(19) United States
(12) Patent Application Publication
(10) Pub. No.: US 2007/0060480 A1
(43) Pub. Date: Mar. 15, 2007

(54) Heteroaroyl-substituted phenylalanineamides

(76) Inventors: Matthias Witschel, Bad Durkheim (DE); Michael Puhl, Lampertheim (DE); Michael Rack, Heidelberg (DE); Liliana Parra Rapado, Offenburg (DE); Ulf Miblitz, Neustadt (DE); Cyrill Zagar, Mannheim (DE); Peter Plath, Frankenthal (DE); Robert Reinhard, Ludwigshafen (DE); Bernd Sievernich, Habloch (DE); Rex Liebl, Deidesheim (DE)

Correspondence Address: ROTHWELL, FIGG, ERNST & MANBECK, P.C., 1425 K STREET, N.W., SUITE 800, WASHINGTON, DC, 20005, US

(21) Appl. No.: 10/581,699

(22) PCT Filed: Dec. 17, 2004
(86) PCT No.: PCT/EP04/14391

§ 371 Date: Jun. 2, 2006

(30) Foreign Application Priority Data
Dec. 19, 2003 (DE) 103 60 463.4

(51) Int. Cl. A01N 43/56

(52) U.S. Cl. 504/280; 548/371.4

(57) ABSTRACT

Pyrazolylcarbonyl-substituted phenylalanineamides of the formula I 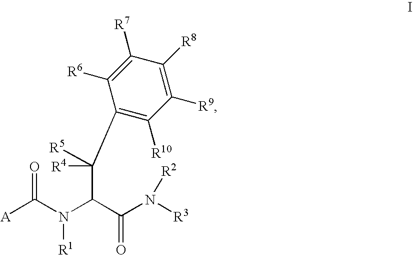
in which the variables A and R¹ to R¹⁰ are as defined in the description, and their agriculturally useful salts, processes and intermediates for their preparation; and the use of these compounds or of compositions comprising these compounds for controlling unwanted plants are described.

The present invention relates to heteroaroyl-substituted phenylalanineamides of the formula I 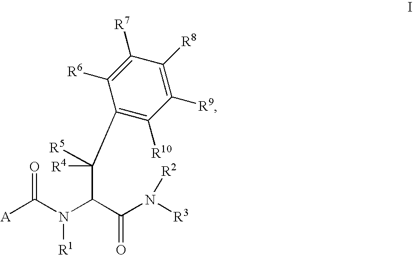
in which the variables are as defined below:
A is C-linked 5- or 6-membered heteroaryl having one to four nitrogen atoms, or having one to three nitrogen atoms and one oxygen or sulfur atom, or having one oxygen or sulfur atom, which heteroaryl may be partially or fully halogenated and/or may carry one to three radicals from the group consisting of cyano, C₁-C₆-alkyl, C₃-C₆-cycloalkyl, C₁-C₆-haloalkyl, C₁-C₆-alkoxy, C₁-C₆-haloalkoxy, C₁-C₆-alkoxy-C₁-C₄-alkyl, amino, (C₁-C₆-alkyl)amino and di(C₁-C₆-alkyl)amino;
R¹, R² are hydrogen, hydroxyl or C₁-C₆-alkoxy;
R³ is C₁-C₆-alkyl, C₁-C₄-cyanoalkyl or C₁-C₆-haloalkyl;
R⁴ is hydrogen, C₁-C₆-alkyl, C₁-C₆-haloalkyl, OR¹¹, SR¹² or NR¹³R¹⁴;
R⁵ is hydrogen or C₁-C₆-alkyl;
R⁶, R⁷ are hydrogen, halogen, cyano, C₁-C₆-alkyl, C₁-C₆-haloalkyl, hydroxyl, C₁-C₆-alkoxy or C₁-C₆-haloalkoxy;
R⁸, R⁹, R¹⁰ are hydrogen, halogen, cyano, C₁-C₆-alkyl, C₁-C₆-haloalkyl, C₁-C₆-alkoxy or C₁-C₆-haloalkoxy;
R¹¹, R¹², R¹³ are hydrogen, C₁-C₆-alkyl, C₃-C₆-cycloalkyl, C₃-C₆-alkenyl, C₃-C₆-alkynyl, C₃-C₆-haloalkenyl, C₃-C₆-haloalkynyl, formyl, C₁-C₆-alkylcarbonyl, C₃-C₆-cycloalkylcarbonyl, C₂-C₆-alkenylcarbonyl, C₂-C₆-alkynylcarbonyl, C₁-C₆-alkoxycarbonyl, C₃-C₆-alkenyloxycarbonyl, C₃-C₆-alkynyloxycarbonyl, C₁-C₆-alkylaminocarbonyl, C₃-C₆-alkenylaminocarbonyl, C₃-C₆-alkynylaminocarbonyl, C₁-C₆-alkylsulfonylaminocarbonyl, di(C₁-C₆-alkyl)aminocarbonyl, N—(C₃-C₆-alkenyl)-N—(C₁-C₆-alkyl)aminocarbonyl, N—(C₃-C₆-alkynyl)-N—(C₁-C₆-alkyl)aminocarbonyl, N—(C₁-C₆-alkoxy)-N—(C₁-C₆-alkyl)aminocarbonyl, N—(C₁-C₆-alkenyl)-N—(C₁-C₆-alkoxy)aminocarbonyl, N—(C₃-C₆-alkynyl)-N—(C₁-C₆-alkoxy)aminocarbonyl, di(C₁-C₆-alkyl)aminothiocarbonyl, C₁-C₆-alkylcarbonyl-C₁-C₆-alkyl, C₁-C₆-alkoxyimino-C₁-C₆-alkyl, N—(C₁-C₆-alkylamino)imino-C₁-C₆-alkyl or N-(di-C₁-C₆-alkylamino)imino-C₁-C₆-alkyl, where the alkyl, cycloalkyl and alkoxy radicals mentioned may be partially or fully halogenated and/or may carry one to three of the following groups: cyano, hydroxyl, C₃-C₆-cycloalkyl, C₁-C₄-alkoxy, C₁-C₄-alkylthio, di(C₁-C₄-alkyl)amino, C₁-C₄-alkylcarbonyl, hydroxycarbonyl, C₁-C₄-alkoxycarbonyl, aminocarbonyl, C₁-C₄-alkylaminocarbonyl, di(C₁-C₄-alkyl)aminocarbonyl or C₁-C₄-alkylcarbonyloxy;
phenyl, phenyl-C₁-C₆-alkyl, phenylcarbonyl, phenylcarbonyl-C₁-C₆-alkyl, phenoxycarbonyl, phenylaminocarbonyl, phenylsulfonylaminocarbonyl, N—(C₁-C₆-alkyl)-N-(phenyl)aminocarbonyl, phenyl-C₁-C₆-alkylcarbonyl, heterocyclyl, heterocyclyl-C₁-C₆-alkyl, heterocyclylcarbonyl, heterocyclylsulfonylaminocarbonyl; heterocyclylcarbonyl-C₁-C₆-alkyl, heterocyclyloxycarbonyl, heterocyclylaminocarbonyl, N—(C₁-C₆-alkyl)-N-(heterocyclyl)aminocarbonyl, or heterocyclyl-C₁-C₆-alkylcarbonyl, where the phenyl and the heterocyclyl radical of the 17 last-mentioned substituents may be partially or fully halogenated and/or may carry one to three of the following groups: nitro, cyano, C₁-C₄-alkyl, C₁-C₄-haloalkyl, C₁-C₄-alkoxy or C₁-C₄-haloalkoxy; or
SO₂R¹⁵;
R¹⁴ is hydrogen, C₁-C₆-alkyl, C₃-C₆-cycloalkyl, C₃-C₆-alkenyl, C₃-C₆-alkynyl, C₃-C₆-haloalkenyl, C₃-C₆-haloalkynyl, where the alkyl and cycloalkyl radicals mentioned may be partially or fully halogenated and/or may carry one to three of the following groups: cyano, hydroxyl, C₃-C₆-cycloalkyl, C₁-C₄-alkoxy, C₁-C₄-alkylthio, di(C₁-C₄-alkyl)amino, C₁-C₄-alkylcarbonyl, hydroxycarbonyl, C₁-C₄-alkoxycarbonyl, aminocarbonyl, C₁-C₄-alkylaminocarbonyl, di(C₁-C₄-alkyl)aminocarbonyl or C₁-C₄-alkylcarbonyloxy; or
phenyl, phenyl-C₁-C₆-alkyl, heterocyclyl or heterocyclyl-C₁-C₆-alkyl, where the phenyl and the heterocyclyl radical of the 4 last-mentioned substituents may be partially or fully halogenated and/or may carry one to three of the following groups: nitro, cyano, C₁-C₄-alkyl, C₁-C₄-haloalkyl, C₁-C₄-alkoxy or C₁-C₄-haloalkoxy;
R¹⁵ is C₁-C₆-alkyl, C₁-C₆-haloalkyl or phenyl, where the phenyl radical may be partially or fully halogenated and/or may carry one to three of the following groups: C₁-C₆-alkyl, C₁-C₆-haloalkyl or C₁-C₆-alkoxy;
   and their agriculturally useful salts.

Moreover, the invention relates to processes and intermediates for preparing compounds of the formula I, to compositions comprising them and to the use of these derivatives or of the compositions comprising them for controlling harmful plants.

Phenylalanineamides substituted by a bezoyl radical are known from the literature, for example from WO 03/066576.

WO 01/55146, WO 02/06995 and WO 02/40469 disclose inter alia heterocyclylcarbonyl-substituted phenylalanineamides having pharmaceutical activity.

However, the herbicidal properties of the prior-art compounds and/or the compatibility with crop plants are not entirely satisfactory.

It is therefore an object of the present invention to provide novel, in particular herbicidally active, compounds having improved properties.

We have found that this object is achieved by the heteroaroyl-substituted phenylalanineamides of the formula I and their herbicidal action.

Furthermore, we have found herbicidal compositions which comprise the compounds I and have very good herbicidal action. Moreover, we have found processes for preparing these compositions and methods for controlling unwanted vegetation using the compounds I.

Depending on the substitution pattern, the compounds of the formula I contain two or more centers of chirality, in which case they are present as enantiomers or diastereomer mixtures. The invention provides both the pure enantiomers or diastereomers and their mixtures.

The compounds of the formula I can also be present in the form of their agriculturally useful salts, the type of salt generally being immaterial. Suitable are, in general, the salts of those cations or the acid addition salts of those acids whose cations and anions, respectively, have no adverse effect on the herbicidal action of the compounds I.

Suitable cations are in particular ions of the alkali metals, preferably lithium, sodium and potassium, of the alkaline earth metals, preferably calcium and magnesium, and of the transition metals, preferably manganese, copper, zinc and iron, and also ammonium, where, if desired, one to four hydrogen atoms may be replaced by C₁-C₄-alkyl, hydroxy-C₁-C₄-alkyl, C₁-C₄-alkoxy-C₁-C₄-alkyl, hydroxy-C₁-C₄-alkoxy-C₁-C₄-alkyl, phenyl or benzyl, preferably ammonium, dimethylammonium, diisopropylammonium, tetramethylammonium, tetrabutylammonium, 2-(2-hydroxyeth-1-oxy)eth-1-ylammonium, di(2-hydroxyeth-1-yl)ammonium, trimethylbenzylammonium, furthermore phosphonium ions, sulfonium ions, preferably tri(C₁-C₄-alkyl)sulfonium, and sulfoxonium ions, preferably tri(C₁-C₄-alkyl)sulfoxonium.

Anions of useful acid addition salts are primarily chloride, bromide, fluoride, hydrogensulfate, sulfate, dihydrogenphosphate, hydrogenphosphate, nitrate, hydrogencarbonate, carbonate, hexafluorosilicate, hexafluorophosphate, benzoate and the anions of C₁-C₄-alkanoic acids, preferably formate, acetate, propionate and butyrate.

The organic moieties mentioned for the substituents R¹—R¹⁹ or as radicals on phenyl or heterocyclyl rings are collective terms for individual enumerations of the individual group members. All hydrocarbon chains, i.e. all alkyl, alkenyl, alkynyl, cyanoalkyl, haloalkyl, haloalkenyl, haloalkynyl, alkoxy, haloalkoxy, alkoxyalkyl, alkylcarbonyl, alkenylcarbonyl, alkynylcarbonyl, alkoxycarbonyl, alkenyloxycarbonyl, alkynyloxycarbonyl, alkylamino, alkylaminocarbonyl, alkenylaminocarbonyl, alkynylaminocarbonyl, alkylsulfonylaminocarbonyl, dialkylaminocarbonyl, N-alkenyl-N-alkylaminocarbonyl, N-alkynyl-N-alkylaminocarbonyl, N-alkoxy-N-alkylaminocarbonyl, N-alkenyl-N-alkoxyaminocarbonyl, N-alkynyl-N-alkoxyaminocarbonyl, dialkylaminothiocarbonyl, alkylcarbonylalkyl, alkoxyiminoalkyl, N-alkylamino)iminoalkyl, N-(dialkylamino)iminoalkyl, phenylalkyl, phenylcarbonylalkyl, N-alkyl-N-phenylaminocarbonyl, phenylalkylcarbonyl, heterocyclylalkyl, heterocyclylcarbonylalkyl, N-alkyl-N-heterocyclylaminocarbonyl, heterocyclylalkylcarbonyl, alkylthio and alkylcarbonyloxy moieties can be straight-chain or branched.

Unless indicated otherwise, halogenated substituents preferably carry one to five identical or different halogen atoms. Halogen means in each case fluorine, chlorine, bromine or iodine.

Examples of other meanings are:
C₁-C₄-alkyl and the alkyl moieties of C₁-C₄-alkylcarbonyloxy and C₁-C₆-alkyliminooxy-C₁-C₄-alkyl: for example methyl, ethyl, n-propyl, 1-methylethyl, n-butyl, 1-methylpropyl, 2-methylpropyl and 1,1-dimethylethyl;
C₁-C₆-alkyl and the alkyl moieties of C₁-C₆-alkylsulfonylaminocarbonyl, N—(C₃-C₆-alkenyl)-N—(C₁-C₆-alkyl)aminocarbonyl, (C₃-C₆-alkynyl) N—(C₁-C₆-alkyl)aminocarbonyl, N—(C₁-C₆-alkoxy”-(C₁-C₆-alkyl)aminocarbonyl, C₁-C₆-alkylcarbonyl-C₁-C₆-alkyl, C₁-C₆-alkoxyimino-C₁-C₆-alkyl, N—(C₁-C₆-alkylamino)imino-C₁-C₆-alkyl, N-(di-C₁-C₆-alkylamino)imino-C₁-C₆-alkyl, phenyl-C₁-C₆-alkyl, phenylcarbonyl-C₁-C₆-alkyl, N—(C₁-C₆-alkyl)-N-phenylaminocarbonyl, heterocyclyl-C₁-C₆-alkyl, heterocyclylcarbonyl-C₁-C₆-alkyl and N—(C₁-C₆-alkyl-N-heterocyclylaminocarbonyl: C₁-C₄-alkyl, as mentioned above, and also, for example, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1-ethyl-1-methylpropyl and 1-ethyl-3-methylpropyl;
C₁-C₄-alkylcarbonyl: for example methylcarbonyl, ethylcarbonyl, propylcarbonyl, 1-methylethylcarbonyl, butylcarbonyl, 1-methylpropylcarbonyl, 2-methylpropylcarbonyl or 1,1-methylethylcarbonyl;
C₁-C₆-alkylcarbonyl and the alkylcarbonyl radicals of C₁-C₆-alkylcarbonyl-C₁-C₆-alkyl, phenyl-C₁-C₆-alkylcarbonyl and heterocyclyl-C₁-C₆-alkylcarbonyl: C₁-C₄-alkylcarbonyl as mentioned above, and also, for example, pentylcarbonyl, 1-methylbutylcarbonyl, 2-methylbutylcarbonyl, 3-methylbutylcarbonyl, 2,2-dimethylpropylcarbonyl, 1-ethylpropylcarbonyl, hexylcarbonyl, 1,1-dimethylpropylcarbonyl, 1,2-dimethylpropylcarbonyl, 1-methylpentylcarbonyl, 2-methylpentylcarbonyl, 3-methylpentylcarbonyl, 4-methylpentylcarbonyl, 1,1-dimethylbutylcarbonyl, 1,2-dimethylbutylcarbonyl, 1,3-dimethylbutylcarbonyl, 2,2-dimethylbutylcarbonyl, 2,3-dimethylbutylcarbonyl, 3,3-dimethylbutylcarbonyl, 1-ethylbutylcarbonyl, 2-ethylbutylcarbonyl, 1,1,2-trimethylpropylcarbonyl, 1,2,2-trimethylpropylcarbonyl, 1-ethyl-1-methylpropylcarbonyl or 1-ethyl-2-methylpropylcarbonyl;
C₃-C₆-cycloalkyl and the cycloalkyl moieties of C₃-C₆-cycloalkylcarbonyl: monocyclic saturated hydrocarbons having 3 to 6 ring members, such as cyclopropyl, cyclobutyl, cyclopentyl and cyclohexyl;
C₃-C₆-alkenyl and the alkenyl moieties of C₃-C₆-alkenyloxycarbonyl: C₃-C₆-alkenylaminocarbonyl, N—(C₃-C₆-alkenyl)-N—(C₁-C₆-alkyl)aminocarbonyl and N—(C₃-C₆-alkenyl)-N-(C₁-C₆-alkoxy)aminocarbonyl: for example 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl and 1-ethyl-2-methyl-2-propenyl;
C₂-C₆-alkenyl and the alkenyl moieties of C₂-C₆-alkenylcarbonyl: C₃-C₆-alkenyl as mentioned above and also ethenyl;
C₃-C₆-alkynyl and the alkynyl moieties of C₃-C₆-alkynyloxycarbonyl, C₃-C₆-alkynylaminocarbonyl, N—C₃-C₆-alkynyl)-N—(C₁-C₆-alkyl)aminocarbonyl, N—(C₃-C₆-alkynyl)-N—(C₁-C₆-alkoxy)aminocarbonyl: for example 1-propynyl, 2-propynyl, 1-butynyl, 2-butynyl, 3-butynyl, 1-methyl-2-propynyl, 1-pentynyl, 2-pentynyl, 3-pentynyl, 4-pentynyl, 1-methyl-2-butynyl, 1-methyl-3-butynyl, 2-methyl-3-butynyl, 3-methyl-1-butynyl, 1,1-dimethyl-2-propynyl, 1-ethyl-2-propynyl, 1-hexynyl, 2-hexynyl, 3-hexynyl, 4-hexynyl, 5-hexynyl, 1-methyl-2-pentynyl, 1-methyl-3-pentynyl, 1-methyl-4-pentynyl, 2-methyl-3-pentynyl, 2-methyl-4-pentynyl, 3-methyl-1-pentynyl, 3-methyl-4-pentynyl, 4-methyl-1-pentynyl, 4-methyl-2-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl and 1-ethyl-1-methyl-2-propynyl;
C₂-C₆-alkynyl and the alkynyl moieties of C₃-C₆-alkynylcarbonyl: C₃-C₆-alkynyl as mentioned above, and also ethynyl;
C₁-C₄-cyanoalkyl: for example cyanomethyl, 1-cyanoeth-1-yl, 2-cyanoeth-1-yl, 1-cyanoprop-1-yl, 2-cyanoprop-1-yl, 3-cyanoprop-1-yl, 1-cyanoprop-2-yl, 2-cyanoprop-2-yl, 1-cyanobut-1-yl, 2-cyanobut-1-yl, 3-cyanobut-1-yl, 4-cyanobut-1-yl, 1-cyanobut-2-yl, 2-cyanobut-2-yl, 1-cyanobut-3-yl, 2-cyanobut-3-yl, 1-cyano-2-methylprop-3-yl, 2-cyano-2-methylprop-3-yl, 3-cyano-2-methylprop-3-yl and 2-cyanomethylprop-2-yl;
C₁-C₄-haloalkyl: a C₁-C₄-alkyl radical as mentioned above which is partially or fully substituted by fluorine, chlorine, bromine and/or iodine, i.e., for example, chloromethyl, dichloromethyl, trichloromethyl, fluoromethyl, difluoromethyl, trifluoromethyl, chlorofluoromethyl, dichlorofluoromethyl, chlorodifluoromethyl, bromomethyl, iodomethyl, 2-fluoroethyl, 2-chloroethyl, 2-bromoethyl, 2-iodoethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl, pentafluoroethyl, 2-fluoropropyl, 3-fluoropropyl, 2,2-difluoropropyl, 2,3-difluoropropyl, 2-chloropropyl, 3-chloropropyl, 2,3-dichloropropyl, 2-bromopropyl, 3-bromopropyl, 3,3,3-trifluoropropyl, 3,3,3-trichloropropyl, 2,2,3,3,3-pentafluoropropyl, heptafluoropropyl, 1-(fluoromethyl)-2-fluoroethyl, 1-(chloromethyl)-2-chloroethyl, 1-(bromomethyl)-2-bromoethyl, 4-fluorobutyl, 4-chlorobutyl, 4-bromobutyl and nonafluorobutyl;
C₁-C₆-haloalkyl: C₁-C₄-haloalkyl as mentioned above, and also, for example, 5-fluoropentyl, 5-chloropentyl, 5-bromopentyl, 5-iodopentyl, undecafluoropentyl, 6-fluorohexyl, 6-chlorohexyl, 6-bromohexyl, 6-iodohexyl and dodecafluorohexyl;

C₃-C₆-haloalkenyl: a C₃-C₆-alkenyl radical as mentioned above which is partially or fully substituted by fluorine, chlorine, bromine and/or iodine, for example 2-chloroprop-2-en-1-yl, 3-chloroprop-2-en-1-yl, 2,3-dichloroprop-2-en-1-yl, 3,3-dichloroprop-2-en-1-yl, 2,3,3-trichloro-2-en-1-yl, 2,3-dichlorobut-2-en-1-yl, 2-bromoprop-2-en-1-yl, 3-bromoprop-2-en-1-yl, 2,3-dibromoprop-2-en-1-yl, 3,3-dibromoprop-2-en-1-yl, 2,3,3-tribromo-2-en-1-yl or 2,3-dibromobut-2-en-1-yl;

C₃-C₆-haloalkynyl: a C₃-C₆-alkynyl radical as mentioned above which is partially or fully substituted by fluorine, chlorine, bromine and/or iodine, for example 1,1-difluoroprop-2-in-1-yl, 3-iodoprop-2-in-1-yl, 4-fluorobut-2-in-1-yl, 4-chlorobut-2-yn-1-yl, 1,1-difluorobut-2-yn-1-yl, 4-iodobut-3-yn-1-yl, 5-fluoropent-3-yn-1-yl, 5-iodopent-4-yn-1-yl, 6-fluorohex-4-yn-1-yl or 6-iodohex-5-yn-1-yl;
C₁-C₄-alkoxy: for example methoxy, ethoxy, propoxy, 1-methylethoxy, butoxy, 1-methylpropoxy, 2-methylpropoxy and 1,1-dimethylethoxy;
C₁₋₁₆alkoxy and the alkoxy moieties of N—(C₁-C₆-alkoxy)-N—(C₁-C₆alkyl)aminocarbonyl, N—(C₃-C₆-alkenyl)-N(C₁-C₆-alkoxy)aminocarbonyl, N—(C₃-C₆-alkynyl)-N-C₁-C₆-alkoxy)aminocarbonyl and C₁-C₆-alkoxyimino-C₁-C₆-alkyl:
C₁-C₄-alkoxy as mentioned above, and also, for example, pentoxy, 1-methylbutoxy, 2-methylbutoxy, 3-methoxylbutoxy, 1,1-dimethylpropoxy, 1,2-dimethylpropoxy, 2,2-dimethylpropoxy, 1-ethylpropoxy, hexoxy, 1-methylpentoxy, 2-methylpentoxy, 3-methylpentoxy, 4-methylpentoxy, 1,1-dimethylbutoxy, 1,2-dimethylbutoxy, 1,3-dimethylbutoxy, 2,2-dimethylbutoxy, 2,3-dimethylbutoxy, 3,3-dimethylbutoxy, 1-ethylbutoxy, 2-ethylbutoxy, 1,1,2-trimethylpropoxy, 1,2,2-trimethylpropoxy, 1-ethyl-1-methylpropoxy and 1-ethyl-2-methylpropoxy;
C₁-C₄-haloalkoxy: a C₁-C₄-alkoxy radical as mentioned above which is partially or fully substituted by fluorine, chlorine, bromine and/or iodine, i.e., for example, fluoromethoxy, difluoromethoxy, trifluoromethoxy, chlorodifluoromethoxy, bromodifluoromethoxy, 2-fluoroethoxy, 2-chloroethoxy, 2-bromomethoxy, 2-iodoethoxy, 2,2-difluoroethoxy, 2,2,2-trifluoroethoxy, 2-chloro-2-fluoroethoxy, 2-chloro-2,2-difluoroethoxy, 2,2-dichloro-2-fluoroethoxy, 2,2,2-trichloroethoxy, pentafluoroethoxy, 2-fluoropropoxy, 3-fluoropropoxy, 2-chloropropoxy, 3-chloropropoxy, 2-bromopropoxy, 3-bromopropoxy, 2,2-difluoropropoxy, 2,3-difluoropropoxy, 2,3-dichloropropoxy, 3,3,3-trifluoropropoxy, 3,3,3-trichloropropoxy, 2,2,3,3,3-pentafluoropropoxy, heptafluoropropoxy, 1-(fluoromethyl) 2-fluoroethoxy, 1-(chloromethyl)-2-chloroethoxy, 1-(bromomethyl)-2-bromoethoxy, 4-fluorobutoxy, 4-chlorobutoxy, 4-bromobutoxy and nonafluorobutoxy;
C₁-C₆-haloalkoxy: C₁-C₄-haloalkoxy as mentioned above, and also, for example, 5-fluoropentoxy, 5-chloropentoxy, 5-bromopentoxy, 5-iodopentoxy, undecafluoropentoxy, 6-fluorohexoxy, 6-chlorohexoxy, 6-bromohexoxy, 6-iodohexoxy and dodecafluorohexoxy;
C₁-C₆-alkoxy-C₁-C₄-alkyl: C₁-C₄-alkyl which is substituted by C₁-C₆-alkoxy as mentioned above, i.e., for example, methoxymethyl, ethoxymethyl, propoxymethyl, (1-methylethoxy)methyl, butoxymethyl, (1-methylpropoxy)methyl, (2-methylpropoxy)methyl, (1,1-dimethylethoxy)methyl, 2-(methoxy)ethyl, 2-(ethoxy)ethyl, 2-(propoxy)ethyl, 2-(1-methylethoxy)ethyl, 2-(butoxy)ethyl, 2-(1-methylpropoxy)ethyl, 2-(2-methylpropoxy)ethyl, 2-(1,1-dimethylethoxy)ethyl, 2-(methoxy)propyl, 2-(ethoxy)propyl, 2-(propoxy)propyl, 2-(1-methylethoxy)propyl, 2-(butoxy)propyl, 2-(1-methylpropoxy)propyl, 2-(2-methylpropoxy)propyl, 2-(1,1-dimethylethoxy)propyl, 3-(methoxy)propyl, 3-(ethoxy)propyl, 3-(propoxy)propyl, 3-(1-methylethoxy)propyl, 3-(butoxy)propyl, 3-(1-methylpropoxy)propyl, 3-(2-methylpropoxy)propyl, 3-(1,1-dimethylethoxy)propyl, 2-(methoxy)butyl, 2-(ethoxy)butyl, 2-(propoxy)butyl, 2-(1-methylethoxy)butyl, 2-(butoxy)butyl, 2-(1-methylpropoxy)butyl, 2-(2-methylpropoxy)butyl, 2-(1,1-dimethylethoxy)butyl, 3-(methoxy)butyl, 3-(ethoxy)butyl, 3-(propoxy)butyl, 3-(1-methylethoxy)butyl, 3-(butoxy)butyl, 3-(1-methylpropoxy)butyl, 3-(2-methylpropoxy)butyl, 3-(1,1-dimethylethoxy)butyl, 4-(methoxy)butyl, 4-(ethoxy)butyl, 4-(propoxy)butyl, 4-(1-methylethoxy)butyl, 4-(butoxy)butyl, 4-(1-methylpropoxy)butyl, 4-(2-methylpropoxy)butyl and 4-(1,1-dimethylethoxy)butyl;
C₁-C₄-alkoxycarbonyl and the alkoxycarbonyl moieties of C₁-C₄-alkoxy-C₁-C₄-alkoxycarbonyl and di(C₁-C₄-alkyl)amino-C₁-C₄-alkoxycarbonyl: for example methoxycarbonyl, ethoxycarbonyl, propoxycarbonyl, 1-methylethoxycarbonyl, butoxycarbonyl, 1-methylpropoxycarbonyl, 2-methylpropoxycarbonyl or 1,1-dimethylethoxycarbonyl;
C₁-C₆-alkoxycarbonyl: C₁-C₄-alkoxycarbonyl as mentioned above, and also, for example, pentoxycarbonyl, 1-methylbutoxycarbonyl, 2-methylbutoxycarbonyl, 3-methylbutoxycarbonyl, 2,2-dimethylpropoxycarbonyl, 1-ethylpropoxycarbonyl, hexoxycarbonyl, 1,1-dimethylpropoxycarbonyl, 1,2-dimethylpropoxycarbonyl, 1-methylpentoxycarbonyl, 2-methylpentoxycarbonyl, 3-methylpentoxycarbonyl, 4-methylpentoxycarbonyl, 1,1-dimethylbutoxycarbonyl, 1,2-dimethylbutoxycarbonyl, 1,3-dimethylbutoxycarbonyl, 2,2-dimethylbutoxycarbonyl, 2,3-dimethylbutoxycarbonyl, 3,3-dimethylbutoxycarbonyl, 1-ethylbutoxycarbonyl, 2-ethylbutoxycarbonyl, 1,1,2-trimethylpropoxycarbonyl, 1,2,2-trimethylpropoxycarbonyl, 1-ethyl-1-methylpropoxycarbonyl or 1-ethyl-2-methylpropoxycarbonyl;
C₁-C₄-alkylthio: for example methylthio, ethylthio, propylthio, 1-methylethylthio, butylthio, 1-methylpropylthio, 2-methylpropylthio and 1,1-dimethylethylthio;
C₁-C₆-alkylamino and the alkylamino radicals of N—(C₁-C₆-alkylamino)imino-C₁-C₆-alkyl: for example methylamino, ethylamino, propylamino, 1-methylethylamino, butylamino, 1-methylpropylamino, 2-methylpropylamino, 1,1-dimethylethylamino, pentylamino, 1-methylbutylamino, 2-methylbutylamino, 3-methylbutylamino, 2,2-dimethylpropylamino, 1-ethylpropylamino, hexylamino, 1,1-dimethylpropylamino, 1,2-dimethylpropylamino, 1-methylpentylamino, 2-methylpentylamino, 3-methylpentylamino, 4-methylpentylamino, 1,1-dimethylbutylamino, 1,2-dimethylbutylamino, 1,3-dimethylbutylamino, 2,2-dimethylbutylamino, 2,3-dimethylbutylamino, 3,3-dimethylbutylamino, 1-ethylbutylamino, 2-ethylbutylamino, 1,1,2-trimethylpropylamino, 1,2,2-trimethylpropylamino, 1-ethyl-1-methylpropylamino or 1-ethyl-2-methylpropylamino;
di(C₁-C₄-alkyl)amino: for example N,N-dimethylamino, N,N-diethylamino, N,N-dipropylamino, N,N-di(1-methylethyl)amino, N,N-dibutylamino, N,N-di-(1-methylpropyl)amino, N,N-di(2-methylpropyl)amino, N,N-di(1,1-dimethylethyl)amino, N-ethyl-N-methylamino, N-methyl-N-propylamino, N-methyl-N-(1-methylethyl)amino, N-butyl-N-methylamino, N-methyl-N-(1-methylpropyl)amino, N-methyl-N-(2-methylpropyl)amino, N-(1,1-dimethylethyl)-N-methylamino, N-ethyl-N-propylamino, N-ethyl-N-(1-methylethyl)amino, N-butyl-N-ethylamino, N-ethyl-N-(1-methylpropyl)amino, N-ethyl-N-(2-methylpropyl)amino, N-ethyl-N-(1,1-dimethylethyl)amino, N-(1-methylethyl)-N-propylamino, N-butyl-N-propylamino, N-(1-methylpropyl)-N-propylamino, N-(2-methylpropyl)-N-propylamino, N-(1,1-dimethylethyl)-N-propylamino, N-butyl-N-(1-methylethyl)amino, N-(1-methylethyl)-N-(1-methylpropyl)amino, N-(1-methylethyl)-N-(2-methylpropyl)amino, N-(1,1-dimethylethyl)-N-(1-methylethyl)amino, N-butyl-N-(1-methylpropyl)amino, N-butyl-N-(2-methylpropyl)amino, N-butyl-N-(1,1-dimethylethyl) amino, N-(1-methylpropyl)-N-(2-methylpropyl)amino, N-(1,1-dimethylethyl)-N-(1-methylpropyl)amino and N-(1,1-dimethylethyl)-N-(2-methylpropyl)amino;
di(C₁-C₆-alkyl)amino and the dialkylamino radicals of N-(di-C₁-C₆-alkylamino)imino-C₁-C₆-alkyl: di(C₁-C₄-alkyl)amino as mentioned above, and also, for example, N,N-dipentylamino, N,N-dihexylamino, N-methyl-N-pentylamino, N-ethyl-N-pentylamino, N-methyl-N-hexylamino and N-ethyl-N-hexylamino;
(C₁-C₄-alkylamino)carbonyl: for example methylaminocarbonyl, ethylaminocarbonyl, propylaminocarbonyl, 1-methylethylaminocarbonyl, butylaminocarbonyl, 1-methylpropylaminocarbonyl, 2-methylpropylaminocarbonyl or 1,1-dimethylethylaminocarbonyl;

di(C₁-C₄-alkyl)aminocarbonyl: for example N,N-dimethylaminocarbonyl, N,N-diethylaminocarbonyl, N,N-di(1-methylethyl)aminocarbonyl, N,N-dipropylaminocarbonyl, N,N-dibutylaminocarbonyl, N,N-di(1-methylpropyl)aminocarbonyl, N,N-di(2-methylpropyl)aminocarbonyl, N,N-di(1,1-dimethylethyl)aminocarbonyl, N-ethyl-N-methylaminocarbonyl, N-methyl-N-propylaminocarbonyl, N-methyl-N-(1-methylethyl)aminocarbonyl, N-butyl-N-methylaminocarbonyl, N-methyl-N-(1-methylpropyl)aminocarbonyl, N-methyl-N-(2-methylpropyl)aminocarbonyl, N-(1,1-dimethylethyl)-N-methylaminocarbonyl, N-ethyl-N-propylaminocarbonyl, N-ethyl-N-(1-methylethyl)aminocarbonyl, N-butyl-N-ethylaminocarbonyl, N-ethyl-N-(1-methylpropyl)aminocarbonyl, N-ethyl-N-(2-methylpropyl)aminocarbonyl, N-ethyl-N-(1,1-dimethylethyl)aminocarbonyl, N-(1-methylethyl)-N-propylaminocarbonyl, N-butyl-N-propylaminocarbonyl, N-(1-methylpropyl)-N-propylaminocarbonyl, N-(2-methylpropyl)-N-propylaminocarbonyl, N-(1,1-dimethylethyl)-N-propylaminocarbonyl, N-butyl-N-(1-methylethyl)aminocarbonyl, N-(1-methylethyl)-N-(1-methylpropyl)aminocarbonyl, N-(1-methylethyl)-N-(2-methylpropyl)aminocarbonyl, N-(1,1-dimethylethyl)-N-(1-methylethyl)aminocarbonyl, N-butyl-N-(1-methylpropyl)aminocarbonyl, N-butyl-N-(2-methylpropyl)aminocarbonyl, N-butyl-N-(1,1-dimethylethyl)aminocarbonyl, N-(1-methylpropyl)-N-(2-methylpropyl)aminocarbonyl, N-(1,1-dimethylethyl)-N-(1-methylpropyl)aminocarbonyl or N-(1,1-dimethylethyl)-N-(2-methylpropyl)aminocarbonyl;
(C₁-C₆-alkylamino)carbonyl: (C₁-C₄-alkylamino)carbonyl as mentioned above, and also, for example, pentylaminocarbonyl, 1-methylbutylaminocarbonyl, 2-methylbutylaminocarbonyl, 3-methylbutylaminocarbonyl, 2,2-dimethylpropylaminocarbonyl, 1-ethylpropylaminocarbonyl, hexylaminocarbonyl, 1,1-dimethylpropylaminocarbonyl, 1,2-dimethylpropylaminocarbonyl, 1-methylpentylaminocarbonyl, 2-methylpentylaminocarbonyl, 3-methylpentylaminocarbonyl, 4-methylpentylaminocarbonyl, 1,1-dimethylbutylaminocarbonyl, 1,2-dimethylbutylaminocarbonyl, 1,3-dimethylbutylaminocarbonyl, 2,2-dimethylbutylaminocarbonyl, 2,3-dimethylbutylaminocarbonyl, 3,3-dimethylbutylaminocarbonyl, 1-ethylbutylaminocarbonyl, 2-ethylbutylaminocarbonyl, 1,1,2-trimethylpropylaminocarbonyl, 1,2,2-trimethylpropylaminocarbonyl, 1-ethyl-1-methylpropylaminocarbonyl or 1-ethyl-2-methylpropylaminocarbonyl;
di(C₁-C₆alkyl)aminocarbonyl: di(C₁-C₄-alkyl)aminocarbonyl as mentioned above, and also, for example, N-methyl-N-pentylaminocarbonyl, N-methyl-N-(1-methylbutyl)aminocarbonyl, N-methyl-N-(2-methylbutyl)aminocarbonyl, N-methyl-N-(3-methylbutyl)aminocarbonyl, N-methyl-N-(2,2-dimethylpropyl)aminocarbonyl, N-methyl-N-(1-ethylpropyl)aminocarbonyl, N-methyl-N-hexylaminocarbonyl, N-methyl-N-1,1-dimethylpropyl)aminocarbonyl, N-methyl-N-(1,2-dimethylpropyl)aminocarbonyl, N-methyl-N-(1-methylpentyl)aminocarbonyl, N-methyl-N-(2-methylpentyl)aminocarbonyl, N-methyl-N-(3-methylpentyl)aminocarbonyl, N-methyl-N-(4-methylpentyl)aminocarbonyl, N-methyl-N-(1,1-dimethylbutyl)aminocarbonyl, N-methyl-N-(1,2-dimethylbutyl)aminocarbonyl, N-methyl-N-(1,3-dimethylbutyl)aminocarbonyl, N-methyl-N-(2,2-dimethylbutyl)aminocarbonyl, N-methyl-N-(2,3-dimethylbutyl)aminocarbonyl, N-methyl-N-(3,3-dimethylbutyl)aminocarbonyl, N-methyl-N-(1-ethylbutyl)aminocarbonyl, N-methyl-N-(2-ethylbutyl)aminocarbonyl, N-methyl-N-(1,1,2-trimethylpropyl)aminocarbonyl, N-methyl-N-(1,2,2-trimethylpropyl)aminocarbonyl, N-methyl-N-(1-ethyl-1-methylpropyl)aminocarbonyl, N-methyl-N-(1-ethyl-2-methylpropyl)aminocarbonyl, N-ethyl-N-pentylaminocarbonyl, N-ethyl-N-(1-methylbutyl)aminocarbonyl, N-methyl-N-(2-methylbutyl)aminocarbonyl, N-ethyl-N-(3-methylbutyl)aminocarbonyl, N-ethyl-N-(2,2-dimethylpropyl)aminocarbonyl, N-ethyl-N-(1-ethylpropyl)aminocarbonyl, N-ethyl-N-hexylaminocarbonyl, N-ethyl-N-(1,1-dimethylpropyl)aminocarbonyl, N-ethyl-N-(1,2-dimethylpropyl)aminocarbonyl, N-ethyl (1-methylpentyl)aminocarbonyl, N-ethyl-N-(2-methylpentyl)aminocarbonyl, N-ethyl-N-3-methylpentyl)aminocarbonyl, N-ethyl-N-4-methylpentyl)aminocarbonyl, N-ethyl-N-(1,1-dimethylbutyl)aminocarbonyl, N-ethyl-N-1,2-dimethylbutyl)aminocarbonyl, N-ethyl-N-1,3-dimethylbutyl)aminocarbonyl, N-ethyl-N-2,2dimethylbutyl)aminocarbonyl, N-ethyl-N-(2,3-dimethylbutyl)aminocarbonyl, N-ethyl-N-(3,3-dimethylbutyl)aminocarbonyl, N-ethyl-N-(1-ethylbutyl)aminocarbonyl, N-ethyl-N-(2-ethylbutyl)aminocarbonyl, N-ethyl-N-1,1,2-trimethylpropyl)aminocarbonyl, N-ethyl-N-(1,2,2-trimethylpropyl)aminocarbonyl, N-ethyl-N-(1-ethyl-1-methylpropyl)aminocarbonyl, N-ethyl-N-1-ethyl-2-methylpropyl)aminocarbonyl, N-propyl-N-pentylaminocarbonyl, N-butyl-N-pentylaminocarbonyl, N,N-dipentylaminocarbonyl, N-propyl-N-hexylaminocarbonyl, N-butyl-N-hexylaminocarbonyl, N-pentyl-N-hexylaminocarbonyl or N,N-dihexylaminocarbonyl;
di(C₁-C₆-alkyl)aminothiocarbonyl: for example N,N-dimethylaminothiocarbonyl, N,N-diethylaminothiocarbonyl, N,N-di(1-methylethyl)aminothiocarbonyl, N,N-dipropylaminothiocarbonyl, N,N-dibutylaminothiocarbonyl, N,N-di(1-methylpropyl)aminothiocarbonyl, N,N-di(2-methylpropyl)aminothiocarbonyl, N,N-di-(1,1-dimethylethyl)aminothiocarbonyl, N-ethyl-N-methylaminothiocarbonyl, N-methyl-N-propylaminothiocarbonyl, N-methyl-N-(1-methylethyl)aminothiocarbonyl, N-butyl-N-methylaminothiocarbonyl, N-methyl-N-(1-methylpropyl)aminothiocarbonyl, N-methyl-N-(2-methylpropyl)aminothiocarbonyl, N-(1,1-dimethylethyl)-N-methylaminothiocarbonyl, N-ethyl-N-propylaminothiocarbonyl, N-ethyl-N-(1-methylethyl)aminothiocarbonyl, N-butyl-N-ethylaminothiocarbonyl, N-ethyl-N-(1-methylpropyl)aminothiocarbonyl, N-ethyl-N-(2-methylpropyl)aminothiocarbonyl, N-ethyl-N-(1,1-dimethylethyl)aminothiocarbonyl, N-(1-methylethyl)-N-propylaminothiocarbonyl, N-butyl-N-propylaminothiocarbonyl, N-(1-methylpropyl)-N-propylaminothiocarbonyl, N-(2-methylpropyl)-N-propylaminothiocarbonyl, N-(1,1-dimethylethyl)-N-propylaminothiocarbonyl, N-butyl-N-(1-methylethyl)aminothiocarbonyl, N-(1-methylethyl)-N-(1-methylpropyl)aminothiocarbonyl, N-(1-methylethyl)-N-(2-methylpropyl)aminothiocarbonyl, N-(1,1-dimethylethyl)-N-(1-methylethyl)aminothiocarbonyl, N-butyl-N-(1-methylpropyl)aminothiocarbonyl, N-butyl-N-(2-methylpropyl)aminothiocarbonyl, N-butyl-N-(1,1-dimethylethyl)aminothiocarbonyl, N-(1-methylpropyl)-N-(2-methylpropyl)aminothiocarbonyl, N-(1,1-dimethylethyl)-N-(1-methylpropyl)aminothiocarbonyl, N-(1,1-dimethylethyl)-N-(2-methylpropyl)aminothiocarbonyl, N-methyl-N-pentylaminothiocarbonyl, N-methyl-N-(1-methylbutyl)aminothiocarbonyl, N-methyl-N-(2-methylbutyl)aminothiocarbonyl, N-methyl-N-(3-methylbutyl)aminothiocarbonyl, N-methyl-N-(2,2-dimethylpropyl)aminothiocarbonyl, N-methyl-N-(1-ethylpropyl)aminothiocarbonyl, N-methyl-N-hexylaminothiocarbonyl, N-methyl-N (1,1-dimethylpropyl)aminothiocarbonyl, N-methyl N-(1,2-dimethylpropyl)aminothiocarbonyl, N-methyl-N-1-methylpentyl)aminothiocarbonyl, N-methyl-N-(2-methylpentyl)aminothiocarbonyl, N-methyl-N-(3-methylpentyl)aminothiocarbonyl, N-methyl-N-4-methylpentyl)aminothiocarbonyl, N-methyl-N-(1,1-dimethylbutyl)aminothiocarbonyl, N-methyl-N-(1,2-dimethylbutyl)aminothiocarbonyl, N-methyl-N-(1,3-dimethylbutyl)aminothiocarbonyl, N-methyl-N-2,2-dimethylbutyl)aminothiocarbonyl, N-methyl-N-(2,3-dimethylbutyl)aminothiocarbonyl, N-methyl-N-(3,3-dimethylbutyl)aminothiocarbonyl, N-methyl-N-(1-ethylbutyl)aminothiocarbonyl, N-methyl-N-(2-ethylbutyl)aminothiocarbonyl, N-methyl-N-ethyl-N-1,1,2-trimethylpropyl)aminothiocarbonyl, N-methyl-N-(1,2,2-trimethylpropyl)aminothiocarbonyl, N-methyl-N-(1-ethyl-1-methylpropyl)aminothiocarbonyl, N-methyl-N-(1-ethyl-2-methylpropyl)aminothiocarbonyl, N-ethyl-N-pentylaminothiocarbonyl, N-ethyl-N-(1-methylbutyl)aminothiocarbonyl, N-ethyl-N-(2-methylbutyl)aminothiocarbonyl, N-ethyl-N-(3-methylbutyl)aminothiocarbonyl, N-ethyl-N-2,2-dimethylpropyl)aminothiocarbonyl, N-ethyl-N-1-ethylpropyl)aminothiocarbonyl, N-ethyl-N-hexylaminothiocarbonyl, N-ethyl-N-(1,1-dimethylpropyl)aminothiocarbonyl, N-ethyl-N-(1,2-dimethylpropyl)aminothiocarbonyl, N-ethyl-N-(1-methylpentyl)aminothiocarbonyl, N-ethyl-N-(2-methylpentyl)aminothiocarbonyl, N-ethyl-N-(3-methylpentyl)aminothiocarbonyl, N-ethyl-N-4-methylpentyl)aminothiocarbonyl, N-ethyl-N-(1,1-dimethylbutyl)aminothiocarbonyl, N-ethyl-N-(1,2-dimethylbutyl)aminothiocarbonyl, N-ethyl-N-(1,3-dimethylbutyl)aminothiocarbonyl, N-ethyl-N-(2,2-dimethylbutyl)aminothiocarbonyl, N-ethyl-N-(2,3-dimethylbutyl)aminothiocarbonyl, N-ethyl-N-(3,3-dimethylbutyl)aminothiocarbonyl, N-ethyl-N-(1-ethylbutyl)aminothiocarbonyl, N-ethyl-N-(2-ethylbutyl)aminothiocarbonyl, N-ethyl-N-(1,1,2-trimethylpropyl)aminothiocarbonyl, N-ethyl-N-(1,2,2-trimethylpropyl)aminothiocarbonyl, N-ethyl-N-(1-ethyl-1-methylpropyl)aminothiocarbonyl, N-ethyl-N-(1-ethyl-2-methylpropyl)aminothiocarbonyl, N-propyl-N-pentylaminothiocarbonyl, N-butyl-N-pentylaminothiocarbonyl, N,N-dipentylaminothiocarbonyl, N-propyl-N-hexylaminothiocarbonyl, N-butyl-N-hexylaminothiocarbonyl, N-pentyl-N-hexylaminothiocarbonyl or N,N-dihexylaminothiocarbonyl;
heterocyclyl, and the heterocyclyl moieties of heterocyclyl-C₁-C₆-alkyl, heterocyclylcarbonyl, heterocyclylcarbonyl-C₁-C₆-alkyl, heterocyclyloxycarbonyl, heterocyclylaminocarbonyl, heterocyclylsulfonylaminocarbonyl, N—(C₁-C₆-alkyl)-N-(heterocyclyl)aminocarbonyl and heterocyclyl-C₁-C₆-alkylcarbonyl: a saturated, partially unsaturated or aromatic 5 or 6-membered heterocyclic ring which contains one to four identical or different heteroatoms selected from the group consisting of oxygen, sulfur and nitrogen and which may be attached via C or N, for example;
C-linked 5-membered saturated rings, such as:
tetrahydrofuran-2-yl, tetrahydrofuran-3-yl, tetrahydrothien-2-yl, tetrahydrothien-3-yl, tetrahydropyrrol-2-yl, tetrahydropyrrokyl, tetrahydropyrazo-3-yl, tetrahydropyrazolyl, tetrahydroisoxazol-3-yl, tetrahydroisoxazol-3-yl, tetrahydroisoxazo-5-yl, 1,2-oxathiolan-3-yl, 1,2-oxathiolan-4-yl, 1,2-oxathiolan-5-yl, tetrahydroisothiazol-3-yl, tetrahydroisothiazol-4-yl, tetrahydroisothiazo-5-yl, 1,2-dithiolan-3-yl, 1,2-dithiolanyl, tetrahydroimidazol-2-yl, tetrahydroimidazol-4-yl, tetrahydrooxazol-2-yl, tetrahydrooxazolyl, tetrahydrooxazol-5-yl, tetrahydrothiazol-2-yl, tetrahydrothiazol-4-yl, tetrahydrothiazol-5-yl, 1,3-dioxolan-2-yl, 1,3-dioxolanyl, 1,3-oxathiolan-2-yl, 1,3-oxathiolan-4-yl, 1,3-oxathiolan-5-yl, 1,3-dithiolan-2-yl, 1,3-dithiolan-4-yl, 1,3,2-dioxathiolan-4-yl;
   N-linked 5-membered saturated rings, such as:
tetrahydropyrrol-1-yl, tetrahydropyrazol-1-yl, tetrahydroisoxazol-2-yl, tetrahydroisothiazol-2-yl, tetrahydroimidazol-1-yl, tetrahydrooxazol-3-yl, tetrahydrothiazol-3-yl;
   C-linked 5-membered partially unsaturated rings, such as:
2,3-dihydrofuran-2-yl, 2,3-dihydrofuran-3-yl, 2,5-dihydrofuran-2-yl, 2,5-dihydrofuran-3-yl, 4,5-dihydrofuran-2-yl, 4,5-dihydrofuran-3-yl, 2,3-dihydrothien-2-yl, 2,3-dihydrothien-3-yl, 2,5-dihydrothien-2-yl, 2,5-dihydrothien-3-yl, 4,5-dihydrothien-2-yl, 4,5-dihydrothien-3-yl, 2,3-dihydro-1H-pyrrol-2-yl, 2,3-dihydro-1H-pyrrol-3-yl, 2,5-dihydro-1H-pyrrol-2-yl, 2,5-dihydro-1H-pyrrol-3-yl, 4,5-dihydro-1H-pyrrol-2-yl, 4,5-dihydro-1H-pyrrol-3-yl, 3,4-dihydro-2H-pyrrol-2-yl, 3,4-dihydro-2H-pyrrol-3-yl, 3,4-dihydro-5H-pyrrol-2-yl, 3,4-dihydro-5H-pyrrol-3-yl, 4,5-dihydro-1H-pyrazol-3-yl, 4,5-dihydro-1H-pyrazol-4-yl, 4,5-dihydro-1H-pyrazol-5-yl, 2,5-dihydro-1H-pyrazol-3-yl, 2,5-dihydro-1H-pyrazol-4-yl, 2,5-dihydro-1H-pyrazol-5-yl, 4,5-dihydroisoxazol-3-yl, 4,5-dihydroisoxazol-4-yl, 4,5-dihydroisoxazol-5-yl, 2,5-dihydroisoxazol-3-yl, 2,5-dihydroisoxazol-4-yl, 2,5-dihydroisoxazol-5-yl, 2,3-dihydroisoxazol-3-yl, 2,3-dihydroisoxazolyl, 2,3-dihydroisoxazol-5-yl, 4,5-dihydroisothiazol-3-yl, 4,5-dihydroisothiazolyl, 4,5-dihydroisothiazol-5-yl, 2,5-dihydroisothiazo-3-yl, 2,5-dihydroisothiazol-4-yl, 2,5-dihydroisothiazol-5-yl, 2,3-dihydroisothiazol-3-yl, 2,3-dihydroisothiazol-4-yl, 2,3-dihydroisothiazol-5-yl, A³-1,2-dithiol-3-yl, A³-1,2-dithiol-4-yl, A³-1,2-dithiol-5-yl, 4,5-dihydro-1H-imidazol-2-yl, 4,5-dihydro-1H-imidazol-4-yl, 4,5-dihydro-1H-imidazol-5-yl, 2,5-dihydro-1H-imidazol-2-yl, 2,5-dihydro-1H-imidazolyl, 2,5-dihydro-1H-imidazol-5-yl, 2,3-dihydro-1H-imidazol-2-yl, 2,3-dihydro-1H-imidazol-4-yl, 4,5-dihydrooxazol-2-yl, 4,5-dihydrooxazolyl, 4,5-dihydrooxazol-5-yl, 2,5-dihydrooxazol-2-yl, 2,5-dihydrooxazolyl, 2,5-dihydrooxazol-5-yl, 2,3-dihydrooxazol-2-yl, 2,3-dihydrooxazolyl, 2,3-dihydrooxazo-5-yl, 4,5-dihydrothiazol-2-yl, 4,5-dihydrothiazol-4-yl, 4,5-dihydrothiazol-5-yl, 2,5-dihydrothiazol-2-yl, 2,5-dihydrothiazolyl, 2,5-dihydrothiazol-5-yl, 2,3-dihydrothiazol-2-yl, 2,3-dihydrothiazol-4-yl, 2,3-dihydrothiazol-5-yl, 1,3-dioxol-2-yl, 1,3-dioxolyl, 1,3-dithiol-2-yl, 1,3-dithio-4-yl, 1,3-oxathiol-2-yl, 1,3-oxathiol-4-yl, 1,3-oxathiol-5-yl, 1,2,3-Δ²-oxadiazolin-4-yl, 1,2,3-Δ²-oxadiazolin-5-yl, 1,2,4-Δ⁴-oxadiazolin-3-yl, 1,2,4-Δ⁴-oxadiazolin-5-yl, 1,2,4-Δ²-oxadiazolin-3-yl, 1,2,4-Δ²-oxadiazolin-5-yl, 1,2,4-Δ³-oxadiazolin-3-yl, 1,2,4-Δ³-oxadiazolin-5-yl, 1,3,4-Δ²-oxadiazolin-2-yl, 1,3,4-Δ²-oxadiazolin-5-yl, 1,3,3-oxadiazolin-2-yl, 1,3,4-oxadiazolin-2-yl, 1,2,4-Δ⁴-thiadiazolin-3-yl, 1,2,4-Δ⁴-thiadiazolin-5-yl, 1,2,4-Δ³-thiadiazolin-3-yl, 1,2,4-Δ³-thiadiazolin-5-yl, 1,2,4-Δ²-thiadiazolin-3-yl, 1,2,4-Δ²-thiadiazolin-5-yl, 1,3,4-Δ²-thiadiazolin-2-yl, 1,3,4-Δ²-thiadiazolin-5-yl, 1,3,4-Δ³-thiadiazolin-2-yl, 1,3,4-thiadiazolin-2-yl, 1,2,3-Δ²-triazolin-4-yl, 1,2,3-Δ²-triazolin-5-yl, 1,2,4-Δ²-triazolin-3-yl, 1,2,4-Δ²-triazolin-5-yl, 1,2,4-Δ³-triazolin-3-yl, 1,2,4-Δ³-triazolin-5-yl, 1,2,4-Δ¹-triazolin-2-yl, 1,2,4-triazolin-3-yl, 3H-1,2,4-dithiazol-5-yl, 2H-1,3,4-dithiazol-5-yl, 2H-1,3,4-oxathiazol-5-yl;
   N-linked 5-membered partially unsaturated rings, such as:
2,3-dihydro-1H-pyrrol-1-yl, 2,5-dihydro-1H-pyrrol-1-yl, 4,5-dihydro-1H-pyrazol-1-yl, 2,5-dihydro-1H-pyrazol-1-yl, 2,3-dihydro-1H-pyrazol-1-yl, 2,5-dihydroisoxazol-2-yl, 2,3-dihydroisoxazol-2-yl, 2,5-dihydroisothiazol-2-yl, 2,3-dihydroisoxazol-2-yl, 4,5-dihydro-1H-imidazol-1-yl, 2,5-dihydro-1H-imidazol-1-yl, 2,3-dihydro-1H-imidazol-1-yl, 2,3-dihydrooxazo-3-yl, 2,3-dihydrothiazol-3-yl, 1,2,4-Δ⁴-oxadiazolin-2-yl, 1,2,4-Δ²-oxadiazolin-4-yl, 1,2,4-Δ³-oxadiazolin-2-yl, 1,3,4-Δ²-oxadiazolin-4-yl, 1,2,4-Δ²-thiadiazolin-2-yl, 1,2,4-Δ³-thiadiazolin-2-yl, 1,2,4-Δ²-thiadiazolin-4-yl, 1,3,4-Δ²-thiadiazolin-4-yl, 1,2,3-Δ²-triazolin-1-yl, 1,2,4-Δ²-triazolin-1-yl, 1,2,4-Δ²-triazolin-4-yl, 1,2,4-Δ³-triazolin-1-yl, 1,2,4-Δ¹-triazolin-4-yl;
   C-linked 5-membered aromatic rings, such as:
2-furyl, 3-furyl, 2-thienyl, 3-thienyl, pyrrol-2-yl, pyrrol-3-yl, pyrazol-3-yl, pyrazol-4-yl, isoxazol-3-yl, isoxazolyl, isoxazol-5-yl, isothiazol-3-yl, isothiazol-4-yl, isothiazol-5-yl, imidazol-2-yl, imidazolyl, oxazol-2-yl, oxazol-1-yl, oxazol-5-yl, thiazol-2-yl, thiazolyl, thiazol-5-yl, 1,2,3-oxadiazol-4-yl, 1,2,3-oxadiazol-5-yl, 1,2,4-oxadiazol-3-yl, 1,2,4-oxadiazol-5-yl, 1,3,4-oxadiazol-2-yl, 1,2,3-thiadiazol-4-yl, 1,2,3-thiadiazol-5-yl, 1,2,4-thiadiazol-3-yl, 1,2,4-thiadiazol-5-yl, 1,3,4-thiadiazolyl-2-yl, 1,2,3-triazolyl, 1,2,4-triazol-3-yl, tetrazol-5-yl;
   N-linked 5-membered aromatic rings, such as:
pyrrol-1-yl, pyrazol-1-yl, imidazol-1-yl, 1,2,3-triazol-1-yl, 1,2,4-triazol-1-yl, tetrazol-1-yl;
   C-linked 6-membered saturated rings, such as:
tetrahydropyran-2-yl, tetrahydropyran-3-yl, tetrahydropyran-4-yl, piperidin 2-yl, piperidin-3-yl, piperidin-4-yl, tetrahydrothiopyran-2-yl, tetrahydrothiopyran-3-yl, tetrahydrothiopyranyl, 1,3-dioxan-2-yl, 1,3-dioxanyl, 1,3-dioxan-5-yl, 1,4-dioxan-2-yl, 1,3-dithian-2-yl, 1,3-dithian-4-yl, 1,3-dithian-5-yl, 1,4-dithian-2-yl, 1,3-oxathian-2-yl, 1,3-oxathian-4-yl, 1,3-oxathian-5-yl, 1,3-oxathian-yl, 1,4-oxathian-2-yl, 1,4-oxathian-3-yl, 1,2-dithian-3-yl, 1,2-dithian-4-yl, hexahydropyrimidin-2-yl, hexahydropyrimidin-4-yl, hexahydropyrimidin-5-yl, hexahydropyrazin-2-yl, hexahydropyridazin-3-yl, hexahydropyridazin-4-yl, tetrahydro-1,3-oxazin-2-yl, tetrahydro-1,3-oxazin-4-yl, tetrahydro-1,3-oxazin-5-yl, tetrahydro-1,3-oxazin-6-yl, tetrahydro-1,3-thiazin-2-yl, tetrahydro-1,3-thiazinyl, tetrahydro-1,3-thiazin-5-yl, tetrahydro-1,3-thiazinyl, tetrahydro-1,4-thiazin-2-yl, tetrahydro-1,4-thiazin-3-yl, tetrahydro-1,4-oxazin-2-yl, tetrahydro-1,4-oxazin-3-yl, tetrahydro-1,2-oxazin-3-yl, tetrahydro-1,2-oxazinyl, tetrahydro-1,2-oxazin-5-yl, tetrahydro-1,2-oxazinyl;
   N-linked 6-membered saturated rings, such as:
piperidin-1-yl, hexahydropyrimidin-1-yl, hexahydropyrazin-1-yl, hexahydropyridazin-1-yl, tetrahydro-1,3-oxazin-3-yl, tetrahydro-1,3-thiazin-3-yl, tetrahydro-1,4-thiazinyl, tetrahydro-1,4-oxazin-4-yl, tetrahydro-1,2-oxazin-2-yl;
   C-linked 6-membered partially unsaturated rings, such as:
2H-3,4-dihydropyran-6-yl, 2H-3,4-dihydropyran-5-yl, 2H-3,4-dihydropyran-4-yl, 2H-3,4-dihydropyran-3-yl, 2H-3,4-dihydropyran-2-yl, 2H-3,4-dihydropyranyl, 2H-3,4-dihydrothiopyran-5-yl, 2H-3,4-dihydrothiopyran-2-yl, 2H-3,4-dihydropyran-3-yl, 2H-3,4-dihydropyran-2-yl, 1,2,3,4-tetrahydropyridinyl, 1,2,3,4-tetrahydropyridin-5-yl, 1,2,3,4-tetrahydropyridin-4-yl, 1,2,3,4-tetrahydropyridin-3-yl, 1,2,3,4-tetrahydropyridin-2-yl, 2H-5,6-dihydropyran-2-yl, 2H-5,6-dihydropyran-3-yl, 2H-5,6-dihydropyranyl, 2H-5,6-dihydropyran-5-yl, 2H-5,6-dihydropyranyl, 2H-5,6-dihydrothiopyran-2-yl, 2H-5,6-dihydrothiopyran-3-yl, 2H-5,6-dihydrothiopyran-2-yl, 2H-5,6-dihydrothiopyran-5-yl, 2H-5,6-dihydrothiopyran-6-yl, 1,2,5,6-tetrahydropyridin-2-yl, 1,2,5,6-tetrahydropyridin-3-yl, 1,2,5,6-tetrahydropyridin-4-yl, 1,2,5,6-tetrahydropyridin-5-yl, 1,2,5,6-tetrahydropyridin-6-yl, 2,3,4,5-tetrahydropyridin-2-yl, 2,3,4,5-tetrahydropyridin-3-yl, 2,3,4,5-tetrahydropyridinyl, 2,3,4,5-tetrahydropyridin-5-yl, 2,3,4,5-tetrahydropyridinyl, 4H-pyran-2-yl, 4H-pyran-3-yl, 4H-pyranyl, 4H-thiopyran-2-yl, 4H-thiopyran-3-yl, 4H-thiopyran-4-yl, 1,4-dihydropyridin-2-yl, 1,4-dihydropyridin-3-yl, 1,4-dihydropyridin-4-yl, 2H-pyran-2-yl, 2H-pyran-3-yl, 2H-pyranyl, 2H-pyran-5-yl, 2H-pyranyl, 2H-thiopyran-2-yl, 2H-thiopyran-3-yl, 2H-thiopyran-3-yl, 2H-thiopyran-5-yl, 2H-thiopyran-6-yl, 1,2-dihydropyridin-2-yl, 1,2-dihydropyridin-3-yl, 1,2-dihydropyridin-4-yl, 1,2-dihydropyridin-5-yl, 1,2-dihydropyridin-6-yl, 3,4-dihydropyridin-2-yl, 3,4-dihydropyridin-3-yl, 3,4-dihydropyridin-4-yl, 3,4-dihydropyridin-5-yl, 3,4-dihydropyridinyl, 2,5-dihydropyridin-2-yl, 2,5-dihydropyridin-3-yl, 2,5-dihydropyridin-4-yl, 2,5-dihydropyridin-5-yl, 2,5-dihydropyridin-6-yl, 2,3-dihydropyridin-2-yl, 2,3-dihydropyridin-3-yl, 2,3-dihydropyridinyl, 2,3-dihydropyridin-5-yl, 2,3-dihydropyridinyl, 2H-5,6-dihydro-1,2-oxazin-3-yl, 2H-5,6-dihydro-1,2-oxazin-4-yl, 2H-5,6-dihydro-1,2-oxazin-5-yl, 2H-5,6-dihydro-1,2-oxazinyl, 2H-5,6-dihydro-1,2-thiazin-3-yl, 2H-5,6-dihydro-1,2-thiazinyl, 2H-5,6-dihydro-1,2-thiazin-5-yl, 2H-5,6-dihydro-1,2-thiazinyl, 4H-5,6-dihydro-1,2-oxazin-3-yl, 4H-5,6-dihydro-1,2-oxazinyl, 4H-5,6-dihydro-1,2-oxazin-5-yl, 4H-5,6-dihydro-1,2-oxazin-6-yl, 4H-5,6-dihydro-1,2-thiazin-3-yl, 4H-5,6-dihydro-1,2-thiazinyl, 4H-5,6-dihydro-1,2-thiazin-5-yl, 4H-5,6-dihydro-1,2-thiazinyl, 2H-3,6-dihydro-1,2-oxazin-3-yl, 2H-3,6-dihydro-1,2-oxazinyl, 2H-3,6-dihydro-1,2-oxazin-5-yl, 2H-3,6-dihydro-1,2-oxazinyl, 2H-3,6-dihydro-1,2-thiazin-3-yl, 2H-3,6-dihydro-1,2-thiazin-4-yl, 2H-3,6-dihydro-1,2-thiazin-5-yl, 2H-3,6-dihydro-1,2-thiazin-6-yl, 2H-3,4-dihydro-1,2-oxazin-3-yl, 2H-3,4-dihydro-1,2-oxazinyl, 2H-3,4-dihydro-1,2-oxazin-5-yl, 2H-3,4-dihydro-1,2-oxazinyl, 2H-3,4-dihydro-1,2-thiazin-3-yl, 2H-3,4-dihydro-1,2-thiazin-4-yl, 2H-3,4-dihydro-1,2-thiazin-5-yl, 2H-3,4-dihydro-1,2-thiazin-yl, 2,3,4,5-tetrahydropyridazin-3-yl, 2,3,4,5-tetrahydropyridazin-4-yl, 2,3,4,5-tetrahydropyridazin-5-yl, 2,3,4,5-tetrahydropyridazin-6-yl, 3,4,5,6-tetrahydropyridazin-3-yl, 3,4,5,6-tetrahydropyridazin-4-yl, 1,2,5,6-tetrahydropyridazin-3-yl, 1,2,5,6-tetrahydropyridazin-yl, 1,2,5,6-tetrahydropyridazin-5-yl, 1,2,5,6-tetrahydropyridazinyl, 1,2,3,6-tetrahydropyridazin-3-yl, 1,2,3,6-tetrahydropyridazinyl, 4H-5,6-dihydro-1,3-oxazin-2-yl, 4H-5,6-dihydro-1,3-oxazin-4-yl, 4H-5,6-dihydro-1,3-oxazin-5-yl, 4H-5,6-dihydro-1,3-oxazinyl, 4H-5,6-dihydro-1,3-thiazin-2-yl, 4H-5,6-dihydro-1,3-thiazin-4-yl, 4H-5,6-dihydro-1,3-thiazin-5-yl, 4H-5,6-dihydro-1,3-thiazin-yl, 3,4,5,6-tetrahydropyrimidin-2-yl, 3,4,5,6-tetrahydropyrimidinyl, 3,4,5,6-tetrahydropyrimidin-5-yl, 3,4,5,6-tetrahydropyrimidin-yl, 1,2,3,4-tetrahydropyrazin-2-yl, 1,2,3,4-tetrahydropyrazin-5-yl, 1,2,3,4-tetrahydropyrimidin-2-yl, 1,2,3,4-tetrahydropyrimidin-4-yl, 1,2,3,4-tetrahydropyrimidin-5-yl, 1,2,3,4-tetrahydropyrimidinyl, 2,3-dihydro-1,4-thiazin-2-yl, 2,3-dihydro-1,4-thiazin-yl, 2,3-dihydro-1,4-thiazin-5-yl, 2,3-dihydro-1,4-thiazin-6-yl, 2H-1,2-oxazin-yl, 2H-1,2-oxazinyl, 2H-1,2-oxazin-5-yl, 2H-1,2-oxazin-6-yl, 2H-1,2-thiazin-3-yl, 2H-1,2-thiazin-4-yl, 2H-1,2-thiazin-5-yl, 2H-1,2-thiazinyl, 4H-1,2-oxazin-3-yl, 4H-1,2-oxazin-4-yl, 4H-1,2-oxazin-yl, 4H-1,2-oxazinyl, 4H-1,2-thiazin-3-yl, 4H-1,2-thiazinyl, 4H-1,2-thiazin-5-yl, 4H-1,2-thiazin-6-yl, 6H-1,2-oxazin-3-yl, 6H-1,2-oxazinyl, 6H-1,2-oxazin-5-yl, 6H-1,2-oxazinyl, 6H-1,2-thiazin-3-yl, 6H-1,2-thiazin-4-yl, 6H-1,2-thiazin-5-yl, 6H-1,2-thiazin-6-yl, 2H-1,3-oxazin-2-yl, 2H-1,3-oxazin-4-yl, 2H-1,3-oxazin-5-yl, 2H-1,3-oxazinyl, 2H-1,3-thiazin-2-yl, 2H-1,3-thiazin-4-yl, 2H-1,3-thiazin-5-yl, 2H-1,3-thiazin-6-yl, 4H-1,3-oxazin-2-yl, 4H-1,3-oxazin-4-yl, 4H-1,3-oxazin-5-yl, 4H-1,3-oxazinyl, 4H-1,3-thiazin-2-yl, 4H-1,3-thiazin-4-yl, 4H-1,3-thiazin-5-yl, 4H-1,3-thiazinyl, 6H-1,3-oxazin-2-yl, 6H-1,3-oxazin-4-yl, 6H-1,3-oxazin-5-yl, 6H-1,3-oxazinyl, 6H-1,3-thiazin-2-yl, 6H-1,3-oxazin-4-yl, 6H-1,3-oxazin-5-yl, 6H-1,3-thiazin-6-yl, 2H-1,4-oxazin-2-yl, 2H-1,4-oxazin-3-yl, 2H-1,4-oxazin-5-yl, 2H-1,4-oxazin-6-yl, 2H-1,4-thiazin-2-yl, 2H-1,4-thiazin-3-yl, 2H-1,4-thiazin-5-yl, 2H-1,4-thiazin-6-yl, 4H-1,4-oxazin-2-yl, 4H-1,4-oxazin-3-yl, 4H-1,4-thiazin-2-yl, 4H-1,4-thiazin-3-yl, 1,4-dihydropyridazin-3-yl, 1,4-dihydropyridazin-4-yl, 1,4-dihydropyridazin-5-yl, 1,4-dihydropyridazin-6-yl, 1,4-dihydropyrazin-2-yl, 1,2-dihydropyrazin-2-yl, 1,2-dihydropyrazin-3-yl, 1,2-dihydropyrazin-5-yl, 1,2-dihydropyrazinyl, 1,4-dihydropyrimidin-2-yl, 1,4-dihydropyrimidin-4-yl, 1,4-dihydropyrimidin-5-yl, 1,4-dihydropyrimidinyl, 3,4-dihydropyrimidin-2-yl, 3,4-dihydropyrimidin-4-yl, 3,4-dihydropyrimidin-5-yl or 3,4-dihydropyrimidinyl;
   N-linked 6-membered partially unsaturated rings, such as:
1,2,3,4-tetrahydropyridin-1-yl, 1,2,5,6-tetrahydropyridin-1-yl, 1,4-dihydropyridin-1-yl, 1,2-dihydropyridin-1-yl, 2H-5,6-dihydro-1,2-oxazin-2-yl, 2H-5,6-dihydro-1,2-thiazin-2-yl, 2H-3,6-dihydro-1,2-oxazin-2-yl, 2H-3,6-dihydro-1,2-thiazin-2-yl, 2H-3,4-hydro-1,2-oxazin-2-yl, 2H-3,4-dihydro-1,2-thiazin-2-yl, 2,3,4,5-tetrahydropyridazin-2-yl, 1,2,5,6-tetrahydropyridazin-1-yl, 1,2,5,6-tetrahydropyridazin-2-yl, 1,2,3,6-tetrahydropyridazin-1-yl, 3,4,5,6-tetrahydropyrimidin-3-yl, 1,2,3,4-tetrahydropyrazin-1-yl, 1,2,3,4-tetrahydropyrimidin-1-yl, 1,2,3,4-tetrahydropyrimidin-3-yl, 2,3-dihydro-1,4-thiazin-4-yl, 2H-1,2-oxazin-2-yl, 2H-1,2-thiazin-2-yl, 4H-1,4-oxazin-4-yl, 4H-1,4-thiazin-4-yl, 1,4-dihydropyridazin-1-yl, 1,4-dihydropyrazin-1-yl, 1,2-dihydropyrazin-1-yl, 1,4-dihydropyrimidin-1-yl or 3,4-dihydropyrimidin-3-yl;
   C-linked 6-membered aromatic rings, such as:
pyridin-2-yl, pyridin-3-yl, pyridinyl, pyridazin-3-yl, pyridazin-4-yl, pyrimidin-2-yl, pyrimidinyl, pyrimidin-5-yl, pyrazin-2-yl, 1,3,5-triazin-2-yl, 1,2,4-triazin-yl, 1,2,4-triazin-5-yl, 1,2,4-triazinyl, 1,2,4,5-tetrazin-3-yl;
   it being possible for a bicyclic ring system to be formed with a fused-on phenyl ring or with a CC-carbocycle or with a further 5- or 6-membered heterocycle.
   C-linked 5- or 6-membered heteroaryl having one of four nitrogen atoms, or one to thee nitrogen atoms and one oxygen or sulfur atom, or having one oxygen or sulfur atom:
   for example aromatic 5-membered heterocycles which are attached via a carbon atom and which, in addition to carbon atoms, may contain one to four nitrogen atoms, or one to three nitrogen atoms and one sulfur or oxygen atom, or one sulfur or oxygen atom as ring members, for example 2-furyl, 3-furyl, 2-thienyl, 3-thienyl, 2-pyrrolyl, 3-pyrrolyl, 3-isoxazolyl, 4-isoxazolyl, 5-isoxazolyl, 3-isothiazolyl, 4-isothiazolyl, 5-isothiazolyl, 3-pyrazolyl, 4-pyrazolyl, 5-pyrazolyl, 2-oxazolyl, 4-oxazolyl, 5-oxazolyl, 2-thiazolyl, 4-thiazolyl, 5-thiazolyl, 2-imidazolyl, 4-imidazolyl, 1,2,4-oxadiazol-3-yl, 1,2,4-oxadiazol-5-yl, 1,2,4-thiadiazol-3-yl, 1,2,4-thiadiazol-5-yl, 1,2,4-triazol-3-yl, 1,3,4-oxadiazol-2-yl, 1,3,4-thiadiazol-2-yl and 1,3,4-triazol-2-yl;
   for example aromatic 6-membered heterocycles attached via a carbon atom which, in addition to carbon atoms, may contain one to four, preferably one to three, nitrogen atoms as ring members, for example 2-pyridinyl, 3-pyridinyl, 4-pyridinyl, 3-pyridazinyl, 4-pyridazinyl, 2-pyrimidinyl, 4-pyrimidinyl, 5-pyrimidinyl, 2-pyrazinyl, 1,3,5-triazin-2-yl and 1,2,4-triazin-3-yl;
   Unless indicated otherwise, all phenyl rings or heterocyclyl radicals and all phenyl components in phenyl-C₁-C₁-alkyl, phenylcarbonyl, phenylcarbonyl-C₁-C₆-alkyl, phenoxycarbonyl, phenylaminocarbonyl, phenylsulfonylaminocarbonyl, N—C₁-C₆-alkyl)-N-phenylaminocarbonyl and phenyl-C₁-C₆-alkylcarbonyl, and all heterocyclyl components in heterocyclyl-C₁-C₆-alkyl, heterocyclylcarbonyl, heterocyclylcarbonyl-C₁-C₆-alkyl, heterocyclyloxycarbonyl, heterocyclylaminocarbonyl, heterocyclylsulfonylaminocarbonyl, N—(C₁-C₆-alkyl-N-heterocyclylaminocarbonyl and heterocyclyl-C₁-C₆-alkylcarbonyl are preferably unsubstituted or carry one to three halogen atoms and/or one nitro group, one cyano radical and/or one or two methyl, trifluoromethyl, methoxy or trifluoromethoxy substituents.

In a particular embodiment, the variables of the compounds of the formula I have the meanings given below, which, on their own and in combination with one another, are particular embodiments of the compounds of the formula I:

Preference is given to the heteroaroyl-substituted phenylalanineamides of the formula I in which
A is C-linked 5-membered heteroaryl having one to four nitrogen atoms, or one to three nitrogen atoms and one oxygen or sulfur atom, or having one oxygen or sulfur atom;
   particularly preferably 5-membered heteroaryl selected from the group consisting of thienyl, furyl, pyrazolyl, imidazolyl, thiazolyl and oxazolyl;
   especially preferably 5-membered heteroaryl selected from the group consisting of thienyl, furyl, pyrazolyl and imidazolyl;
   where the heteroaryl radicals mentioned may be partially or fully halogenated and/or may carry 1 to 3 radicals from the group consisting of cyano, C₁-C₆-alkyl, C₃-C₆-cycloalkyl, C₁-C₆-haloalkyl, C₁-C₆-alkoxy, C₁-C₆-haloalkoxy, C₁-C₆-alkoxy-C₁-C₄-alkyl, amino, (C₁-C₆-alkyl)amino and di(C₁-C₆-alkyl)amino.

Preference is likewise given to the heteroaroyl-substituted phenylalanineamides of the formula I, in which
A is C-linked 6-membered heteroaryl having one to four nitrogen atoms;
   particularly preferably pyridyl or pyrimidyl.
   especially preferably pyrimidyl;
   where the heteroaryl radicals mentioned may be partially or fully halogenated and/or may carry 1 to 3 radicals from the group consisting of cyano, C₁-C₆-alkyl, C₃-C₆-cycloalkyl, C₁-C₆-haloalkyl, C₁-C₆-alkoxy, C₁-C₆-haloalkoxy, C₁-C₆-alkoxy-C₁-C₄-alkyl, amino, (C₁-C₆-alkyl)amino and di(C₁-C₆-alkyl)amino.

Preference is likewise given to the heteroaroyl-substituted phenylalanineamides of the formula I in which
A is C-linked 5- or 6-membered heteroaryl selected from the group consisting of pyrrolyl, thienyl, furyl, pyrazolyl, imidazolyl, thiazolyl, oxazolyl, tetrazolyl, pyridyl and pyrimidinyl; where the heteroaryl radicals mentioned may be partially or fully halogenated and/or may carry 1 to 3 radicals selected from the group consisting of cyano, C₁-C₆-alkyl, C₃-C₆-cycloalkyl, C₁-C₆-haloalkyl, C₁-C₆-alkoxy, C₁-C₆-haloalkoxy, C₁-C₆-alkoxy-C₁-C₄-alkyl, amino, (C₁-C₆-alkyl)amino and di(C₁-C₆-alkyl)amino;
particularly preferably C-linked 5- or 6-membered heteroaryl selected from the group consisting of thienyl, furyl, pyrazolyl, imidazolyl, thiazolyl, oxazolyl and pyridyl; where the heteroaryl radicals mentioned may be partially or fully halogenated and/or may carry 1 to 3 radicals from the group consisting of C₁-C₆-alkyl, C₁-C₆-cycloalkyl and C₁-C₆-haloalkyl;
   especially preferably C-linked 5-membered heteroaryl selected from the group consisting of thienyl, furyl, pyrazolyl, imidazolyl, thiazolyl and oxazolyl; where
      the heteroaryl radicals mentioned may be partially halogenated and/or may carry 1 to 2 radicals from the group consisting of C₁-C₆-alkyl and C₁-C₄-haloalkyl;
   most preferably C-linked 5-membered heteroaryl selected from the group consisting of thienyl, furyl, pyrazolyl and imidazolyl; where
      the heteroaryl radicals mentioned may be partially halogenated and/or may carry 1 to 2 radicals from the group consisting of C₁-C₆-alkyl and C₁-C₄-haloalkyl.

Preference is likewise given to the heteroaryl-substituted phenylalanineamides of the formula I in which
A is C-linked 5- or 6-membered heteroaryl selected from the group consisting of A1 to A14 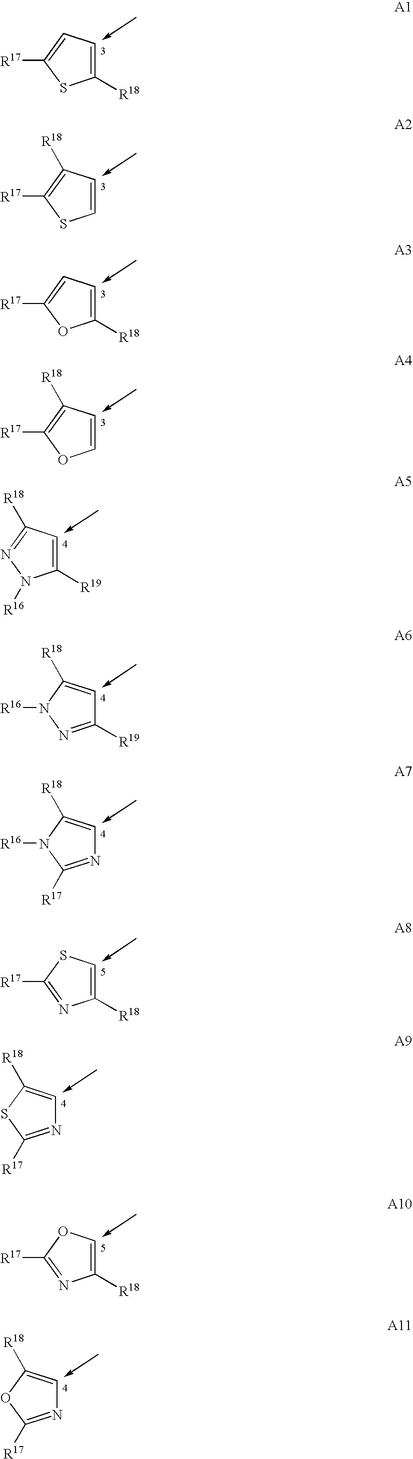 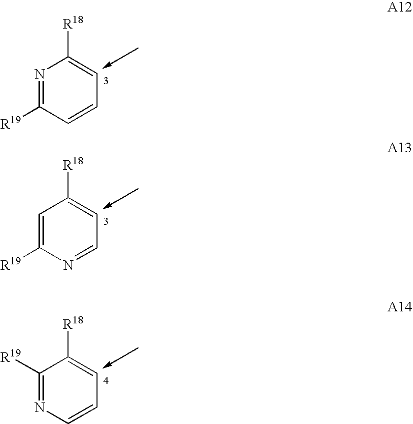
where the arrow indicates the point of attachment and
   R¹⁶ is hydrogen, C₁-C₆-alkyl, C₃-C₆-cycloalkyl, C₁-C₆-haloalkyl or C₁-C₆-alkoxy-C₁-C₄-alkyl,
      particularly preferably C₁-C₄-alkyl, C₃-C₆-cycloalkyl, C₁-C₄-haloalkyl or C₁-C₄-alkoxy-C₁-C₄-alkyl,
      especially preferably C₁-C₄-alkyl or C₁-C₄-haloalkyl,
      most preferably C₁-C₄-alkyl,
      with extraordinary preference CH₃;
   R¹⁷ is hydrogen, halogen, C₁-C₆-alkyl or C₁-C₆-haloalkyl,
      particularly preferably hydrogen, C₁-C₄-alkyl or C₁-C₄-haloalkyl,
      especially preferably hydrogen or C₁-C₄-alkyl,
      most preferably hydrogen;
   R¹⁸ is halogen, C₁-C₆-alkyl, C₁-C₆-haloalkyl or C₁-C₆-haloalkoxy,
      particularly preferably halogen, C₁-C₄-alkyl or C₁-C₄-haloalkyl,
      especially preferably halogen or C₁-C₄-haloalkyl, most preferably CF₃;
   R¹⁹ is hydrogen, halogen, C₁-C₆-alkyl or C₁-C₆-haloalkyl,
      particularly preferably hydrogen, halogen or C₁-C₄-haloalkyl,
      especially preferably hydrogen or halogen,
      most preferably hydrogen; and
   particularly preferably A1, A2, A3, A4, A5, A6, A8 or A9;
      where R¹⁶ to R¹⁹ are as defined above;
   most preferably A1, A2, A5 or A6;
      where R¹⁶ to R¹⁹ are as defined above.

Preference is likewise given to the heteroaroyl-substituted phenylalanineamides of the formula I in which
A is 3-pyrazolyl which may be partially or fully halogenated and/or may be substituted by one to three radicals from the group consisting of C₁-C₆-alkyl, C₃-C₆-cycloalkyl, C₁-C₆-haloalkyl and C₁-C₆-alkoxy-C₁-C₄-alkyl;
   particularly preferably 3-pyrazolyl which may be partially halogenated and/or may be substituted by one to three radicals from the group consisting of C₁-C₆-alkyl, C₃-C₆-Cycloalkyl, C₁-C₆-haloalkyl and C₁-C₆-alkoxy-C₁-C₄-alkyl;
   especially preferably 3-pyrazolyl which may be substituted by one to three radicals from the group consisting of C₁-C₄-alkyl, C₃-C₆-cycloalkyl, C₁-C₄-haloalkyl and C₁-C₄-alkoxy-C₁-C₄-alkyl.

Preference is likewise given to the heteroaroyl-substituted phenylalanineamides of the formula I in which
A is 4-pyrazolyl which may be partially or fully halogenated and/or may be substituted by one to three radicals from the group consisting of C₁-C₆-alkyl, C₃-C₆-Cycloalkyl, C₁-C₆-haloalkyl and C₁-C₆-alkoxy-C₁-C₄-alkyl;
   particularly preferably 4-pyrazolyl which may be partially halogenated and/or may be substituted by one to three radicals from the group consisting of C₁-C₆-alkyl, C₃-C₆-Cycloalkyl, C₁-C₆-haloalkyl and C₁-C₆-alkoxy-C₁-C₄-alkyl;
   especially preferably 4-pyrazolyl which may be substituted by one to three radicals from the group consisting of C₁-C₄-alkyl, C₃-C₆-cycloalkyl, C₁-C₄-haloalkyl and C₁-C₄-alkoxy-C₁-C₄-alkyl.

Preference is also give to the heteroaroyl-substituted phenylalanineamides of the formula I in which
A is C-linked pyrazolyl selected from the group consisting of A1a to A4a 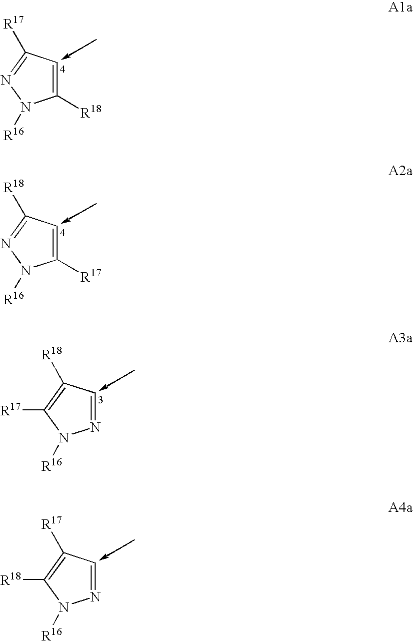
where the arrow indicates the point of attachment and
   R¹⁶ is C₁-C₆-alkyl, C₃-C₆-cycloalkyl, C₁-C₆-haloalkyl or C₁-C₆-alkoxy-C₁-C₄-alkyl;
      particularly preferably C₁-C₄-alkyl, C₃-C₆-cycloalkyl, C₁-C₄-haloalkyl or C₁-C₄-alkoxy-C₁-C₄-alkyl,
      especially preferably C₁-C₄-alkyl or C₁-C₄-haloalkyl,
      with extraordinary preference C₁-C₄-alkyl,
      with most extraordinary preference CH₃;
   R¹⁷ is hydrogen, halogen, C₁-C₆-alkyl or C₁-C₆-haloalkyl,
      particularly preferably hydrogen, C₁-C₄-alkyl or C₁-C₄-haloalkyl,
      especially preferably hydrogen or C₁-C₄-alkyl,
      with extraordinary preference hydrogen;
   R¹⁸ is halogen, C₁-C₆-alkyl or C₁-C₆-haloalkyl,
      particularly preferably halogen, C₁-C₄-alkyl or C₁-C₄-haloalkyl,
      especially preferably C₁-C₄-haloalkyl,
      with extraordinary preference CF₃;
   particularly preferably A1a, A2a or A3, where R¹⁶ to R¹⁸ are as defined above;
   with extraordinary preference A1a or A2a, where R¹⁶ to R¹ are as defined above.

Preference is likewise given to the heteroaroyl-substituted phenylalanineamides of the formula I in which
R¹ is hydrogen or hydroxyl;
   particularly preferably hydrogen; and
R² is hydrogen.

Preference is likewise given to the heteroaroyl-substituted phenylalanineamides of the formula I, in which
R³ is C₁-C₆-alkyl or C₁-C₆-haloalkyl;
   particularly preferably C₁-C₆-alkyl;
   especially preferably C₁-C₄-alkyl;
   with extraordinary preference CH₃.

Preference is also give to the heteroaroyl-substituted phenylalanineamides of the formula I in which
R⁴ is hydrogen, C₁-C₄-alkyl, C₁-C₄-haloalkyl, OR¹¹, SR¹² or NR¹³R¹⁴;
   particularly preferably hydrogen, C₁-C₄-alkyl, OR¹¹, SR¹² or NR¹³R¹⁴;
   especially preferably hydrogen or C₁-C₄-alkyl;
   with very extraordinary preference hydrogen;
   also with very extraordinary preference C₁-C₄-alkyl.

Preference is also given to the heteroaroyl-substituted phenylalanineamides of the formula I in which
R⁴ is hydrogen, C₁-C₄-alkyl or OR¹¹;
   particularly preferably C₁-C₄-alkyl or OR¹¹;
   especially preferably OR¹¹.

Preference is also given to the heteroaroyl-substituted phenylalanineamides of the formula I in which
R⁴ is hydrogen, C₁-C₄-alkyl or SR¹²;
   particularly preferably C₁-C₄-alkyl or SR¹²;
   especially preferably SR¹².

Preference is also given to the heteroaroyl-substituted phenylalanineamides of the formula I in which
R⁴ is hydrogen, C₁-C₄-alkyl or NR¹³R¹⁴;
   particularly preferably C₁-C₄-alkyl or NR¹³R¹⁴;
   especially preferably NR¹³R¹⁴.

Preference is also given to the heteroaroyl-substituted phenylalanineamides of the formula I in which
R⁴ is OR¹¹, SR¹² or NR¹³R¹⁴;
   particularly preferably OR¹¹ or SR¹²;
   especially preferably OR¹¹.

Preference is also given to the heteroaroyl-substituted phenylalanineamides of the formula I in which
R⁵ is hydrogen or C₁-C₄-alkyl;
   preferably hydrogen or CH₃;
   especially preferably hydrogen.

Preference is also given to the heteroaroyl-substituted phenylalanineamides of the formula I in which
R⁶ is hydrogen, halogen, cyano, C₁-C₆-alkyl, hydroxyl or C₁-C₆-alkoxy;
   particularly preferably hydrogen, halogen, cyano or C₁-C₆-alkyl;
   especially preferably hydrogen, halogen, cyano or C₁-C₄-alkyl;
   with extraordinary preference hydrogen, fluorine or CH₃.

Preference is also given to the heteroaroyl-substituted phenylalanineamides of the formula I in which
R⁷ is hydrogen, halogen, cyano, C₁-C₆-alkyl or C₁-C₆-haloalkyl;
   particularly preferably hydrogen, halogen, cyano or C₁-C₆-alkyl;
   especially preferably hydrogen, halogen, cyano or C₁-C₄-alkyl;
   with extraordinary preference hydrogen, halogen or cyano;
   with very extraordinary preference hydrogen, fluorine or chlorine.

Preference is also given to the heteroaroyl-substituted phenylalanineamides of the formula I in which
R⁸, R⁹ and R¹⁰ are each independently of one another hydrogen, halogen, cyano, C₁-C₄-alkyl or C₁-C₄-haloalkyl;
   particularly preferably hydrogen, halogen or cyano;
   especially preferably hydrogen, fluorine or chlorine;
   with extraordinary preference hydrogen.

Preference is also given to the heteroaroyl-substituted phenylalanineamides of the formula I in which
R¹¹, R¹² and R¹³ are each independently of one another hydrogen, C₁-C₆-alkyl, C₃-C₆-alkenyl, C₃-C₆-alkynyl, C₁-C₆-alkylcarbonyl, C₁-C₆-alkenylcarbonyl, C₃-C₆-cycloalkylcarbonyl, C₁-C₆-alkoxycarbonyl, C₁-C₆-alkylaminocarbonyl, C₁-C₆-alkylsulfonylaminocarbonyl, di(C₁-C₆-alkyl)aminocarbonyl, N—(C₁-C₆-alkoxy)-N—(C₁-C₆-alkyl)aminocarbonyl, di(C₁-C₆-alkyl)aminothiocarbonyl, C₁-C₆-alkoxyimino-C₁-C₆-alkyl,
   where the alkyl, cycloalkyl and alkoxy radicals mentioned may be partially or fully halogenated and/or may carry one to three of the following groups: cyano, hydroxyl, C₃-C₆-cycloalkyl, C₁-C₄-alkoxy, C₁-C₄-alkylthio, di(C₁-C₄-alkyl)amino, C₁-C₄-alkylcarbonyl, hydroxycarbonyl, C₁-C₄-alkoxycarbonyl, aminocarbonyl, C₁-C₄-alkylaminocarbonyl, di(C₁-C₄-alkyl)aminocarbonyl, or C₁-C₄-alkylcarbonyloxy;
   phenyl, phenyl-C₁-C₆-alkyl, phenylcarbonyl, phenylcarbonyl-C₁-C₆-alkyl, phenylsulfonylaminocarbonyl or phenyl-C₁-C₆-alkylcarbonyl,
   where the phenyl radical of the 6 last-mentioned substituents may be partially or fully halogenated and/or may carry one to three of the following groups: nitro, cyano, C₁-C₄-alkyl, C₁-C₄-haloalkyl, C₁-C₄-alkoxy or C₁-C₄-haloalkoxy; or
   SO₂R¹⁵;
   particularly preferably hydrogen, C₁-C₆-alkyl, C₃-C₆-alkenyl, C₃-C₆-alkynyl, C₁-C₆-alkylcarbonyl, C₂-C₆-alkenylcarbonyl, C₁-C₆-alkoxycarbonyl, C₁-C₆-alkylsulfonylaminocarbonyl, di(C₁-C₆-alkyl)aminocarbonyl, N—(C₁-C₆-alkoxy)-N—(C₁-C₆-alkyl)aminocarbonyl or di(C₁-C₆-alkyl)aminothiocarbonyl,
   where the alkyl or alkoxy radicals mentioned may be partially or fully halogenated and/or may carry one to three of the following groups: cyano, C₁-C₄-alkoxy, C₁-C₄-alkoxycarbonyl, C₁-C₄-alkylaminocarbonyl, di(C₁-C₄-alkyl)aminocarbonyl or C₁-C₄-alkylcarbonyloxy;
   phenyl-C₁-C₆-alkyl, phenylcarbonyl, phenylcarbonyl-C₁-C₆-alkyl, phenylsulfonylaminocarbonyl or phenyl-C₁-C₆-alkylcarbonyl,
   where the phenyl ring of the 5 last-mentioned substituents may be partially or fully halogenated and/or may carry one to three of the following groups: nitro, cyano, C₁-C₄-alkyl, C₁-C₄-haloalkyl, C₁-C₄-alkoxy or C₁-C₄-halooxy; or
   SO₂R¹⁵;
   especially preferably hydrogen, C₁-C₆-alkyl, C₃-C₆-alkenyl, C₃-C₆-alkynyl, C₁-C₆-alkylcarbonyl, C₁-C₆-alkenylcarbonyl, C₁-C₆-alkoxycarbonyl, di(C₁-C₆-alkyl)aminocarbonyl, N—(C₁-C₆-alkoxy)-N—(C₁-C₆-alkyl)aminocarbonyl, di(C₁-C₆-alkyl)aminothiocarbonyl, phenyl-C₁-C₆-alkyl, phenylcarbonyl, phenylcarbonyl-C₁-C₆-alkyl or phenyl-C₁-C₆-alkylcarbonyl, where the phenyl ring of the 4 last-mentioned substituents may be partially or fully halogenated and/or may carry one to three of the following groups: nitro, cyano, C₁-C₄-alkyl, C₁-C₄-haloalkyl, C₁-C₄-alkoxy or C₁-C₄-haloalkoxy; or
   SO₂R¹⁵.

Preference is also given to the heteroaroyl-substituted phenylalanineamides of the formula I in which
R¹¹, R¹² and R¹³ are each independently of one another hydrogen, C₁-C₆-alkyl, C₃-C₆-alkenyl, C₃-C₆-alkynyl, C₁-C₆-alkylcarbonyl, C₂-C₆-alkenylcarbonyl, C₃-C₆-cycloalkylcarbonyl, C₁-C₆-alkoxycarbonyl, C₁-C₆-alkylaminocarbonyl, di(C₁-C₆-alkyl)aminocarbonyl, N—(C₁-C₆-alkoxy)-N—(C₁-C₆-alkyl)aminocarbonyl, di(C₁-C₆-alkyl)aminothiocarbonyl, C₁-C₆-alkoxyimino-C₁-C₆-alkyl, where the alkyl, cycloalkyl or alkoxy radicals mentioned may be partially or fully halogenated and/or may carry one to three of the following groups:
   cyano, hydroxyl, C₃-C₆-cycloalkyl, C₁-C₄-alkoxy, C₁-C₄-alkylthio, di(C₁-C₄-alkyl)amino, C₁-C₄-alkylcarbonyl, hydroxycarbonyl, C₁-C₄-alkoxycarbonyl, aminocarbonyl, C₁-C₄-alkylaminocarbonyl, di(C₁-C₄-alkyl)aminocarbonyl or C₁-C₄-alkylcarbonyloxy; or
   SO₂R¹⁵.

Preference is also given to the heteroaroyl-substituted phenylalanineamides of the formula I in which R¹¹ and R¹³ are each independently of one another hydrogen, C₁-C₆-alkyl, C₃-C₆-alkenyl, C₃-C₆-alkynyl, C₁-C₆-alkylcarbonyl, C₁-C₆-alkoxycarbonyl, C₁-C₆-alkylaminocarbonyl, di(C₁-C₆-alkyl)aminocarbonyl, N—(C₁-C₆-alkoxy)-N—(C₁-C₆-alkyl)aminocarbonyl,
where the alkyl and alkoxy radicals mentioned may be partially or fully halogenated and/or may carry one to three of the following groups:

cyano, C₁-C₄-alkoxy, C₁-C₄-alkylaminocarbonyl or di(C₁-C₄-alkyl)aminocarbonyl; phenyl-C₁-C₆-alkyl, phenylcarbonyl, phenylcarbonyl-C₁-C₆-alkyl, phenylaminocarbonyl, N—(C₁-C₆-alkyl)-N-(phenyl)aminocarbonyl or heterocyclylcarbonyl, where the phenyl and the heterocyclyl radical of the 6 last-mentioned substituents may be partially or fully halogenated and/or may carry one to three of the following groups: cyano, C₁-C₄-alkyl or C₁-C₄-haloalkyl; or
SO₂R¹⁵;
particularly preferably hydrogen, C₁-C₄-alkyl, C₃-C₄-alkenyl, C₃-C₄-alkynyl, C₁-C₄-alkylcarbonyl, C₁-C₄-alkoxycarbonyl, C₁-C₄-alkylaminocarbonyl, di(C₁-C₄-alkyl)aminocarbonyl, N—(C₁-C₄-alkoxy)-N—(C₁-C₄-alkyl)aminocarbonyl, where the alkyl and alkoxy radicals mentioned may be partially or fully halogenated and/or may carry one to three of the following groups: cyano, C₁-C₄-alkoxy, C₁-C₄-alkylaminocarbonyl or di(C₁-C₄-alkyl)aminocarbonyl;
phenyl-C₁-C₄-alkyl, phenylcarbonyl, phenylcarbonyl-C₁-C₄-alkyl, phenylaminocarbonyl, N—(C₁-C₄-alkyl)-N-(phenyl)aminocarbonyl or heterocyclylcarbonyl,
where the phenyl and the heterocyclyl radical of the 6 last-mentioned substituents may be partially or fully halogenated and/or may carry one to three of the following groups: cyano, C₁-C₄-alkyl or C₁-C₄-haloalkyl; or
SO₂R¹⁵;
especially preferably hydrogen or C₁-C₄-alkyl, where the alkyl radical mentioned may be partially or fully halogenated and/or may carry one to three of the following groups:
cyano, C₁-C₄-alkoxy, C₁-C₄-alkylaminocarbonyl or
di(C₁-C₄-alkyl)aminocarbonyl;
phenyl-C₁-C₄-alkyl, phenylcarbonyl, phenylcarbonyl-C₁-C₄-alkyl, phenylaminocarbonyl, N—(C₁-C₄-alkyl)-N-(phenyl)aminocarbonyl or
heterocyclylcarbonyl, or
SO₂R¹⁵;
with extraordinary preference hydrogen, C₁-C₆-alkylcarbonyl, C₁-C₆-alkylaminocarbonyl, di-(C₁-C₄-alkyl)aminocarbonyl, phenylaminocarbonyl, N(C₁-C₄-alkyl)-N-(phenyl)aminocarbonyl, SO₂CH₃, SO₂CF₃ or SO₂(C₆H₅).

Preference is also given to the heteroaroyl-substituted phenylalanineamides of the formula I in which
R¹² is hydrogen, C₁-C₆-alkylcarbonyl, C₁-C₆-alkoxycarbonyl, C₁-C₆-alkylaminocarbonyl, di(C₁-C₆-alkyl)aminocarbonyl or N—(C₁-C₆-alkoxy)-N—(C₁-C₆-alkyl)aminocarbonyl,
   where the alkyl and alkoxy radicals mentioned may be partially or fully halogenated and/or may carry one to three of the following groups: cyano or C₁-C₄-alkoxy;
   particularly preferably hydrogen, C₁-C₄-alkylcarbonyl, C₁-C₄-alkoxycarbonyl, C₁-C₄-alkylaminocarbonyl, di(C₁-C₄-alkyl)aminocarbonyl or N—(C₁-C₄-alkoxy)-N—(C₁-C₄-alkyl)aminocarbonyl,
   where the alkyl and alkoxy radicals mentioned may be partially or fully halogenated and/or may carry one to three of the following groups: cyano or C₁-C₄-alkoxy;
   particularly preferably hydrogen, C₁-C₄-alkylcarbonyl, C₁-C₄-alkoxycarbonyl, C₁-C₄-alkylaminocarbonyl, di(C₁-C₄-alkyl)aminocarbonyl, N—(C₁-C₄-alkoxy)-N—(C₁-C₄-alkyl)aminocarbonyl.

Preference is also given to the heteroaroyl-substituted phenylalanineamides of the formula I in which
R¹⁴ is hydrogen, C₁-C₆-alkyl, C₃-C₆-cycloalkyl, C₃-C₆-alkenyl or C₃-C₆-alkynyl, where the 4 last-mentioned radicals may be partially or fully halogenated and/or may carry one to three of the following groups: cyano, hydroxyl, C₃-C₆-cycloalkyl, C₁-C₄-alkoxy, C₁-C₄-alkylthio, di(C₁-C₄-alkyl)amino, C₁-C₄-alkylcarbonyl, hydroxycarbonyl, C₁-C₄-alkoxycarbonyl, aminocarbonyl, C₁-C₄-alkylaminocarbonyl, di(C₁-C₄-alkyl)aminocarbonyl or C₁-C₄-alkylcarbonyloxy;
   phenyl or phenyl-C₁-C₆-alkyl, where the phenyl ring of the 2 last-mentioned substituents may be partially or fully halogenated and/or may carry one to three of the following groups: nitro, cyano, C₁-C₄-alkyl, C₁-C₄-haloalkyl, C₁-C₄-alkoxy or C₁-C₄-haloalkoxy;
   particularly preferably hydrogen, C₁-C₆-alkyl, C₃-C₆-alkenyl or C₃-C₆-alkynyl, where the 3 radicals mentioned may be partially or fully halogenated and/or may carry one to three of the following groups:
   cyano, C₁-C₄-alkoxy, C₁-C₄-alkoxycarbonyl, C₁-C₄-alkylaminocarbonyl, di(C₁-C₄-alkyl)aminocarbonyl or C₁-C₄-alkylcarbonyloxy; or
   phenyl or phenyl-C₁-C₄-alkyl, where the phenyl ring of the 2 last-mentioned substituents may be partially or fully halogenated and/or may carry one to three of the following groups: nitro, cyano, C₁-C₄-alkyl, C₁-C₄-haloalkyl, C₁-C₄-alkoxy or C₁-C₄-haloalkoxy;
   especially preferably hydrogen or C₁-C₆-alkyl, where the alkyl radical may be partially or fully halogenated; or
   phenyl or phenyl-C₁-C₄-alkyl, where the phenyl ring of the 2 last-mentioned substituents may be partially or fully halogenated and/or may carry one to three of the following groups: cyano, C₁-C₄-alkyl or C₁-C₄-haloalkyl;
   with extraordinary preference hydrogen or C₁-C₄-alkyl.

Preference is also given to the heteroaroyl-substituted phenylalanineamides of the formula I in which
R¹⁵ is C₁-C₆-alkyl, C₁-C₆-haloalkyl or phenyl, where the phenyl radical may be partially or fully halogenated and/or may be substituted by C₁-C₄-alkyl;
   particularly preferably C₁-C₄-alkyl, C₁-C₄-haloalkyl or phenyl;
   especially preferably methyl, trifluoromethyl or phenyl.

Preference is also given to the heteroaroyl-substituted phenylalanineamides of the formula I in which
R¹ and R² are hydrogen;
R³ is C₁-C₄-alkyl, particularly preferably CH₃;
R⁴ is hydrogen, C₁-C₄-alkyl, C₁-C₄-haloalkyl, OR¹¹, SR¹² or NR¹³R¹⁴;
R⁵ is hydrogen;
R⁶ is hydrogen, halogen, cyano or C₁-C₄-alkyl, particularly preferably hydrogen, fluorine or CH₃;
R⁷ is hydrogen, halogen or cyano, particularly preferably hydrogen, fluorine or chlorine;
R⁸, R⁹ and R¹⁰ independently of one another are hydrogen, fluorine or chlorine, particularly preferably hydrogen;
R¹¹ and R¹³ independently of one another are hydrogen, C₁-C₄-alkylcarbonyl, C₁-C₄-alkylaminocarbonyl, di(C₁-C₄-alkyl)aminocarbonyl, phenylaminocarbonyl, N—(C₁-C₄-alkyl)-N-(phenyl)aminocarbonyl, SO₂CH₃, SO₂CF₃ or SO₂(C₆H₅);
R¹² is hydrogen, C₁-C₄-alkylcarbonyl, C₁-C₄-alkoxycarbonyl, C₁-C₄-alkylaminocarbonyl, di(C₁-C₄-alkyl)aminocarbonyl, N—(C₁-C₄-alkoxy)-N—(C₁-C₄-alkyl)aminocarbonyl; and
R¹⁴ is hydrogen or C₁-C₄-alkyl.

Extraordinary preference is given to the compounds of the formula I.a (corresponds to formula I where A=A1a, where R¹⁶ is CH₃, R¹⁷ is H and R¹⁸ is CF₃; R¹, R², R⁹, R¹⁰=H, R³=CH₃), in particular to the compounds of the formulae I.a.1 to I.a.630 of table 1, where the definitions of the variables A and R¹ to R¹⁹ are of particular importance for the compounds according to the invention not only in combination with one another but in each case also on their own.

TABLE 1

| | | | | I.a |
|---|---|---|---|---|
| 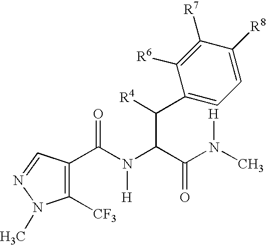 | | | | |
| No. | R⁴ | R⁶ | R⁷ | R⁸ |
| I.a.1 | H | H | H | H |
| I.a.2 | H | H | H | F |
| I.a.3 | H | H | F | H |
| I.a.4 | H | H | F | F |
| I.a.5 | H | H | Cl | H |
| I.a.6 | H | H | Cl | F |
| I.a.7 | H | F | H | H |
| I.a.8 | H | F | H | F |
| I.a.9 | H | F | F | H |
| I.a.10 | H | F | F | F |
| I.a.11 | H | F | Cl | H |
| I.a.12 | H | F | Cl | F |
| I.a.13 | H | CH₃ | H | H |
| I.a.14 | H | CH₃ | H | F |
| I.a.15 | H | CH₃ | F | H |
| I.a.16 | H | CH₃ | F | F |
| I.a.17 | H | CH₃ | Cl | H |
| I.a.18 | H | CH₃ | Cl | F |
| I.a.19 | CH₃ | H | H | H |
| I.a.20 | CH₃ | H | H | F |
| I.a.21 | CH₃ | H | F | H |
| I.a.22 | CH₃ | H | F | F |
| I.a.23 | CH₃ | H | Cl | H |
| I.a.24 | CH₃ | H | Cl | F |
| I.a.25 | CH₃ | F | H | H |
| I.a.26 | CH₃ | F | H | F |
| I.a.27 | CH₃ | F | F | H |
| I.a.28 | CH₃ | F | F | F |
| I.a.29 | CH₃ | F | Cl | H |
| I.a.30 | CH₃ | F | Cl | F |
| I.a.31 | CH₃ | CH₃ | H | H |
| I.a.32 | CH₃ | CH₃ | H | F |
| I.a.33 | CH₃ | CH₃ | F | H |
| I.a.34 | CH₃ | CH₃ | F | F |
| I.a.35 | CH₃ | CH₃ | Cl | H |
| I.a.36 | CH₃ | CH₃ | Cl | F |
| I.a.37 | C₂H₅ | H | H | H |
| I.a.38 | C₂H₅ | H | H | F |
| I.a.39 | C₂H₅ | H | F | H |
| I.a.40 | C₂H₅ | H | F | F |
| I.a.41 | C₂H₅ | H | Cl | H |
| I.a.42 | C₂H₅ | H | Cl | F |
| I.a.43 | C₂H₅ | F | H | H |
| I.a.44 | C₂H₅ | F | H | F |
| I.a.45 | C₂H₅ | F | F | H |
| I.a.46 | C₂H₅ | F | F | F |
| I.a.47 | C₂H₅ | F | Cl | H |
| I.a.48 | C₂H₅ | F | Cl | F |
| I.a.49 | C₂H₅ | CH₃ | H | H |
| I.a.50 | C₂H₅ | CH₃ | H | F |
| I.a.51 | C₂H₅ | CH₃ | F | H |
| I.a.52 | C₂H₅ | CH₃ | F | F |
| I.a.53 | C₂H₅ | CH₃ | Cl | H |
| I.a.54 | C₂H₅ | CH₃ | Cl | F |
| I.a.55 | CF₃ | H | H | H |
| I.a.56 | CF₃ | H | H | F |
| I.a.57 | CF₃ | H | F | H |
| I.a.58 | CF₃ | H | F | F |
| I.a.59 | CF₃ | H | Cl | H |
| I.a.60 | CF₃ | H | Cl | F |
| I.a.61 | CF₃ | F | H | H |
| I.a.62 | CF₃ | F | H | F |
| I.a.63 | CF₃ | F | F | H |
| I.a.64 | CF₃ | F | F | F |
| I.a.65 | CF₃ | F | Cl | H |
| I.a.66 | CF₃ | F | Cl | F |
| I.a.67 | CF₃ | CH₃ | H | H |
| I.a.68 | CF₃ | CH₃ | H | F |
| I.a.69 | CF₃ | CH₃ | F | H |
| I.a.70 | CF₃ | CH₃ | F | F |
| I.a.71 | CF₃ | CH₃ | Cl | H |
| I.a.72 | CF₃ | CH₃ | Cl | F |
| I.a.73 | OH | H | H | H |
| I.a.74 | OH | H | H | F |
| I.a.75 | OH | H | F | H |
| I.a.76 | OH | H | F | F |
| I.a.77 | OH | H | Cl | H |
| I.a.78 | OH | H | Cl | F |
| I.a.79 | OH | F | H | H |
| I.a.80 | OH | F | H | F |
| I.a.81 | OH | F | F | H |
| I.a.82 | OH | F | F | F |
| I.a.83 | OH | F | Cl | H |
| I.a.84 | OH | F | Cl | F |
| I.a.85 | OH | CH₃ | H | H |
| I.a.86 | OH | CH₃ | H | F |
| I.a.87 | OH | CH₃ | F | H |
| I.a.88 | OH | CH₃ | F | F |
| I.a.89 | OH | CH₃ | Cl | H |
| I.a.90 | OH | CH₃ | Cl | F |
| I.a.91 | OC(O)CH₃ | H | H | H |
| I.a.92 | OC(O)CH₃ | H | H | F |
| I.a.93 | OC(O)CH₃ | H | F | H |
| I.a.94 | OC(O)CH₃ | H | F | F |
| I.a.95 | OC(O)CH₃ | H | Cl | H |
| I.a.96 | OC(O)CH₃ | H | Cl | F |
| I.a.97 | OC(O)CH₃ | F | H | H |
| I.a.98 | OC(O)CH₃ | F | H | F |
| I.a.99 | OC(O)CH₃ | F | F | H |
| I.a.100 | OC(O)CH₃ | F | F | F |
| I.a.101 | OC(O)CH₃ | F | Cl | H |
| I.a.102 | OC(O)CH₃ | F | Cl | F |
| I.a.103 | OC(O)CH₃ | CH₃ | H | H |
| I.a.104 | OC(O)CH₃ | CH₃ | H | F |
| I.a.105 | OC(O)CH₃ | CH₃ | F | H |
| I.a.106 | OC(O)CH₃ | CH₃ | F | F |
| I.a.107 | OC(O)CH₃ | CH₃ | Cl | H |
| I.a.108 | OC(O)CH₃ | CH₃ | Cl | F |
| I.a.109 | OC(O)tertC₄H₉ | H | H | H |
| I.a.110 | OC(O)tertC₄H₉ | H | H | F |
| I.a.111 | OC(O)tertC₄H₉ | H | F | H |
| I.a.112 | OC(O)tertC₄H₉ | H | F | F |
| I.a.113 | OC(O)tertC₄H₉ | H | Cl | H |
| I.a.114 | OC(O)tertC₄H₉ | H | Cl | F |
| I.a.115 | OC(O)tertC₄H₉ | F | H | H |
| I.a.116 | OC(O)tertC₄H₉ | F | H | F |
| I.a.117 | OC(O)tertC₄H₉ | F | F | H |
| I.a.118 | OC(O)tertC₄H₉ | F | F | F |
| I.a.119 | OC(O)tertC₄H₉ | F | Cl | H |
| I.a.120 | OC(O)tertC₄H₉ | F | Cl | F |
| I.a.121 | OC(O)tertC₄H₉ | CH₃ | H | H |
| I.a.122 | OC(O)tertC₄H₉ | CH₃ | H | F |
| I.a.123 | OC(O)tertC₄H₉ | CH₃ | F | H |
| I.a.124 | OC(O)tertC₄H₉ | CH₃ | F | F |
| I.a.125 | OC(O)tertC₄H₉ | CH₃ | Cl | H |
| I.a.126 | OC(O)tertC₄H₉ | CH₃ | Cl | F |
| I.a.127 | OC(O)NH(CH₃) | H | H | H |
| I.a.128 | OC(O)NH(CH₃) | H | H | F |
| I.a.129 | OC(O)NH(CH₃) | H | F | H |
| I.a.130 | OC(O)NH(CH₃) | H | F | F |
| I.a.131 | OC(O)NH(CH₃) | H | Cl | H |
| I.a.132 | OC(O)NH(CH₃) | H | Cl | F |
| I.a.133 | OC(O)NH(CH₃) | F | H | H |
| I.a.134 | OC(O)NH(CH₃) | F | H | F |
| I.a.135 | OO(O)NH(CH₃) | F | F | H |
| I.a.136 | OC(O)NH(CH₃) | F | F | F |
| I.a.137 | OC(O)NH(CH₃) | F | Cl | H |
| I.a.138 | OC(O)NH(CH₃) | F | Cl | F |
| I.a.139 | OC(O)NH(CH₃) | CH₃ | H | H |
| I.a.140 | OC(O)NH(CH₃) | CH₃ | H | F |
| I.a.141 | OC(O)NH(CH₃) | CH₃ | F | H |
| I.a.142 | OC(O)NH(CH₃) | CH₃ | F | F |
| I.a.143 | OC(O)NH(CH₃) | CH₃ | Cl | H |
| I.a.144 | OC(O)NH(CH₃) | CH₃ | Cl | F |
| I.a.145 | OC(O)NH(C₆H₅) | H | H | H |
| I.a.146 | OC(O)NH(C₆H₅) | H | H | F |
| I.a.147 | OC(O)NH(C₆H₅) | H | F | H |
| I.a.148 | OC(O)NH(C₆H₅) | H | F | F |
| I.a.149 | OC(O)NH(C₆H₅) | H | Cl | H |
| I.a.150 | OC(O)NH(C₆H₅) | H | Cl | F |
| I.a.151 | OC(O)NH(C₆H₅) | F | H | H |
| I.a.152 | OC(O)NH(C₆H₅) | F | H | F |
| I.a.153 | OC(O)NH(C₆H₅) | F | F | H |
| I.a.154 | OC(O)NH(C₆H₅) | F | F | F |
| I.a.155 | OC(O)NH(C₆H₅) | F | Cl | H |
| I.a.156 | OC(O)NH(C₆H₅) | F | Cl | F |
| I.a.157 | OC(O)NH(C₆H₅) | CH₃ | H | H |
| I.a.158 | OC(O)NH(C₆H₅) | CH₃ | H | F |
| I.a.159 | OC(O)NH(C₆H₅) | CH₃ | F | H |
| I.a.160 | OC(O)NH(C₆H₅) | CH₃ | F | F |
| I.a.161 | OC(O)NH(C₆H₅) | CH₃ | Cl | H |
| I.a.162 | OC(O)NH(C₆H₅) | CH₃ | Cl | F |
| I.a.163 | OC(O)N(CH₃)₂ | H | H | H |
| I.a.164 | OC(O)N(CH₃)₂ | H | H | F |
| I.a.165 | OC(O)N(CH₃)₂ | H | F | H |
| I.a.166 | OC(O)N(CH₃)₂ | H | F | F |
| I.a.167 | OC(O)N(CH₃)₂ | H | Cl | H |
| I.a.168 | OC(O)N(CH₃)₂ | H | Cl | F |
| I.a.169 | OC(O)N(CH₃)₂ | F | H | H |
| I.a.170 | OC(O)N(CH₃)₂ | F | H | F |
| I.a.171 | OC(O)N(CH₃)₂ | F | F | H |
| I.a.172 | OC(O)N(CH₃)₂ | F | F | F |
| I.a.173 | OC(O)N(CH₃)₂ | F | Cl | H |
| I.a.174 | OC(O)N(CH₃)₂ | F | Cl | F |
| I.a.175 | OC(O)N(CH₃)₂ | CH₃ | H | H |
| I.a.176 | OC(O)N(CH₃)₂ | CH₃ | H | F |
| I.a.177 | OC(O)N(CH₃)₂ | CH₃ | F | H |
| I.a.178 | OC(O)N(CH₃)₂ | CH₃ | F | F |
| I.a.179 | OC(O)N(CH₃)₂ | CH₃ | Cl | H |
| I.a.180 | OC(O)N(CH₃)₂ | CH₃ | Cl | F |
| I.a.181 | OC(O)N(CH₃)(C₆H₅) | H | H | H |
| I.a.182 | OC(O)N(CH₃)(C₆H₅) | H | H | F |
| I.a.183 | OC(O)N(CH₃)(C₆H₅) | H | F | H |
| I.a.184 | OC(O)N(CH₃)(C₆H₅) | H | F | F |
| I.a.185 | OC(O)N(CH₃)(C₆H₅) | H | Cl | H |
| I.a.186 | OC(O)N(CH₃)(C₆H₅) | H | Cl | F |
| I.a.187 | OC(O)N(CH₃)(C₆H₅) | F | H | H |
| I.a.188 | OC(O)N(CH₃)(C₆H₅) | F | H | F |
| I.a.189 | OC(O)N(CH₃)(C₆H₅) | F | F | H |
| I.a.190 | QC(O)N(CH₃)(C₆H₅) | F | F | F |
| I.a.191 | OC(O)N(CH₃)(C₆H₅) | F | Cl | H |
| I.a.192 | OC(O)N(CH₃)(C₆H₅) | F | Cl | F |
| I.a.193 | OC(O)N(CH₃)(C₆H₅) | CH₃ | H | H |
| I.a.194 | OC(O)N(CH₃)(C₆H₅) | CH₃ | H | F |
| I.a.195 | OC(O)N(CH₃)(C₆H₅) | CH₃ | F | H |
| I.a.196 | OC(O)N(CH₃)(C₆H₅) | CH₃ | F | F |
| I.a.197 | OC(O)N(CH₃)(C₆H₅) | CH₃ | Cl | H |
| I.a.198 | OC(O)N(CH₃)(C₆H₅) | CH₃ | Cl | F |
| I.a.199 | OSO₂CH₃ | H | H | H |
| I.a.200 | OSO₂CH₃ | H | H | F |
| I.a.201 | OSO₂CH₃ | H | F | H |
| I.a.202 | OSO₂CH₃ | H | F | F |
| I.a.203 | OSO₂CH₃ | H | Cl | H |
| I.a.204 | OSO₂CH₃ | H | Cl | F |
| I.a.205 | OSO₂CH₃ | F | H | H |
| I.a.206 | OSO₂CH₃ | F | H | F |
| I.a.207 | OSO₂CH₃ | F | F | H |
| I.a.208 | OSO₂CH₃ | F | F | F |
| I.a.209 | OSO₂CH₃ | F | Cl | H |
| I.a.210 | OSO₂CH₃ | F | Cl | F |
| I.a.211 | OSO₂CH₃ | CH₃ | H | H |
| I.a.212 | OSO₂CH₃ | CH₃ | H | F |
| I.a.213 | OSO₂CH₃ | CH₃ | F | H |
| I.a.214 | OSO₂CH₃ | CH₃ | F | F |
| I.a.215 | OSO₂CH₃ | CH₃ | Cl | H |
| I.a.216 | OSO₂CH₃ | CH₃ | Cl | F |
| I.a.217 | SH | H | H | H |
| I.a.218 | SH | H | H | F |
| I.a.219 | SH | H | F | H |
| I.a.220 | SH | H | F | F |
| I.a.221 | SH | H | Cl | H |
| I.a.222 | SH | H | Cl | F |
| I.a.223 | SH | F | H | H |
| I.a.224 | SH | F | H | F |
| I.a.225 | SH | F | F | H |
| I.a.226 | SH | F | F | F |
| I.a.227 | SH | F | Cl | H |
| I.a.228 | SH | F | Cl | F |
| I.a.229 | SH | CH₃ | H | H |
| I.a.230 | SH | CH₃ | H | F |
| I.a.231 | SH | CH₃ | F | H |
| I.a.232 | SH | CH₃ | F | F |
| I.a.233 | SH | CH₃ | Cl | H |
| I.a.234 | SH | CH₃ | Cl | F |
| I.a.235 | SC(O)CH₃ | H | H | H |
| I.a.236 | SC(O)CH₃ | H | H | F |
| I.a.237 | SC(O)CH₃ | H | F | H |
| I.a.238 | SC(O)CH₃ | H | F | F |
| I.a.239 | SC(O)CH₃ | H | Cl | H |
| I.a.240 | SC(O)CH₃ | H | Cl | F |
| I.a.241 | SC(O)CH₃ | F | H | H |
| I.a.242 | SC(O)CH₃ | F | H | F |
| I.a.243 | SC(O)CH₃ | F | F | H |
| I.a.244 | SC(O)CH₃ | F | F | F |
| I.a.245 | SC(O)CH₃ | F | Cl | H |
| I.a.246 | SC(O)CH₃ | F | Cl | F |
| I.a.247 | SC(O)CH₃ | CH₃ | H | H |
| I.a.248 | SC(O)CH₃ | CH₃ | H | F |
| I.a.249 | SC(O)CH₃ | CH₃ | F | H |
| I.a.250 | SC(O)CH₃ | CH₃ | F | F |
| I.a.251 | SC(O)CH₃ | CH₃ | Cl | H |
| I.a.252 | SC(O)CH₃ | CH₃ | Cl | F |
| I.a.253 | SC(O)tertC₄H₉ | H | H | H |
| I.a.254 | SC(O)tertC₄H₉ | H | H | F |
| I.a.255 | SC(O)tertC₄H₉ | H | F | H |
| I.a.256 | SC(O)tertC₄H₉ | H | F | F |
| I.a.257 | SC(O)tertC₄H₉ | H | Cl | H |
| I.a.258 | SC(O)tertC₄H₉ | H | Cl | F |
| I.a.259 | SC(O)tertC₄H₉ | F | H | H |
| I.a.260 | SC(O)tertC₄H₉ | F | H | F |
| I.a.261 | SC(O)tertC₄H₉ | F | F | H |
| I.a.262 | SC(O)tertC₄H₉ | F | F | F |
| I.a.263 | SC(O)tertC₄H₉ | F | Cl | H |
| I.a.264 | SC(O)tertC₄H₉ | F | Cl | F |
| I.a.265 | SC(O)tertC₄H₉ | CH₃ | H | H |
| I.a.266 | SC(O)tertC₄H₉ | CH₃ | H | F |
| I.a.267 | SC(O)tertC₄H₉ | CH₃ | F | H |
| I.a.268 | SC(O)tertC₄H₉ | CH₃ | F | F |
| I.a.269 | SC(O)tertC₄H₉ | CH₃ | Cl | H |
| I.a.270 | SC(O)tertC₄H₉ | CH₃ | Cl | F |
| I.a.271 | SC(O)NH(CH₃) | H | H | H |
| I.a.272 | SC(O)NH(CH₃) | H | H | F |
| I.a.273 | SC(O)NH(CH₃) | H | F | H |
| I.a.274 | SC(O)NH(CH₃) | H | F | F |
| I.a.275 | SC(O)NH(CH₃) | H | Cl | H |
| I.a.276 | SC(O)NH(CH₃) | H | Cl | F |
| I.a.277 | SC(O)NH(CH₃) | F | H | H |
| I.a.278 | SC(O)NH(CH₃) | F | H | F |
| I.a.279 | SC(O)NH(CH₃) | F | F | H |
| I.a.280 | SC(O)NH(CH₃) | F | F | F |
| I.a.281 | SC(O)NH(CH₃) | F | Cl | H |
| I.a.282 | SC(O)NH(CH₃) | F | Cl | F |
| I.a.283 | SC(O)NH(CH₃) | CH₃ | H | H |
| I.a.284 | SC(O)NH(CH₃) | CH₃ | H | F |
| I.a.285 | SC(O)NH(CH₃) | CH₃ | F | H |
| I.a.286 | SC(O)NH(CH₃) | CH₃ | F | F |
| I.a.287 | SC(O)NH(CH₃) | CH₃ | Cl | H |
| I.a.288 | SC(O)NH(CH₃) | CH₃ | Cl | F |
| I.a.289 | SC(O)NH(C₆H₅) | H | H | H |
| I.a.290 | SC(O)NH(C₆H₅) | H | H | F |
| I.a.291 | SC(O)NH(C₆H₅) | H | F | H |
| I.a.292 | SC(O)NH(C₆H₅) | H | F | F |
| I.a.293 | SC(O)NH(C₆H₅) | H | Cl | H |
| I.a.294 | SC(O)NH(C₆H₅) | H | Cl | F |
| I.a.295 | SC(O)NH(C₆H₅) | F | H | H |
| I.a.296 | SC(O)NH(C₆H₅) | F | H | F |
| I.a.297 | SC(O)NH(C₆H₅) | F | F | H |
| I.a.298 | SC(O)NH(C₆H₅) | F | F | F |
| I.a.299 | SC(O)NH(C₆H₅) | F | Cl | H |
| I.a.300 | SC(O)NH(C₆H₅) | F | Cl | F |
| I.a.301 | SC(O)NH(C₆H₅) | CH₃ | H | H |
| I.a.302 | SC(O)NH(C₆H₅) | CH₃ | H | F |
| I.a.303 | SC(O)NH(C₆H₅) | CH₃ | F | H |
| I.a.304 | SC(O)NH(C₆H₅) | CH₃ | F | F |
| I.a.305 | SC(O)NH(C₆H₅) | CH₃ | Cl | H |
| I.a.306 | SC(O)NH(C₆H₅) | CH₃ | Cl | F |
| I.a.307 | SC(O)N(CH₃)₂ | H | H | H |
| I.a.308 | SC(O)N(CH₃)₂ | H | H | F |
| I.a.309 | SC(O)N(CH₃)₂ | H | F | H |
| I.a.310 | SC(O)N(CH₃)₂ | H | F | F |
| I.a.311 | SC(O)N(CH₃)₂ | H | Cl | H |
| I.a.312 | SC(O)N(CH₃)₂ | H | Cl | F |
| I.a.313 | SC(O)N(CH₃)₂ | F | H | H |
| I.a.314 | SC(O)N(CH₃)₂ | F | H | F |
| I.a.315 | SC(O)N(CH₃)₂ | F | F | H |
| I.a.316 | SC(O)N(CH₃)₂ | F | F | F |
| I.a.317 | SC(O)N(CH₃)₂ | F | Cl | H |
| I.a.318 | SC(O)N(CH₃)₂ | F | Cl | F |
| I.a.319 | SC(O)N(CH₃)₂ | CH₃ | H | H |
| I.a.320 | SC(O)N(CH₃)₂ | CH₃ | H | F |
| I.a.321 | SC(O)N(CH₃)₂ | CH₃ | F | H |
| I.a.322 | SC(O)N(CH₃)₂ | CH₃ | F | F |
| I.a.323 | SC(O)N(CH₃)₂ | CH₃ | Cl | H |
| I.a.324 | SC(O)N(CH₃)₂ | CH₃ | Cl | F |
| I.a.325 | SC(O)N(CH₃)(C₆H₅) | H | H | H |
| I.a.326 | SC(O)N(CH₃)(C₆H₅) | H | H | F |
| I.a.327 | SC(O)N(CH₃)(C₆H₅) | H | F | H |
| I.a.328 | SC(O)N(CH₃)(C₆H₅) | H | F | F |
| I.a.329 | SC(O)N(CH₃)(C₆H₅) | H | Cl | H |
| I.a.330 | SC(O)N(CH₃)(C₆H₅) | H | Cl | F |
| I.a.331 | SC(O)N(CH₃)(C₆H₅) | F | H | H |
| I.a.332 | SC(O)N(CH₃)(C₆H₅) | F | H | F |
| I.a.333 | SC(O)N(CH₃)(C₆H₅) | F | F | H |
| I.a.334 | SC(O)N(CH₃)(C₆H₅) | F | F | F |
| I.a.335 | SC(O)N(CH₃)(C₆H₅) | F | Cl | H |
| I.a.336 | SC(O)N(CH₃)(C₆H₅) | F | Cl | F |
| I.a.337 | SC(O)N(CH₃)(C₆H₅) | CH₃ | H | H |
| I.a.338 | SC(O)N(CH₃)(C₆H₅) | CH₃ | H | F |
| I.a.339 | SC(O)N(CH₃)(C₆H₅) | CH₃ | F | H |
| I.a.340 | SC(O)N(CH₃)(C₆H₅) | CH₃ | F | F |
| I.a.341 | SC(O)N(CH₃)(C₆H₅) | CH₃ | Cl | H |
| I.a.342 | SC(O)N(CH₃)(C₆H₅) | CH₃ | Cl | F |
| I.a.343 | NH₂ | H | H | H |
| I.a.344 | NH₂ | H | H | F |
| I.a.345 | NH₂ | H | F | H |
| I.a.346 | NH₂ | H | F | F |
| I.a.347 | NH₂ | H | Cl | H |
| I.a.348 | NH₂ | H | Cl | F |
| I.a.349 | NH₂ | F | H | H |
| I.a.350 | NH₂ | F | H | F |
| I.a.351 | NH₂ | F | F | H |
| I.a.352 | NH₂ | F | F | F |
| I.a.353 | NH₂ | F | Cl | H |
| I.a.354 | NH₂ | F | Cl | F |
| I.a.355 | NH₂ | CH₃ | H | H |
| I.a.356 | NH₂ | CH₃ | H | F |
| I.a.357 | NH₂ | CH₃ | F | H |
| I.a.358 | NH₂ | CH₃ | F | F |
| I.a.359 | NH₂ | CH₃ | Cl | H |
| I.a.360 | NH₂ | CH₃ | Cl | F |
| I.a.361 | NHC(O)CH₃ | H | H | H |
| I.a.362 | NHC(O)CH₃ | H | H | F |
| I.a.363 | NHC(O)CH₃ | H | F | H |
| I.a.364 | NHC(O)CH₃ | H | F | F |
| I.a.365 | NHC(O)CH₃ | H | Cl | H |
| I.a.366 | NHC(O)CH₃ | H | Cl | F |
| I.a.367 | NHC(O)CH₃ | F | H | H |
| I.a.368 | NHC(O)CH₃ | F | H | F |
| I.a.369 | NHC(O)CH₃ | F | F | H |
| I.a.370 | NHC(O)CH₃ | F | F | F |
| I.a.371 | NHC(O)CH₃ | F | Cl | H |
| I.a.372 | NHC(O)CH₃ | F | Cl | F |
| I.a.373 | NHC(O)CH₃ | CH₃ | H | H |
| I.a.374 | NHC(O)CH₃ | CH₃ | H | F |
| I.a.375 | NHC(O)CH₃ | CH₃ | F | H |
| I.a.376 | NHC(O)CH₃ | CH₃ | F | F |
| I.a.377 | NHC(O)CH₃ | CH₃ | Cl | H |
| I.a.378 | NHC(O)CH₃ | CH₃ | Cl | F |
| I.a.379 | NHC(O)tertC₄H₉ | H | H | H |
| I.a.380 | NHC(O)tertC₄H₉ | H | H | F |
| I.a.381 | NHC(O)tertC₄H₉ | H | F | H |
| I.a.382 | NHC(O)tertC₄H₉ | H | F | F |
| I.a.383 | NHC(O)tertC₄H₉ | H | Cl | H |
| I.a.384 | NHC(O)tertC₄H₉ | H | Cl | F |
| I.a.385 | NHC(O)tertC₄H₉ | F | H | H |
| I.a.386 | NHC(O)tertC₄H₉ | F | H | F |
| I.a.387 | NHC(O)tertC₄H₉ | F | F | H |
| I.a.388 | NHC(O)tertC₄H₉ | F | F | F |
| I.a.389 | NHC(O)tertC₄H₉ | F | Cl | H |
| I.a.390 | NHC(O)tertC₄H₉ | F | Cl | F |
| I.a.391 | NHC(O)tertC₄H₉ | CH₃ | H | H |
| I.a.392 | NHC(O)tertC₄H₉ | CH₃ | H | F |
| I.a.393 | NHC(O)tertC₄H₉ | CH₃ | F | H |
| I.a.394 | NHC(O)tertC₄H₉ | CH₃ | F | F |
| I.a.395 | NHC(O)tertC₄H₉ | CH₃ | Cl | H |
| I.a.396 | NHC(O)tertC₄H₉ | CH₃ | Cl | F |
| I.a.397 | NHC(O)NH(CH₃) | H | H | H |
| I.a.398 | NHC(O)NH(CH₃) | H | H | F |
| I.a.399 | NHC(O)NH(CH₃) | H | F | H |
| I.a.400 | NHC(O)NH(CH₃) | H | F | F |
| I.a.401 | NHC(O)NH(CH₃) | H | Cl | H |
| I.a.402 | NHC(O)NH(CH₃) | H | Cl | F |
| I.a.403 | NHC(O)NH(CH₃) | F | H | H |
| I.a.404 | NHC(O)NH(CH₃) | F | H | F |
| I.a.405 | NHC(O)NH(CH₃) | F | F | H |
| I.a.406 | NHC(O)NH(CH₃) | F | F | F |
| I.a.407 | NHC(O)NH(CH₃) | F | Cl | H |
| I.a.408 | NHC(O)NH(CH₃) | F | Cl | F |
| I.a.409 | NHC(O)NH(CH₃) | CH₃ | H | H |
| I.a.410 | NHC(O)NH(CH₃) | CH₃ | H | F |
| I.a.411 | NHC(O)NH(CH₃) | CH₃ | F | H |
| I.a.412 | NHC(O)NH(CH₃) | CH₃ | F | F |
| I.a.413 | NHC(O)NH(CH₃) | CH₃ | Cl | H |
| I.a.414 | NHC(O)NH(CH₃) | CH₃ | Cl | F |
| I.a.415 | NHC(O)NH(C₆H₅) | H | H | H |
| I.a.416 | NHC(O)NH(C₆H₅) | H | H | F |
| I.a.417 | NHC(O)NH(C₆H₅) | H | F | H |
| I.a.418 | NHC(O)NH(C₆H₅) | H | F | F |
| I.a.419 | NHC(O)NH(C₆H₅) | H | Cl | H |
| I.a.420 | NHC(O)NH(C₆H₅) | H | Cl | F |
| I.a.421 | NHC(O)NH(C₆H₅) | F | H | H |
| I.a.422 | NHC(O)NH(C₆H₅) | F | H | F |
| I.a.423 | NHC(O)NH(C₆H₅) | F | F | H |
| I.a.424 | NHC(O)NH(C₆H₅) | F | F | F |
| I.a.425 | NHC(O)NH(C₆H₅) | F | Cl | H |
| I.a.426 | NHC(O)NH(C₆H₅) | F | Cl | F |
| I.a.427 | NHC(O)NH(C₆H₅) | CH₃ | H | H |
| I.a.428 | NHC(O)NH(C₆H₅) | CH₃ | H | F |
| I.a.429 | NHC(O)NH(C₆H₅) | CH₃ | F | H |
| I.a.430 | NHC(O)NH(C₆H₅) | CH₃ | F | F |
| I.a.431 | NHC(O)NH(C₆H₅) | CH₃ | Cl | H |
| I.a.432 | NHC(O)NH(C₆H₅) | CH₃ | Cl | F |
| I.a.433 | NHC(O)N(CH₃)₂ | H | H | H |
| I.a.434 | NHC(O)N(CH₃)₂ | H | H | F |
| I.a.435 | NHC(O)N(CH₃)₂ | H | F | H |
| I.a.436 | NHC(O)N(CH₃)₂ | H | F | F |
| I.a.437 | NHC(O)N(CH₃)₂ | H | Cl | H |
| I.a.438 | NHC(O)N(CH₃)₂ | H | Cl | F |
| I.a.439 | NHC(O)N(CH₃)₂ | F | H | H |
| I.a.440 | NHC(O)N(CH₃)₂ | F | H | F |
| I.a.441 | NHC(O)N(CH₃)₂ | F | F | H |
| I.a.442 | NHC(O)N(CH₃)₂ | F | F | F |
| I.a.443 | NHC(O)N(CH₃)₂ | F | Cl | H |
| I.a.444 | NHC(O)N(CH₃)₂ | F | Cl | F |
| I.a.445 | NHC(O)N(CH₃)₂ | CH₃ | H | H |
| I.a.446 | NHC(O)N(CH₃)₂ | CH₃ | H | F |
| I.a.447 | NHC(O)N(CH₃)₂ | CH₃ | F | H |
| I.a.448 | NHC(O)N(CH₃)₂ | CH₃ | F | F |
| I.a.449 | NHC(O)N(CH₃)₂ | CH₃ | Cl | H |
| I.a.450 | NHC(O)N(CH₃)₂ | CH₃ | Cl | F |
| I.a.451 | NHC(O)N(CH₃)(C₆H₅) | H | H | H |
| I.a.452 | NHC(O)N(CH₃)(C₆H₅) | H | H | F |
| I.a.453 | NHC(O)N(CH₃)(C₆H₅) | H | F | H |
| I.a.454 | NHC(O)N(CH₃)(C₆H₅) | H | F | F |
| I.a.455 | NHC(O)N(CH₃)(C₆H₅) | H | Cl | H |
| I.a.456 | NHC(O)N(CH₃)(C₆H₅) | H | Cl | F |
| I.a.457 | NHC(O)N(CH₃)(C₆H₅) | F | H | H |
| I.a.458 | NHC(O)N(CH₃)(C₆H₅) | F | H | F |
| I.a.459 | NHC(O)N(CH₃)(C₆H₅) | F | F | H |
| I.a.460 | NHC(O)N(CH₃)(C₆H₅) | F | F | F |
| I.a.461 | NHC(O)N(CH₃)(C₆H₅) | F | Cl | H |
| I.a.462 | NHC(O)N(CH₃)(C₆H₅) | F | Cl | F |
| I.a.463 | NHC(O)N(CH₃)(C₆H₅) | CH₃ | H | H |
| I.a.464 | NHC(O)N(CH₃)(C₆H₅) | CH₃ | H | F |
| I.a.465 | NHC(O)N(CH₃)(C₆H₅) | CH₃ | F | H |
| I.a.466 | NHC(O)N(CH₃)(C₆H₅) | CH₃ | F | F |
| I.a.467 | NHC(O)N(CH₃)(C₆H₅) | CH₃ | Cl | H |
| I.a.468 | NHC(O)N(CH₃)(C₆H₅) | CH₃ | Cl | F |
| I.a.469 | NHSO₂CH₃ | H | H | H |
| I.a.470 | NHSO₂CH₃ | H | H | F |
| I.a.471 | NHSO₂CH₃ | H | F | H |
| I.a.472 | NHSO₂CH₃ | H | F | F |
| I.a.473 | NHSO₂CH₃ | H | Cl | H |
| I.a.474 | NHSO₂CH₃ | H | Cl | F |
| I.a.475 | NHSO₂CH₃ | F | H | H |
| I.a.476 | NHSO₂CH₃ | F | H | F |
| I.a.477 | NHSO₂CH₃ | F | F | H |
| I.a.478 | NHSO₂CH₃ | F | F | F |
| I.a.479 | NHSO₂CH₃ | F | Cl | H |
| I.a.480 | NHSO₂CH₃ | F | Cl | F |
| I.a.481 | NHSO₂CH₃ | CH₃ | H | H |
| I.a.482 | NHSO₂CH₃ | CH₃ | H | F |
| I.a.483 | NHSO₂CH₃ | CH₃ | F | H |
| I.a.484 | NHSO₂CH₃ | CH₃ | F | F |
| I.a.485 | NHSO₂CH₃ | CH₃ | Cl | H |
| I.a.486 | NHSO₂CH₃ | CH₃ | Cl | F |
| I.a.487 | NH(CH₃) | H | H | H |
| I.a.488 | NH(CH₃) | H | H | F |
| I.a.489 | NH(CH₃) | H | F | H |
| I.a.490 | NH(CH₃) | H | F | F |
| I.a.491 | NH(CH₃) | H | Cl | H |
| I.a.492 | NH(CH₃) | H | Cl | F |
| I.a.493 | NH(CH₃) | F | H | H |
| I.a.494 | NH(CH₃) | F | H | F |
| I.a.495 | NH(CH₃) | F | F | H |
| I.a.496 | NH(CH₃) | F | F | F |
| I.a.497 | NH(CH₃) | F | Cl | H |
| I.a.498 | NH(CH₃) | F | Cl | F |
| I.a.499 | NH(CH₃) | CH₃ | H | H |
| I.a.500 | NH(CH₃) | CH₃ | H | F |
| I.a.501 | NH(CH₃) | CH₃ | F | H |
| I.a.502 | NH(CH₃) | CH₃ | F | F |
| I.a.503 | NH(CH₃) | CH₃ | Cl | H |
| I.a.504 | NH(CH₃) | CH₃ | Cl | F |
| I.a.505 | N(CH₃)C(O)CH₃ | H | H | H |
| I.a.506 | N(CH₃)C(O)CH₃ | H | H | F |
| I.a.507 | N(CH₃)C(O)CH₃ | H | F | H |
| I.a.508 | N(CH₃)C(O)CH₃ | H | F | F |
| I.a.509 | N(CH₃)C(O)CH₃ | H | Cl | H |
| I.a.510 | N(CH₃)C(O)CH₃ | H | Cl | F |
| I.a.511 | N(CH₃)C(O)CH₃ | F | H | H |
| I.a.512 | N(CH₃)C(O)CH₃ | F | H | F |
| I.a.513 | N(CH₃)C(O)CH₃ | F | F | H |
| I.a.514 | N(CH₃)C(O)CH₃ | F | F | F |
| I.a.515 | N(CH₃)C(O)CH₃ | F | Cl | H |
| I.a.516 | N(CH₃)C(O)CH₃ | F | Cl | F |
| I.a.517 | N(CH₃)C(O)CH₃ | CH₃ | H | H |
| I.a.518 | N(CH₃)C(O)CH₃ | CH₃ | H | F |
| I.a.519 | N(CH₃)C(O)CH₃ | CH₃ | F | H |
| I.a.520 | N(CH₃)C(O)CH₃ | CH₃ | F | F |
| I.a.521 | N(CH₃)C(O)CH₃ | CH₃ | Cl | H |
| I.a.522 | N(CH₃)C(O)CH₃ | CH₃ | Cl | F |
| I.a.523 | N(CH₃)C(O)tertC₄H₉ | H | H | H |
| I.a.524 | N(CH₃)C(O)tertC₄H₉ | H | H | F |
| I.a.525 | N(CH₃)C(O)tertC₄H₉ | H | F | H |
| I.a.526 | N(CH₃)C(O)tertC₄H₉ | H | F | F |
| I.a.527 | N(CH₃)C(O)tertC₄H₉ | H | Cl | H |
| I.a.528 | N(CH₃)C(O)tertC₄H₉ | H | Cl | F |
| I.a.529 | N(CH₃)C(O)tertC₄H₉ | F | H | H |
| I.a.530 | N(CH₃)C(O)tertC₄H₉ | F | H | F |
| I.a.531 | N(CH₃)C(O)tertC₄H₉ | F | F | H |
| I.a.532 | N(CH₃)C(O)tertC₄H₉ | F | F | F |
| I.a.533 | N(CH₃)C(O)tertC₄H₉ | F | Cl | H |
| I.a.534 | N(CH₃)C(O)tertC₄H₉ | F | Cl | F |
| I.a.535 | N(CH₃)C(O)tertC₄H₉ | CH₃ | H | H |
| I.a.536 | N(CH₃)C(O)tertC₄H₉ | CH₃ | H | F |
| I.a.537 | N(CH₃)C(O)tertC₄H₉ | CH₃ | F | H |
| I.a.538 | N(CH₃)C(O)tertC₄H₉ | CH₃ | F | F |
| I.a.539 | N(CH₃)C(O)tertC₄H₉ | CH₃ | Cl | H |
| I.a.540 | N(CH₃)C(O)tertC₄H₉ | CH₃ | Cl | F |
| I.a.541 | N(CH₃)C(O)NH(CH₃) | H | H | H |
| I.a.542 | N(CH₃)C(O)NH(CH₃) | H | H | F |
| I.a.543 | N(CH₃)C(O)NH(CH₃) | H | F | H |
| I.a.544 | N(CH₃)C(O)NH(CH₃) | H | F | F |
| I.a.545 | N(CH₃)C(O)NH(CH₃) | H | Cl | H |
| I.a.546 | N(CH₃)C(O)NH(CH₃) | H | Cl | F |
| I.a.547 | N(CH₃)C(O)NH(CH₃) | F | H | H |
| I.a.548 | N(CH₃)C(O)NH(CH₃) | F | H | F |
| I.a.549 | N(CH₃)C(O)NH(CH₃) | F | F | H |
| I.a.550 | N(CH₃)C(O)NH(CH₃) | F | F | F |
| I.a.551 | N(CH₃)C(O)NH(CH₃) | F | Cl | H |
| I.a.552 | N(CH₃)C(O)NH(CH₃) | F | Cl | F |
| I.a.553 | N(CH₃)C(O)NH(CH₃) | CH₃ | H | H |
| I.a.554 | N(CH₃)C(O)NH(CH₃) | CH₃ | H | F |
| I.a.555 | N(CH₃)C(O)NH(CH₃) | CH₃ | F | H |
| I.a.556 | N(CH₃)C(O)NH(CH₃) | CH₃ | F | F |
| I.a.557 | N(CH₃)C(O)NH(CH₃) | CH₃ | Cl | H |
| I.a.558 | N(CH₃)C(O)NH(CH₃) | CH₃ | Cl | F |
| I.a.559 | N(CH₃)C(O)NH(C₆H₅) | H | H | H |
| I.a.560 | N(CH₃)C(O)NH(C₆H₅) | H | H | F |
| I.a.561 | N(CH₃)C(O)NH(C₆H₅) | H | F | H |
| I.a.562 | N(CH₃)C(O)NH(C₆H₅) | H | F | F |
| I.a.563 | N(CH₃)C(O)NH(C₆H₅) | H | Cl | H |
| I.a.564 | N(CH₃)C(O)NH(C₆H₅) | H | Cl | F |
| I.a.565 | N(CH₃)C(O)NH(C₆H₅) | F | H | H |
| I.a.566 | N(CH₃)C(O)NH(C₆H₅) | F | H | F |
| I.a.567 | N(CH₃)C(O)NH(C₆H₅) | F | F | H |
| I.a.568 | N(CH₃)C(O)NH(C₆H₅) | F | F | F |
| I.a.569 | N(CH₃)C(O)NH(C₆H₅) | F | Cl | H |
| I.a.570 | N(CH₃)C(O)NH(C₆H₅) | F | Cl | F |
| I.a.571 | N(CH₃)C(O)NH(C₆H₅) | CH₃ | H | H |
| I.a.572 | N(CH₃)C(O)NH(C₆H₅) | CH₃ | H | F |
| I.a.573 | N(CH₃)C(O)NH(C₆H₅) | CH₃ | F | H |
| I.a.574 | N(CH₃)C(O)NH(C₆H₅) | CH₃ | F | F |
| I.a.575 | N(CH₃)C(O)NH(C₆H₅) | CH₃ | Cl | H |
| I.a.576 | N(CH₃)C(O)NH(C₆H₅) | CH₃ | Cl | F |
| I.a.577 | N(CH₃)C(O)N(CH₃)₂ | H | H | H |
| I.a.578 | N(CH₃)C(O)N(CH₃)₂ | H | H | F |
| I.a.579 | N(CH₃)C(O)N(CH₃)₂ | H | F | H |
| I.a.580 | N(CH₃)C(O)N(CH₃)₂ | H | F | F |
| I.a.581 | N(CH₃)C(O)N(CH₃)₂ | H | Cl | H |
| I.a.582 | N(CH₃)C(O)N(CH₃)₂ | H | Cl | F |
| I.a.583 | N(CH₃)C(O)N(CH₃)₂ | F | H | H |
| I.a.584 | N(CH₃)C(O)N(CH₃)₂ | F | H | F |
| I.a.585 | N(CH₃)C(O)N(CH₃)₂ | F | F | H |
| I.a.586 | N(CH₃)C(O)N(CH₃)₂ | F | F | F |
| I.a.587 | N(CH₃)C(O)N(CH₃)₂ | F | Cl | H |
| I.a.588 | N(CH₃)C(O)N(CH₃)₂ | F | Cl | F |
| I.a.589 | N(CH₃)C(O)N(CH₃)₂ | CH₃ | H | H |
| I.a.590 | N(CH₃)C(O)N(CH₃)₂ | CH₃ | H | F |
| I.a.591 | N(CH₃)C(O)N(CH₃)₂ | CH₃ | F | H |
| I.a.592 | N(CH₃)C(O)N(CH₃)₂ | CH₃ | F | F |
| I.a.593 | N(CH₃)C(O)N(CH₃)₂ | CH₃ | Cl | H |
| I.a.594 | N(CH₃)C(O)N(CH₃)₂ | CH₃ | Cl | F |
| I.a.595 | N(CH₃)C(O)N(CH₃)(C₆H₅) | H | H | H |
| I.a.596 | N(CH₃)C(O)N(CH₃)(C₆H₅) | H | H | F |
| I.a.597 | N(CH₃)C(O)N(CH₃)(C₆H₅) | H | F | H |
| I.a.598 | N(CH₃)C(O)N(CH₃)(C₆H₅) | H | F | F |
| I.a.599 | N(CH₃)C(O)N(CH₃)(C₆H₅) | H | Cl | H |
| I.a.600 | N(CH₃)C(O)N(CH₃)(C₆H₅) | H | Cl | F |
| I.a.601 | N(CH₃)C(O)N(CH₃)(C₆H₅) | F | H | H |
| I.a.602 | N(CH₃)C(O)N(CH₃)(C₆H₅) | F | H | F |
| I.a.603 | N(CH₃)C(O)N(CH₃)(C₆H₅) | F | F | H |
| I.a.604 | N(CH₃)C(O)N(CH₃)(C₆H₅) | F | F | F |
| I.a.605 | N(CH₃)C(O)N(CH₃)(C₆H₅) | F | Cl | H |
| I.a.606 | N(CH₃)C(O)N(CH₃)(C₆H₅) | F | Cl | F |
| I.a.607 | N(CH₃)C(O)N(CH₃)(C₆H₅) | CH₃ | H | H |
| I.a.608 | N(CH₃)C(O)N(CH₃)(C₆H₅) | CH₃ | H | F |
| I.a.609 | N(CH₃)C(O)N(CH₃)(C₆H₅) | CH₃ | F | H |
| I.a.610 | N(CH₃)C(O)N(CH₃)(C₆H₅) | CH₃ | F | F |
| I.a.611 | N(CH₃)C(O)N(CH₃)(C₆H₅) | CH₃ | Cl | H |
| I.a.612 | N(CH₃)C(O)N(CH₃)(C₆H₅) | CH₃ | Cl | F |
| I.a.613 | N(CH₃)SO₂CH₃ | H | H | H |
| I.a.614 | N(CH₃)SO₂CH₃ | H | H | F |
| I.a.615 | N(CH₃)SO₂CH₃ | H | F | H |
| I.a.616 | N(CH₃)SO₂CH₃ | H | F | F |
| I.a.617 | N(CH₃)SO₂CH₃ | H | Cl | H |
| I.a.618 | N(CH₃)SO₂CH₃ | H | Cl | F |
| I.a.619 | N(CH₃)SO₂CH₃ | F | H | H |
| I.a.620 | N(CH₃)SO₂CH₃ | F | H | F |
| I.a.621 | N(CH₃)SO₂CH₃ | F | F | H |
| I.a.622 | N(CH₃)SO₂CH₃ | F | F | F |
| I.a.623 | N(CH₃)SO₂CH₃ | F | Cl | H |
| I.a.624 | N(CH₃)SO₂CH₃ | F | Cl | F |
| I.a.625 | N(CH₃)SO₂CH₃ | CH₃ | H | H |
| I.a.626 | N(CH₃)SO₂CH₃ | CH₃ | H | F |
| I.a.627 | N(CH₃)SO₂CH₃ | CH₃ | F | H |
| I.a.628 | N(CH₃)SO₂CH₃ | CH₃ | F | F |
| I.a.629 | N(CH₃)SO₂CH₃ | CH₃ | Cl | H |
| I.a.630 | N(CH₃)SO₂CH₃ | CH₃ | Cl | F |

Extraordinary preference is also given to the compounds of formula I.b, in particular to the compounds of the formulae I.b.1 to I.b.630 which differ from the corresponding compounds of the formulae I.a.1 to I.a.630 in that R¹⁶ is CH₂CH₃.

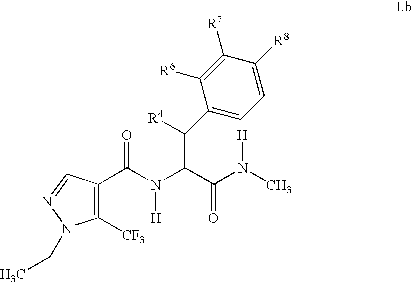

Extraordinary preference is also given to the compounds of formula I.c, in particular to the compounds of the formulae I.c.1 to I.c.630 which differ from the corresponding compounds of the formulae I.a.1 to I.a.630 in that R¹⁶ is CH₂CF₃.

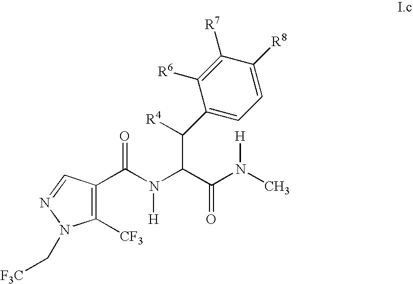

Extraordinary preference is also given to the compounds of formula I.d, in particular to the compounds of the formulae I.d.1 to I.d.630 which differ from the corresponding compounds of the formulae I.a.1 to I.a.630 in that A is A2a where R¹⁶=CH₃, R¹⁷=H and R¹⁸=CF₃.

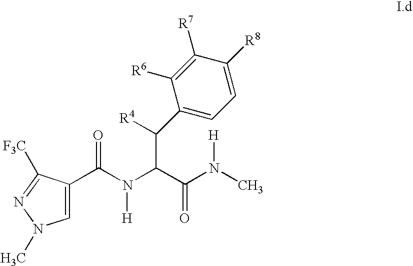

Extraordinary preference is also given to the compounds of formula I.e, in particular to the compounds of the formulae I.e.1 to I.e.630 which differ from the corresponding compounds of the formulae I.a.1 to I.a.630 in that A is A2a where R¹⁶=CH₂CH₃, R¹⁷=H and R¹⁸=CF₃.

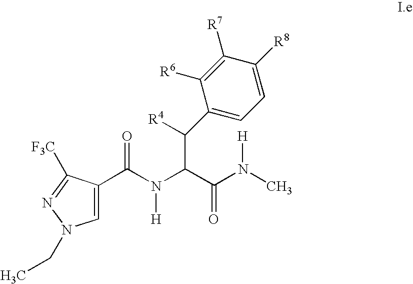

Extraordinary preference is also given to the compounds of formula I.f, in particular to the compounds of the formulae I.f.1 to I.f.630 which differ from the corresponding compounds of the formulae I.a.1 to I.a.630 in that A is A2a where R¹⁶=CH₂CF₃, R¹⁷=H and R¹⁸=CF₃.

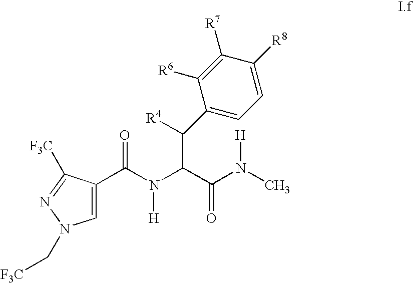

Extraordinary preference is also given to the compounds of formula I.g, in particular to the compounds of the formulae I.g.1 to I.g.630 which differ from the corresponding compounds of the formulae I.a.1 to I.a.630 in that A is A2a where R¹⁶=CH(CH₃)₂, R¹⁷=H and R¹⁸=CF₃.

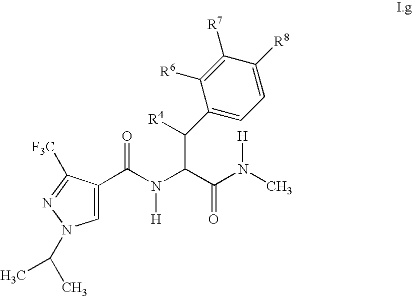

Extraordinary preference is also given to the compounds of formula I.h, in particular to the compounds of the formulae I.h.1 to I.h.630 which differ from the corresponding compounds of the formulae I.a.1 to I.a.630 in that A is A2a where R¹⁶=CH₂CHCH₂, R¹⁷=H and R¹⁸=CF₃.

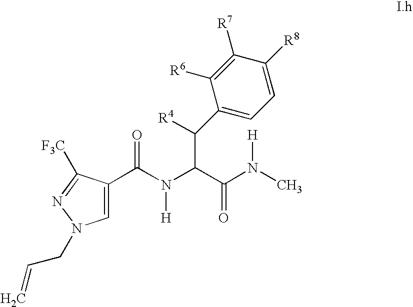

Extraordinary preference is also given to the compounds of formula I.i, in particular to the compounds of the formulae I.i.1 to I.i.630 which differ from the corresponding compounds of the formulae I.a.1 to I.a.630 in that A is Ala where R¹⁶=CH(CH₃)₂, R¹⁷=H and R¹⁸=CF₃.

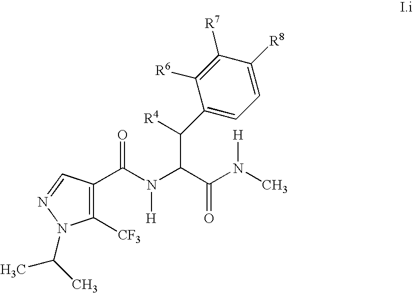

Extraordinary preference is also given to the compounds of formula I.k, in particular to the compounds of the formulae I.k.1 to I.k.630 which differ from the corresponding compounds of the formulae I.a.1 to I.a.630 in that A is Ala where R¹⁶=CH₂CHCH₂, R¹⁷=H and R¹⁸=CF₃.

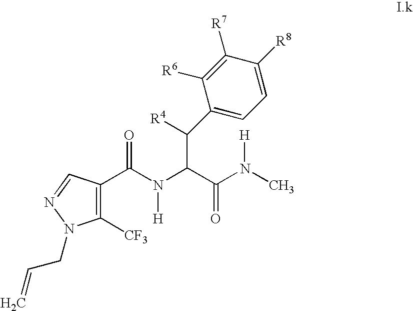

Extraordinary preference is also given to the compounds of the formula I.I., in particular to the compounds of the formulae I.I.1 to I.I.630 which differ from the corresponding compounds of the formulae I.a.1 to I.a.630 in that A is A1 where R¹⁷=H and R¹⁸=CF₃.

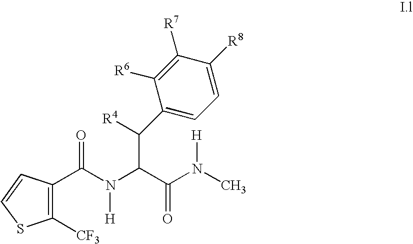

Extraordinary preference is also given to the compounds of the formula I.m, in particular to the compounds of the formulae I.m.1 to I.m.630, which differ from the corresponding compounds of the formulae I.a.1 to I.a.630 in that A is A1 where R¹⁷=CH₃ and R¹⁸=CF₃.

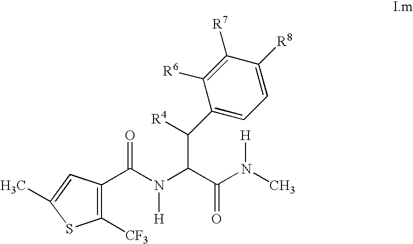

Extraordinary preference is also given to the compounds of the formula I.n, in particular to the compounds of the formulae I.n.1 to I.n.630, which differ from the corresponding compounds of the formulae I.a.1 to I.a.630 in that A is A2 where R¹⁷=H and R¹⁸=CF₃.

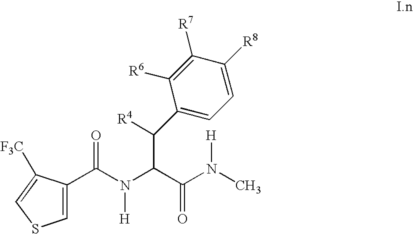

Extraordinary preference is also given to the compounds of the formula I.o, in particular to the compounds of the formulae I.o.1 to I.o.630, which differ from the corresponding compounds of the formulae I.a.1 to I.a.630 in that A is A3 where R¹⁷=H and R¹⁸=CF₃.

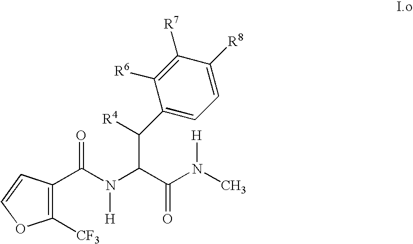

Extraordinary preference is also given to the compounds of the formula I.p, in particular to the compounds of the formulae I.p.1 to I.p.630, which differ from the corresponding compounds of the formulae I.a.1 to I.a.630 in that A is A3 where R¹⁷=CH₃ and R¹⁸=CF₃.

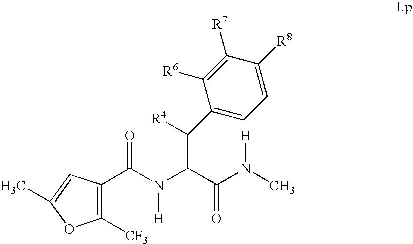

Extraordinary preference is also given to the compounds of the formula I.q, in particular to the compounds of the formulae I.q.1 to I.q.630, which differ from the corresponding compounds of the formulae I.a.1 to I.a.630 in that A is A4 where

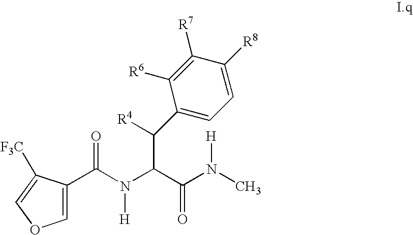

Extraordinary preference is also given to the compounds of the formula I.r, in particular to the compounds of the formulae I.r.1 to I.r.630, which differ from the corresponding compounds of the formulae I.a.1 to I.a.630 in that A is A5 where R¹⁶=H, R¹⁸=CF₃ and R¹⁹=H.

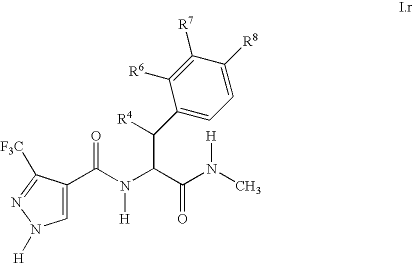

Extraordinary preference is also given to the compounds of the formula I.s, in particular to the compounds of the formulae I.s.1 to I.s.630, which differ from the corresponding compounds of the formulae I.a.1 to I.a.630 in that A is A8 where R¹⁷=H and R¹⁸=CF₃.

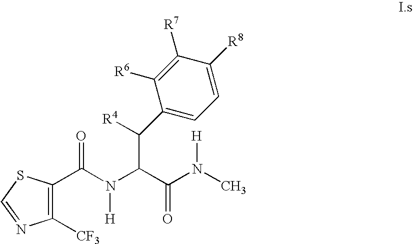

Extraordinary preference is also given to the compounds of the formula I.t, in particular to the compounds of the formulae I.t.1 to I.t.630, which differ from the corresponding compounds of the formulae I.a.1 to I.a.630 in that A is A8 where R¹⁷=CH₃ and R¹⁸=CF₃.

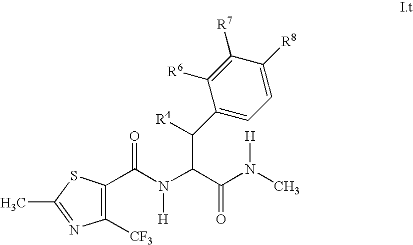

The heteroaroyl-substituted phenylalanineamides of the formula I can be obtained by different routes, for example by the following processes:

Process A

A phenylalanine of the formula V is initially converted with heteroarylcarboxylic acids or heteroarylcarboxylic acid derivatives of the formula IV into the corresponding heteroaroyl derivative of the formula III which is then reacted with an amine of the formula II to give the desired heteroaroyl-substituted phenylalanineamide of the formula I: 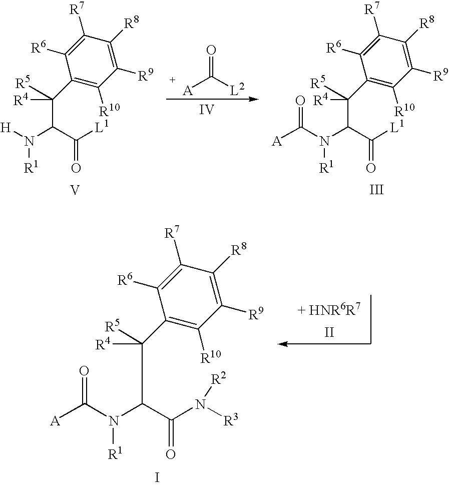
L¹ is a nucleophilically displaceable leaving group, for example hydroxyl or C₁-C₆-alkoxy.
L² is a nucleophilically displaceable leaving group, for example hydroxyl, halogen, C₁-C₆-alkylcarbonyl, C₁-C₆-alkoxycarbonyl, C₁-C₄-alkylsulfonyl, phosphoryl or isoureyl.

The reaction of the phenylalanines of the formula V with heteroarylcarboxylic acids or heteroarylcarboxylic acid derivatives of the formula IV where L² is hydroxyl to give heteroaroyl derivates of formula III is carried out in the presence of an activating agent and a base, usually at temperatures of from 0° C. to the boiling point of the reaction mixture, preferably from 0° C. to 110° C., particularly preferably at room temperature, in an inert organic solvent [cf. Bergmann, E. D.; et al., J Chem Soc 1951, 2673; Zhdankin, V. V.; et al., Tetrahedron Lett. 2000, 41 (28), 5299-5302; Martin, S. F. et al., Tetrahedron Lett. 1998, 39 (12), 1517-1520; Jursic, B. S. et al., Synth Commun 2001, 31 (4), 555-564; Albrecht, M. et al., Synthesis 2001, (3), 468472; Yadav, L. D. S. et al., Indian J. Chem B. 41 (3), 593-595 (2002); Clark, J. E. et al., Sythesis (10), 891-894 (1991)].

Suitable activating agents are condensing agents, such as, for example, polystyrene-bound dicyclohexylcarbodiimide, diisopropylcarbodiimide, carbonyldiimidazole, chloroformates, such as methyl chloroformate, ethyl chloroformate, isopropyl chloroformate, isobutyl chloroformate, sec-butyl chloroformate or allyl chloroformate, pivaloyl chloride, polyphosphoric acid, propanephosphonic anhydride, bis(2-oxo-3-oxazolidynyl)phosphoryl chloride (BOPCI) or sulfonyl chlorides such as methanesulfonyl chloride, toluenesulfonyl chloride or benzenesulfonyl chloride.

Suitable solvents are aliphatic hydrocarbons, such as pentane, hexane, cyclohexane and mixtures of C₅-C₈-alkanes, aromatic hydrocarbons, such as benzene, toluene, o-, m- and p-xylene, halogenated hydrocarbons, such as methylene chloride, chloroform and chlorobenzene, ethers, such as diethyl ether, diisopropyl ether, tert-butyl methyl ether, dioxane, anisole and tetrahydrofuran (THF), nitriles, such as acetonitrile and propionitrile, ketones, such as acetone, methyl ethyl ketone, diethyl ketone and tert-butyl methyl ketone, and also dimethyl sulfoxide, dimethylformamid (DMF), dimethylacetamide (DMA) and N-methylpyrrolidone (NMP), or else water; particular preference is given to methylene chloride, THF and water.

It is also possible to use mixtures of the solvents mentioned.

Suitable bases are, in general, inorganic compounds, such as alkali metal and alkaline earth metal hydroxides, such as lithium hydroxide, sodium hydroxide, potassium hydroxide and calcium hydroxide, alkali metal and alkaline earth metal oxides, such as lithium oxide, sodium oxide, calcium oxide and magnesium oxide, alkali metal and alkaline earth metal hydrides, such as lithium hydride, sodium hydride, potassium hydride and calcium hydride, alkali metal and alkaline earth metal carbonates, such as lithium carbonate, potassium carbonate and calcium carbonate, and also alkali metal bicarbonates, such as sodium bicarbonate, moreover organic bases, for example tertiary amines, such as trimethylamine, triethylamine, diisopropylethylamine, N-methylmorpholine, and N-methylpiperidine, pyridine, substituted pyridines, such as collidine, lutidine and 4-dimethylaminopyridine, and also bicyclic amines. Particular preference is given to sodium hydroxide, triethylamine and pyridine.

The bases are generally employed in equimolar amounts. However, they can also be used in excess or, if appropriate, as solvent.

The starting materials are generally reacted with one another in equimolar amounts. It may be advantageous to employ an excess of IV, based on V.

The reaction mixtures are worked up in a customary manner, for example by mixing with water, separating the phases and, if appropriate, chromatographic purification of the crude products. Some of the intermediates and end products are obtained in the form of viscous oils which are freed from volatile components or purified under reduced pressure and at moderately elevated temperature. If the intermediates and end products are obtained as solids, purification can also be carried out by recrystallization or digestion.

The reaction of the phenylalanines of the formula V with heteroarylcarboxylic acids or heteroarylcarboxylic acid derivatives of the formula IV where L² is halogen, C₁-C₆-alkylcarbonyl, C₁-C₆-alkoxycarbonyl, C₁-C₄-alkylsulfonyl, phosphonyl or isoureyl to give heteroaroyl derivatives of the formula III is carried out in the presence of a base, usually at temperatures of from 0° C. to the boiling point of the reaction mixture, preferably from 0° C. to 100° C., particularly preferably at room temperature, in an inert organic solvent [cf. Bergmann, E. D.; et al., J Chem Soc 1951, 2673; Zhdankin, V. V.; et al., Tetrahedron Lett. 2000, 41 (28), 5299-5302; Martin, S. F. et al., Tetrahedron Lett. 1998, 39 (12), 1517-1520; Jursic, B. S. et al., Synth Commun 2001, 31 (4), 555-564; Albrecht, M. et al., Synthesis 2001, (3), 468-472; Yadav, L. D. S. et al., Indian J. Chem B. 41 (3), 593-595 (2002); Clark, J. E. et al., Sythesis (10), 891-894 (1991)].

Suitable solvents are aliphatic hydrocarbons, such as pentane, hexane, cyclohexane and mixtures of C₅-C₈-alkanes, aromatic hydrocarbons, such as benzene, toluene, o-, m- and p-xylene, halogenated hydrocarbons, such as methylene chloride, chloroform and chlorobenzene, ethers, such as diethyl ether, diisopropyl ether, tert-butyl methyl ether, dioxane, anisole and tetrahydrofuran (THF), nitriles, such as acetonitrile and propionitrile, ketones, such as acetone, methyl ethyl ketone, diethyl ketone and tert-butyl methyl ketone, and also dimethyl sulfoxide, dimethylformamide (DMF), dimethylacetamide (DMA) and N-methylpyrrolidone (NMP), or else water; particular preference is given to methylene chloride, THF and water.

It is also possible to use mixtures of the solvents mentioned.

Suitable bases are, in general, inorganic compounds, such as alkali metal and alkaline earth metal hydroxides, such as lithium hydroxide, sodium hydroxide, potassium hydroxide and calcium hydroxide, alkali metal and alkaline earth metal oxides, such as lithium oxide, sodium oxide, calcium oxide and magnesium oxide, alkali metal and alkaline earth metal hydrides, such as lithium hydride, sodium hydride, potassium hydride and calcium hydride, alkali metal and alkaline earth metal carbonates, such as lithium carbonate, potassium carbonate and calcium carbonate, and also alkali metal bicarbonates, such as sodium bicarbonate, moreover organic bases, for example tertiary amines, such as trimethylamine, triethylamine, diisopropylethylamine, N-methylmorpholine, and N-methylpiperidine, pyridine, substituted pyridines, such as collidine, lubdine and 4-dimethylaminopyridine, and also bicyclic amines. Particular preference is given to sodium hydroxide, triethylamine and pyridine.

The bases are generally employed in equimolar amounts. However, they can also be employed in excess or, if appropriate, as solvent.

The starting materials are generally reacted with one another in equimolar amounts. It may be advantageous to employ an excess of IV, based on V.

Work-up and isolation of the products can be carried out in a manner known per se.

It is, of course, also possible to initially convert, in an analogous manner, the phenylalanines of the formula V with amines of the formula II into the corresponding amines which then react with heteroarylcarboxylic acids or heteroarylcarboxylic acid derivatives of the formula IV to give the corresponding heteroaroyl-substituted phenylalanineamides of the formula I.

The phenylalanines of the formula V where L¹=hydroxyl, required for preparing the heteroaroyl derivatives of the formula II, are known from the literature or can be prepared in accordance with the literature cited, also in enantiomerically and diastereomerically pure form:
R⁴=OR¹¹:
   by condensation of glycine enolate equivalents with benzaldehydes (Hvidt, T. et al., Tetrahedron Lett. 27 (33), 3807-3810 (1986); Saeed, A. et al., Tetrahedron 48 (12), 2507-2514 (1992); Kikuchi, J. et al., Chem. Lett. (3), 553-556 (1993); Soloshonok, V. A. et al., Tetrahedron Lett. 35 (17), 2713-2716 (1994); Soloshonok, V. A.; et al.; Tetrahedron 52 (1), 245-254 (1996); Rozenberg, V. et al., Angew. Chem. 106 (1), 106-108 (1994); U.S. Pat. No. 4,605,759; Alker, D. et al., Tetrahedron 54 (22), 6089-6098 (1998); Shengde, W. et al., Synth. Commun. 16 (12), 1479 (1986); JP 2001046076; Herbert, R. B. et al., Can. J. Chem. 72 (1), 114-117 (1994));
   by cleaving 2-N-phthaloyl-3-hydroxyphenylalanines (Hutton, C. A., Org. Lett. 1 (2), 295-297 (1999));
   by oxidative aminohydroxylation and subsequent deprotection of cinnamic acid derivatives (Kim, I. H. et al., Tetrahedron Lett. 42 (48), 8401-8403 (2001);
   by cleaving substituted oxazolidines (Wu, S. D. et al., Synthetic Commun. 16 (12), 1479-1484 (1986));
   by cleaving substituted oxazolines (Soloshonok, V. A.; et al.; Tetrahedron 52 (1), 245-254 (1996); Lown, J. W. et al., Can. J. Chem. 51, 856 (1973));
   by cleaving substituted 2-oxazolidinones (Jung, M. E. et al., Tetrahedron Lett. 30 (48), 6637-6640 (1989));
   by cleaving substituted 5-oxazolidinones (Blaser, D. et al., Liebigs Ann. Chem. (10), 1067-1078 (1991));
   by hydrolysis of phenylserinenitrile derivatives (Iriuchijima, S. et al., J. Am. Chem. Soc. 96, 4280 (1974))
   by cleaving substituted imidazolin-4-ones (Davis, C et al., J. Chem. Soc. 3479 (1951))
R⁴=SR¹²:
   by cleaving 2-acylamino-3-thioalkylphenylalanine derivatives (Villeneuve, G. et al., J. Chem. Soc. Perkin Trans 1 (16), 1897-1904(1993))
   by ring-opening of thiazolidinethiones (Cook, A. H. et al., J. Chem. Soc. 1337 (1948))
R⁴=NR¹³R¹⁴:
   by ring-opening of substituted imidazolinones (Kavrakova, I. K. et al., Org. Prep. Proced. Int. 28 (3), 333-338 (1996))
   by ring-opening of substituted imidazolines (Meyer R., Liebigs Ann. Chem., 1183 (1977); Hayashi, T. et al., Tetrahedron Lett. 37 (28), 4969-4972 (1996); Lin, Y. R. et al., J. Org. Chem. 62 (6), 1799-1803 (1997); Zhou, X. T. et al., Tetrahedron Asym. 10 (5), 855-862 (1999))
   by reduction of 2-azido-3-aminophenylalanine derivatives (Moyna, G. et al., Synthetic Commun. 27 (9), 1561-1567 (1997))
   by hydrogenation of substituted imidazolidines (Alker, D. et al., Tetrahedron Lett. 39 (5-6), 475478 (1998))

The phenylalanines of the formula V where L¹=C₁-C₆-alkoxy, required for preparing the heteroaryl derivatives of the formula III, are known from the literature or can be prepared in accordance with the literature cited, also in enantiomerically and diastereomerically pure form:
R⁴═OR¹¹:
   by condensation of glycine enolate equivalents with aldehydes: Nicolaou, K. C. et al., J. Am. Chem. Soc. 124 (35), 10451-10455 (2002); Carrara, G. et al., Gazz. Chim. Ital. 82, 325 (1952); Fuganti, C. et al., J. Org. Chem. 51 (7), 1126-1128 (1986); Boger, D. L. et al., J. Org. Chem. 62 (14), 4721-4736 (1997); Honig, H. et al., Tetrahedron (46), 3841 (1990); Kanemasa, S. et al., Tetrahedron Lett. 34 (4), 677-680 (1993); U.S. Pat. No. 4,873,359)
   by cleaving dihydropyrazines (Li, Y. Q. et al., Tetrahedron Lett. 40 (51), 9097-9100 (1999); Beulshausen, T. et al., Liebigs Ann. Chem. (11), 1207-1209 (1991))
   by reducing N-aminophenylserine derivatives (Poupardin, O. et al., Tetrahedron Lett. 42 (8), 1523-1526 (2001))
   by cleaving N-carbamoylphenylserine derivatives (Park, H. et al., J. Org. Chem. 66 (21), 7223-7226 (2001); U.S. Pat. No. 6,057,473; Kim, I. H. et al., Tetrahedron Lett. 42 (48), 8401-8403 (2001); Nicolaou, K. C. et al., Angew. Chem. Int. Edit. 37 (19), 2714-2716 (1998))
   by cleaving substituted oxazolidines (Zhou, C. Y. et al., Synthetic Commun. 17 (11), 1377-1382 (1987))
   by reducing 2-azido-3-hydroxyphenylpropionic acid derivatives (Corey, E. J. et al., Tetrahedron Lett. 32 (25), 2857-2860 (1991))
   by ring-opening of aziridines using oxygen nucleophiles (Davis, F. A. et al., J. Org. Chem. 59 (12), 3243-3245 (1994))
   by cleaving substituted 2-oxazolidinones (Jung, M. E. et al., Synlett 563-564 (1995))
   by reducing 2-hydroxyimino-3-ketophenylpropionic acid derivatives (Inoue, H. et al., Chem. Phar. Bull. 41 (9), 1521-1523 (1993); Chang, Y.-T. et al., J. Am. Chem. Soc. 75, 89 (1953); U.S. Pat. No. 4,810,817)
   by hydrolyzing phenylserineimino derivatives (Solladiecavallo, A. et al., Gazz. Chim. Ital. 126 (3), 173-178 (1996); Solladiecavallo, A. et al., Tetrahedron Lett. 39 (15), 2191-2194 (1998))
   by cleaving N-acylphenylserine derivatives (Girard, A. et al., Tetrahedron Lett. 37 (44), 7967-7970 (1996)) - by reducing 2-hydroxyimino-3-hydroxyphenylpropionic acid derivatives (Boukhris, S. et al., Tetrahedron Lett. 40 (9), 1669-1672 (1999))
   by cleaving N-benzylphenylserine derivatives (Caddick, S.; Tetrahedron, 57 (30), 6615-6626 (2001)) - by reducing 2-diazo-3-ketophenylpropionic acid derivatives (Looker, et al., J. Org. Chem. 22, 1233 (1957))
   by cleaving substituted imidazolidinones (Davis, A. C.; et al., J. Chem. Soc. 3479 (1951))
R⁴=SR¹²:
   by ring-opening of substituted thiazolidines (Nagai, U. et al., Heterocycles 28 (2), 589-592 (1989))
   by ring-opening of substituted aziridines using thiols (Legters, J. et al., Recl. Trav. Chim. Pays-Bas 111 (1), 16-21 (1992))
   by reducing 3-ketophenylalanine derivatives (U.S. Pat. No. 4,810,817)
R⁴=NR¹³R¹⁴:
   by reducing substituted 2-azido-3-aminophenylalanine derivatives (Lee S. H., Tetrahedron 57(11), 2139-2145 (2001))
   by ring-opening of substituted imidazolines (Zhou, X. T. et al., Tetrahedron Asymmetr. 10 (5), 855-862 (1999); Hayashi, T. et al., Tetrahedron Lett. 37 (28), 4969-4972 (1996))

The heteroarylcarboxylic acids or heteroarylcarboxylic acid derivatives of the formula IV, required for preparing the heteroaroyl derivatives of the formula III, are commercially available or can be prepared analogously to procedures known from the literatures via a Grignard reaction from the corresponding halide [for example A. Mannschuk et al., Angew. Chem. 100 (1988), 299].

The conversion of the heteroaroyl derivatives of the formula III where L¹=hydroxyl or salts thereof with an amine of the formula II into the desired heteroaroyl-substituted phenylalanineamides of the formula I is carried out in the presence of an activating agent and, if appropriate, in the presence of a base, usually at temperatures of from 0° C. to the boiling point of the reaction mixture, preferably from 0° C. to 100° C., particularly preferably at room temperature, in an inert organic solvent [cf. Perich, J. W., Johns, R. B., J. Org. Chem. 53 (17), 41034105 (1988); Somlai, C. et al., Synthesis (3), 285-287 (1992); Gupta, A. et al., J. Chem. Soc. Perkin Trans. 2, 1911 (1990); Guan et al., J. Comb. Chem. 2, 297 (2000)].

Suitable activating agents are condensing agents, such as, for example, polystyrene-bound dicyclohexylcarbodiimide, diisopropylcarbodiimide, carbonyldiimidazole, chloroformic esters, such as methyl chloroformate, ethyl chloroformate, isopropyl chloroformate, isobutyl chloroformate, sec-butyl chloroformate or allyl chloroformate, pivaloyl chloride, polyphosphoric acid, propanephosphonic anhydride, bis(2-oxo-3-oxazolidinyl)phosphoryl chloride (BOPCI) or sulfonyl chlorides, such as methanesulfonyl chloride, toluenesulfonyl chloride or benzenesulfonyl chloride.

Suitable solvents are aliphatic hydrocarbons such as pentane, hexane, cyclohexane and mixtures of C₅-C₈-alkanes, aromatic hydrocarbons, such as benzene, toluene, o-, m- and p-xylene, halogenated hydrocarbons, such as methylene chloride, chloroform and chlorobenzene, ethers, such as diethyl ether, diisopropyl ether, tert-butyl methyl ether, dioxane, anisole and tetrahydrofuran (THF), nitriles, such as acetonitrile and propionitrile, ketones, such as acetone, methyl ethyl ketone, diethyl ketone and tert-butyl methyl ketone, alcohols, such as methanol, ethanol, n-propanol, isopropanol, n-butanol and tert-butanol, and also dimethyl sulfoxide, dimethylformamide (DMF), dimethylacetamide (DMA) and N-methylpyrrolidone (NMP), or else water; particular preference is given to methylene chloride, THF, methanol, ethanol and water.

It is also possible to use mixtures of the solvents mentioned.

Suitable bases are, in general, inorganic compounds, such as alkali metal and alkaline earth metal hydroxides, such as lithium hydroxide, sodium hydroxide, potassium hydroxide and calcium hydroxide, alkali metal and alkaline earth metal oxides, such as lithium oxide, sodium oxide, calcium oxide and magnesium oxide, alkali metal and alkaline earth metal hydrides, such as lithium hydride, sodium hydride, potassium hydride and calcium hydride, alkali metal and alkaline earth metal carbonates, such as lithium carbonate, potassium carbonate and calcium carbonate, and also alkali metal bicarbonates, such as sodium bicarbonate, moreover organic bases, for example tertiary amines, such as trimethylamine, triethylamine, diisopropylethylamine, N-methylmorpholine and N-methylpiperidine, pyridine, substituted pyridines, such as collidine, lutidine and 4-dimethylaminopyridine, and also bicyclic amines. Particular preference is given to sodium hydroxide, triethylamine, ethyl diisopropylamine, N-methylmorpholine and pyridine.

The bases are generally employed in catalytic amounts; however, they can also be employed in equimolar amounts, in excess or, if appropriate, as solvent.

The starting materials are generally reacted with one another in equimolar amounts. It may be advantageous to employ an excess of II, based on Ill.

Work-up and isolation of the products can be carried out in a manner known per se.

The conversion of the heteroaroyl derivatives of the formula III where L¹=C₁-C₆-alkoxy with an amine of the formula II into the desired heteroaroyl-substituted phenylalanineamides of the formula I is usually carried out at temperatures of from 0° C. to the boiling point of the reaction mixture, preferably from 0° C. to 100° C., particularly preferably at room temperature, in an inert organic solvent, if appropriate in the presence of a base [cf. Kawahata, N. H. et al., Tetrahedron Lett. 43 (40), 7221-7223 (2002); Takahashi, K. et al., J. Org. Chem. 50 (18), 3414-3415 (1985); Lee, Y. et al., J. Am. Chem. Soc. 121 (36), 8407-8408 (1999)].

Suitable solvents are aliphatic hydrocarbons such as pentane, hexane, cyclohexane and mixtures of C₅-C₈-alkanes, aromatic hydrocarbons, such as benzene, toluene, o-, m- and p-xylene, halogenated hydrocarbons, such as methylene chloride, chloroform and chlorobenzene, ethers, such as diethyl ether, diisopropyl ether, tert-butyl methyl ether, dioxane, anisole and tetrahydrofuran (THF), nitriles, such as acetonitrile and propionitrile, ketones, such as acetone, methyl ethyl ketone, diethyl ketone and tert-butyl methyl ketone, alcohols, such as methanol, ethanol, n-propanol, isopropanol, n-butanol and tert-butanol, and also dimethyl sulfoxide, dimethylformamide (DMF), dimethylacetamide (DMA) and N-methylpyrrolidone (NMP), or else water; particular preference is given to methylene chloride, THF, methanol, ethanol and water.

It is also possible to use mixtures of the solvents mentioned.

The reaction can, if appropriate, be carried out in the presence of a base. Suitable bases are, in general, inorganic compounds, such as alkali metal and alkaline earth metal hydroxides, such as lithium hydroxide, sodium hydroxide, potassium hydroxide and calcium hydroxide, alkali metal and alkaline earth metal oxides, such as lithium oxide, sodium oxide, calcium oxide and magnesium oxide, alkali metal and alkaline earth metal hydrides, such as lithium hydride, sodium hydride, potassium hydride and calcium hydride, alkali metal and alkaline earth metal carbonates, such as lithium carbonate, potassium carbonate and calcium carbonate, and also alkali metal bicarbonates, such as sodium bicarbonate, moreover organic bases, for example tertiary amines, such as trimethylamine, triethylamine, diisopropylethylamine, N-methylmorpholine and N-methylpiperidine, pyridine, substituted pyridines, such as collidine, lutidine and 4-dimethylaminopyridine, and also bicyclic amines. Particular preference is given to sodium hydroxide, triethylamine, ethyl diisopropylamine, N-methylmorpholine and pyridine.

The bases are generally employed in catalytic amounts; however, they can also be employed in equimolar amounts, in excess or, if appropriate, as solvent.

The starting materials are generally reacted with one another in equimolar amounts. It may be advantageous to employ an excess of II, based on III.

Work-up and isolation of the products can be carried out in a manner known per se.

The amines of the formula II required for preparing the heteroaroyl-substituted serine amides of the formula I are commercially available.

Process B

Heteroaroyl derivatives of the formula III where R⁴=hydroxyl can also be obtained by condensing acylated glycine derivatives of the formula VIII where the acyl group may be a cleavable protective group, such as benzyloxycarbonyl (cf. Villa where Σ=benzyl) or tert-butyloxycarbonyl (cf. VIIIa where Σ=tert-butyl), with heterocyclylcarbonyl compounds VII to give the corresponding aldol products VI. The protective group is then cleaved and resulting phenylalanine of the formula V where R⁴=hydroxyl is acylated using heteroarylcarboxylic acids or heteroarylcarboxylic acid derivatives of the formula IV.

Analogously, it is also possible to convert an acylated glycine derivative of the formula VIII where the acyl group is a substituted heteroaroyl radical (cf. VIIIb) in the presence of a base with a heterocyclylcarbonyl compound VII into the heteroaroyl derivative III where R⁴=hydroxyl:

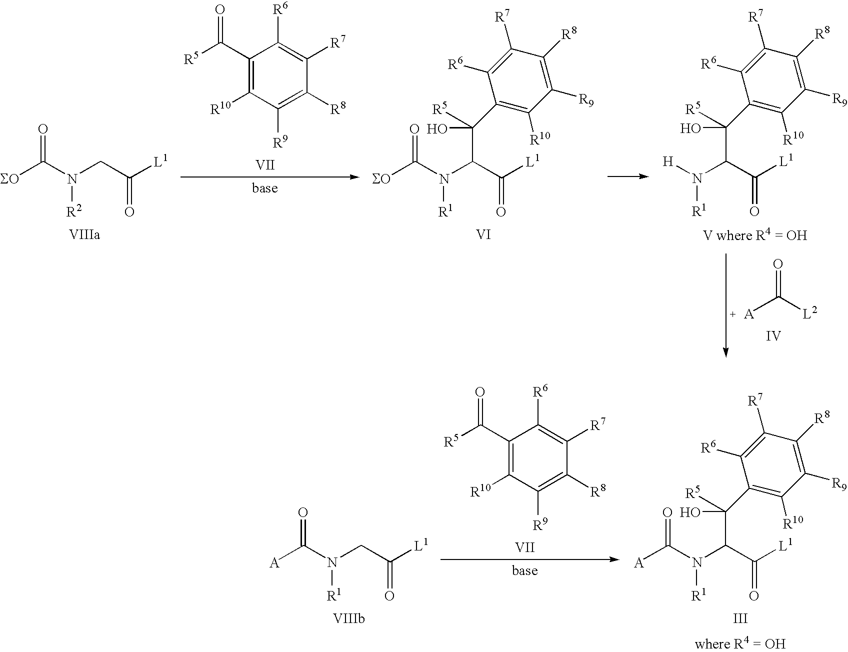

L¹ is a nucleophilically displaceable leaving group, for example hydroxyl or C₁-C₆-alkoxy.

L² is a nucleophilically displaceable leaving group, for example hydroxyl, halogen, C₁-C₆-alkylcarbonyl, C₁-C₆-alkoxycarbonyl, C₁-C₄-alkylsulfonyl, phosphoryl or isoureyl.

The reaction of the glycine derivatives VII with heterocyclyl compounds VII to give the corresponding aldol product VI or heteroaroyl derivative III where R⁴=hydroxyl is usually carried out at temperatures of from −100° C. to the boiling point of the reaction mixture, preferably at from 80° C. to 20° C., particularly preferably at from −80° C. to −20° C., in an inert organic solvent in the presence of a base [cf. J.-F. Rousseau et al., J. Org. Chem. 63, 2731-2737 (1998)].

Suitable solvents are aliphatic hydrocarbons, such as pentane, hexane, cyclohexane and mixtures of C₅-C₈-alkanes, aromatic hydrocarbons, such as toluene, o-, m- and p-xylolene, ethers, such as diethyl ether, diisopropyl ether, tert-butyl methyl ether, dioxane, anisole and tetrahydrofuran, and also dimethyl sulfoxide, dimethylformamide and dimethylacetamide, particularly preferably diethyl ether, dioxane and tetrahydrofuran.

It is also possible to use mixtures of the solvents mentioned.

Suitable bases are, in general, inorganic compounds, such as alkali metal and alkaline earth metal hydrides, such as lithium hydride, sodium hydride, potassium hydride and calcium hydride, alkali metal azides, such as lithium hexamethyldisilazide, organometallic compounds, in particular alkali metal alkyls, such as methyllithium, butyllithium and phenyllithium, and also alkali metal and alkaline earth metal alkoxides, such as sodium methoxide, sodium ethoxide, potassium ethoxide, potassium tert-butoxide, potassium tert-pentoxide, and dimethoxymagnesium, moreover organic bases, for example tertiary amines, such as trimethylamine, triethylamine, diisopropylethylamine and N-methylpiperidine, pyridine, substituted pyridines, such as collidine, lutidine and 4-dimethylaminopyridine, and also bicyclic amines. Particular preference is given to sodium hydride, lithium hexamethyldisilazide and lithium diisopropylamide.

The bases are generally employed in equimolar amounts; however, they can also be used catalytically, in excess or, if appropriate, as solvents.

The starting materials are generally reacted with one another in equimolar amounts. It may be advantageous to employ an excess of base and/or heterocyclylcarbonyl compounds VII, based on the glycine derivatives VII.

Work-up and isolation of the products can be carried out in a manner known per se.

The glycine derivatives of the formula VIII required for preparing the compounds I are commercially available, known from the literature (for example H. Pessoa-Mahana et al., Synth. Comm. 32, 1437 (2002] or can be prepared in accordance with the literature cited.

The protective group is cleaved off by methods known from the literature, giving phenylalanines of the formula V where R⁴=hydroxy][cf J.-F. Rousseau et al., J. Org. Chem. 63, 2731-2737 (1998); J. M. Andres, Tetrahedron 56, 1523 (2000)]; in the case of Σ=benzyl by hydrogenolysis, preferably using hydrogen and Pd/C in methanol; in the case of Σ=tert-butyl using acid, preferably hydrochloric acid in dioxane.

The reaction of the phenylalanines V where R⁴=hydroxyl with heteroarylcarboxylic acids or heteroarylcarboxylic acid derivatives IV to give heteroaroyl derivatives III where R⁴=hydroxyl is usually carried analogously to the reaction, mentioned in process A, of the phenylalanines of the formula V with heteroarylcarboxylic acids or heteroarylcarboxylic acid derivatives of the formula III to give heteroaroyl derivatives III.

Analogously to process A, the heteroaroyl derivatives of the formula III where R⁴=hydroxyl can then be reacted with amines of the formula II to give the desired heteroaroyl-substituted phenylalanineamides of the formula I where R⁴=hydroxyl which can then be derivatized with compounds of the formula IX to give heteroaroyl-substituted phenylalanineamides of the formula I where R⁴=OR¹¹ [cf., for example, Yokokawa, F. et al., Tetrahedron Lett. 42 (34), 5903-5908 (2001); Arrault, A. et al., Tetrahedron Lett. 43(22), 4041-4044 (2002)].

It is also possible to derivatize the heteroaroyl derivatives of the formula III where R⁴=hydroxyl with compounds of the formula IX to give further heteroaroyl derivatives of the formula III [cf., for example, Troast, D. et al., Org. Lett. 4 (6), 991-994 (2002); Ewing W. et al., Tetrahedron Lett., 30 (29), 3757-3760 (1989); Paulsen, H. et al., Liebigs Ann. Chem. 565 (1987)], followed by reaction with amines of the formula II analogously to process A, giving the desired heteroaroyl-substituted phenylalanineamides of formula I where R⁴=OR¹¹:

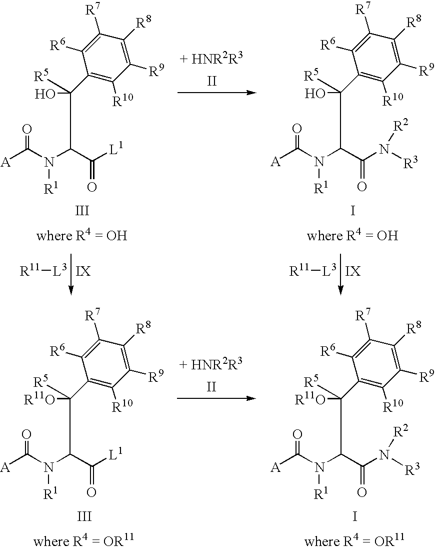

L¹ is a nucleophilically displaceable leaving group, for example hydroxyl or C₁-C₆-alkoxy.

L³ is a nucleophilically displaceable leaving group, for example halogen, hydroxyl or C₁-C₆-alkoxy.

The reaction of the heteroaroyl derivatives of the formula III where R⁴=hydroxyl or OR¹¹ with amides of the formula II to give heteroaroyl-substituted phenylalanineamides of the formula I where R⁴=hydroxyl or OR¹¹ is usually carried out analogously to the reaction, described in process A, of the heteroaroyl derivates of the formula III with amines of the formula II.

The reaction of the heteroaroyl derivatives of the formula III where R⁴=hydroxyl or of the heteroaroyl-substituted phenylalanineamides of the formula I where R⁴=hydroxyl with compounds of the formula IX to give heteroaroyl derivatives of the formula III where R⁴=OR¹¹ or heteroaroyl-substituted phenylalanineamides of the formula I where R⁴=OR¹¹ is usually carried out at temperatures of from 0° C. to 100° C., preferably from 10° C. to 50° C., in an inert organic solvent in the presence of a base [cf., for example, Troast, D. et al., Org. Lett. 4 (6), 991-994 (2002); Ewing W. et al., Tetrahedron Lett., 30 (29), 3757-3760 (1989); Paulsen, H. et al., Liebigs Ann. Chem. 565 (1987)].

Suitable solvents are aliphatic hydrocarbons, such as pentane, hexane, cyclohexane and mixtures of C₅-C₈-alkanes, aromatic hydrocarbons, such as toluene, o-, m- and p-xylolene, halogenated hydrocarbons, such as methylene chloride, chloroform and chlorobenzene, ethers, such as diethyl ether, diisopropyl ether, tert-butyl methyl ether, dioxane, anisole and tetrahydrofuran, nitriles, such as acetonitrile and propionitrile, ketones, such as acetone, methyl ethyl ketone, diethyl ketone and tert-butyl methyl ketone, alcohols, such as methanol, ethanol, n-propanol, isopropanol, n-butanol and tert-butanol, and also dimethyl sulfoxide, dimethylformamide and dimethylacetamide, particularly preferably dichloromethane, tert-butyl methyl ether, dioxane and tetrahydrofuran.

It is also possible to use mixtures of the solvents mentioned.

Suitable bases are, in general, inorganic compounds, such as alkali metal and alkaline earth metal hydroxides, such as lithium hydroxide, sodium hydroxide, potassium hydroxide and calcium hydroxide, alkali metal and alkaline earth metal oxides, such as lithium oxide, sodium oxide, calcium oxide and magnesium oxide, alkali metal and alkaline earth metal hydrides, such as lithium hydride, sodium hydride, potassium hydride and calcium hydride, alkali metal amides such as lithium amide, sodium amide and potassium amide, alkali metal and alkaline earth metal carbonates, such as lithium carbonate, potassium carbonate and calcium carbonate, and also alkali metal bicarbonates, such as sodium bicarbonate, organometallic compounds, in particular alkali metal alkyls, such as methyllithium, butyllithium and phenyllithium, alkylmagnesium halides, such as methylmagnesium chloride, and also alkali metal and alkaline earth metal alkoxides, such as sodium methoxide, sodium ethoxide, potassium ethoxide, potassium tert-butoxide, potassium tert-pentoxide and dimethoxymagnesium, moreover organic bases, for example tertiary amines, such as trimethylamine, triethylamine, diisopropylethylamine and N-methylpiperidine, pyridine, substituted pyridines, such as collidine, lutidine and 4-dimethylaminopyridine, and also bicyclic amines. Particular preference is given to sodium hydroxide, sodium hydride and triethylamine.

The bases are generally employed in equimolar amounts; however, they can also be employed catalytically, in excess or, if appropriate, as solvents.

The starting materials are generally reacted with one another in equimolar amounts. It may be advantageous to use an excess of base and/or IX, based on III or 1.

Work-up and isolation of the products can be carried out in a manner known per se.

The required compounds of the formula VIII are commercially available.

Process C

Heteroaroyl derivatives of the formula III where R⁴=hydroxyl can also be obtained by initially acylating aminomalonyl compounds of the formula XI with heteroarylcarboxylic acids or heteroarylcarboxylic acid derivatives of the formula IV to give the corresponding N-acylaminomalonyl compounds of the formula X, followed by condensation with a heterocyclylcarbonyl compound of the formula VII with decarboxylation:

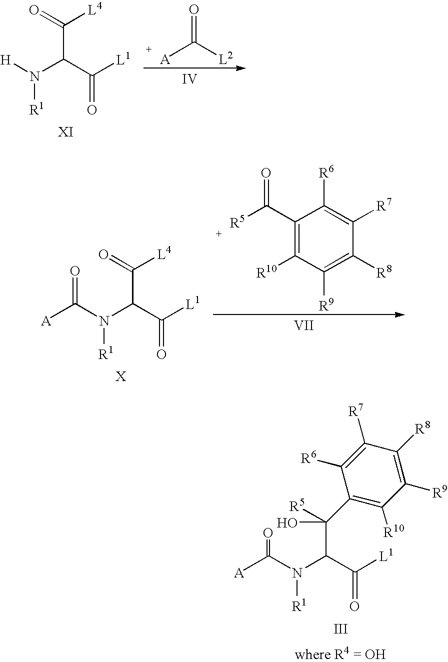

L¹ is a nucleophilically displaceable leaving group, for example hydroxyl or C₁-C₆-alkoxy.

L² is a nucleophilically displaceable leaving group, for example hydroxyl, halogen, C₁-C₆-alkylcarbonyl, C₁-C₆-alkoxycarbonyl, C₁-C₆-alkylsulfonyl, phosphoryl or isoureyl.

L⁴ is a nucelophilically displaceable leaving group, for example hydroxyl, or C₁-C₆-alkoxy.

The acylation of the aminomalonyl compounds of the formula XI with heteroarylcarboxylic acids or heteroarylcarboxylic acid derivatives of the formula IV to give the corresponding N-acylaminomalonyl compounds of the formula X is usually carried out analogously to the reaction, mentioned in process A, of the phenylalanines of the formula V with heteroarylcarboxylic acids or heteroarylcarboxylic acid derivatives of the formula IV to give the corresponding heteroaroyl derivatives of the formula III.

The reaction of the N-acylaminomalonyl compounds of the formula X with heterocyclylcarbonyl compounds of the formula VII to give heteroaroyl derivatives of the formula III where R⁴=hydroxyl is usually carried out at temperatures of from 0° C. to 100° C., preferably from 10° C. to 50° C., in an inert organic solvent in the presence of a base [cf., for example U.S. Pat. No. 4,904,674; Hellmann, H. et al., Liebigs Ann. Chem. 631, 175-179 (1960)]

If L⁴ in the N-acylaminomalonyl compounds of the formula X is C₁-C₆-alkoxy, it is advantageous to initially convert L⁴ by ester hydrolysis [for example Hellmann, H. et al., Liebigs Ann. Chem. 631, 175-179 (1960)] into a hydroxyl group.

Suitable solvents are aliphatic hydrocarbons, such as pentane, hexane, cyclohexane and mixtures of C₅-C₈-alkanes, aromatic hydrocarbons, such as toluene, o-, m- and p-xylene, halogenated hydrocarbons, such as methylene chloride, chloroform and chlorobenzene, ethers, such as diethyl ether, diisopropyl ether, tert-butyl methyl ether, dioxane, anisole and tetrahydrofuran, nitriles, such as acetonitrile and propionitrile, ketones, such as acetone, methyl ethyl ketone, diethyl ketone and tert-butyl methyl ketone, alcohols, such as methanol, ethanol, n-propanol, isopropanol, n-butanol and tert-butanol, and also dimethyl sulfoxide, dimethylformamide and dimethylacetamide, particularly preferably diethyl ether, dioxane and tetrahydrofuran.

It is also possible to use mixtures of the solvents mentioned.

Suitable bases are, in general, inorganic compounds, such as alkali metal and alkaline earth metal hydroxides, such as lithium hydroxide, sodium hydroxide, potassium hydroxide and calcium hydroxide, alkali metal and alkaline earth metal oxides, such as lithium oxide, sodium oxide, calcium oxide and magnesium oxide, alkali metal and alkaline earth metal hydrides, such as lithium hydride, sodium hydride, potassium hydride and calcium hydride, alkali metal amides, such as lithium amide, sodium amide and potassium amide, alkali metal and alkaline earth metal carbonates, such lithium carbonate, potassium carbonate and calcium carbonate, and also alkali metal bicarbonates, such as sodium bicarbonate, organometallic compounds, in particular alkali metal alkyls, such as methyllithium, butyllithium and phenyllithium, alkylmagnesium halides, such as methylmagnesium chloride, and also alkali metal and alkaline earth metal alkoxides, such as sodium methoxide, sodium ethoxide, potassium ethoxide, potassium tert-butoxide, potassium tert-pentoxide and dimethoxymagnesium, moreover organic bases, for example tertiary amines, such as trimethylamine, triethylamine, diisopropylethylamine and N-methylpiperidine, pyridine, substituted pyridines, such as collidine, lubdine and 4-dimethylaminopyridine, and also bicyclic amines. Particular preference is given to triethylamine and diisopropylethylamine.

The bases are generally employed in catalytic amounts; however, they can also be used in equimolar amounts, in excess or, if appropriate, as solvents.

The starting materials are generally reacted with one another in equimolar amounts. It may be advantageous to employ an excess of base, based on X.

Work-up and isolation of the products can be carried out in a manner known per se.

According to process A or B mentioned above, the resulting heteroaroyl derivatives of the formula III where R⁴=hydroxyl can then be converted into the desired heteroaroyl-substituted phenylalanineamides of the formula I where R⁴=OR¹¹.

The required aminomalonyl compounds of the formula XI are commercially available and/or known from the literature [for example U.S. Pat. No. 4,904,674; Hellmann, H. et al., Liebigs Ann. Chem. 631, 175-179 (1960)], or they can be prepared in accordance with the literature cited.

The required heterocyclic compounds of the formula VII are commercially available.

Process D

Heteroaroyl derivatives of the formula III where R⁴=hydroxyl and R⁵=hydrogen can also be obtained by initially acylating keto compounds of the formula XIII with heteroarylcarboxylic acids or heteroarylcarboxylic acid derivatives of the formula IV to give the corresponding N-acyl keto compounds of the formula XII, followed by reduction of the keto group [Girard A, Tetrahedron Lett. 37(44), 7967-7970(1996); Nojori R., J. Am. Chem. Soc. 111 (25), 9134-9135(1989); Schmidt U., Synthesis (12), 1248-1254 (1992); Bolhofer, A.; J. Am. Chem. Soc. 75, 4469 (1953)]:

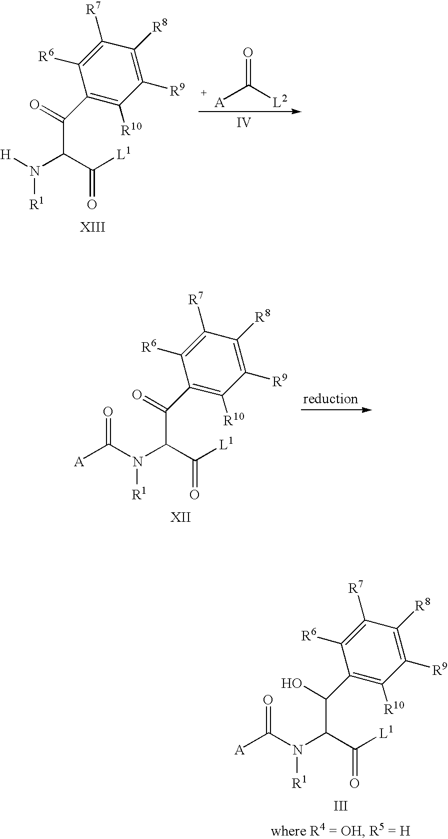

L¹ is a nucleophilically displaceable leaving group, for example hydroxyl or C₁-C₆-alkoxy.

L² is a nucleophilically displaceable leaving group, for example hydroxyl, halogen, C₁-C₆-alkylcarbonyl, C₁-C₆-alkoxycarbonyl, C₁-C₆-alkylsulfonyl, phosphoryl or isoureyl.

The acylation of the keto compounds of the formula XIII with heteroarylcarboxylic acids or heteroarylcarboxylic acid derivatives of the formula IV to give N-acyl keto compounds of the formula XII is usually carried out analogously to the reaction, mentioned in process A, of the phenylalanines of the formula V with heteroarylcarboxylic acids or heteroarylcarboxylic acid derivatives of the formula IV to give the corresponding heteroaroyl derivatives of the formula III.

The keto compounds of the formula XIII required for preparing the heteroaroyl derivatives of the formula III where R⁴=hydroxyl and R⁵=hydrogen are known from the literature [WO 02/083111; Boto, A. et al., Tetrahedron Letters 39 (44), 8167-8170 (1988); von Geldem, T. et al., J. of Med. Chem. 39(4), 957-967 (1996); Singh, J. et al., Tetrahedron Letters 34 (2), 211-214 (1993); ES 2021557; Maeda, S: et al., Chem. & Pharm. Bull. 32 (7), 2536-2543 (1984); Ito, S. et al., J. of Biol. Chem. 256 (15), 7834-4783 (1981); Vinograd, L. et al., Zhurnal Organicheskoi Khimii 16 (12), 2594-2599 (1980); Castro, A. et al., J. Org. Chem. 35 (8), 2815-2816 (1970); JP 02-172956; Suzuki, M. et al., J. Org. Chem. 38 (20), 3571-3575 (1973); Suzuki, M. et al, Synthetic Communications 2 (4), 237-242 (1972)] or can be prepared according to the literature cited.

The reduction of N-acyl keto compounds of the formula XII to heteroaroyl derivatives of the formula III where R⁴=hydroxyl and R⁵=hydrogen is usually carried out at temperatures of from 0° C. to 100° C., preferably from 20° C. to 80° C., in an inert organic solvent in the presence of a reducing agent.

Suitable solvents are aliphatic hydrocarbons, such as pentane, hexane, cyclohexane and mixtures of C₅-C₈-alkanes, aromatic hydrocarbons, such as, toluene o-, m- and p-xylene, halogenated hydrocarbons, such as methylene chloride, chloroform and chlorobenzene, ethers, such as diethyl ether, diisopropyl ether, tert-butyl methyl ether, dioxane, anisole and tetrahydrofuran, nitriles, such as acetonitrile and propionitrile, ketones, such as acetone, methyl ethyl ketone, diethyl ketone and tert-butyl methyl ketone, alcohols, such as methanol, ethanol, n-propanol, isopropanol, n-butanol and tert-butanol, and also dimethyl sulfoxide, dimethylformamide and dimethylacetamide, particularly preferably toluene, methylene chloride or tert-butyl methyl ether.

It is also possible to use mixtures of the solvents mentioned.

Suitable reducing agents are, for example, sodium borohydride, zinc borohydride, sodium cyanoborohydride, lithium triethylborohydride (Superhydrid®)), lithium tri-sec-butylborohydride (L-Selectrid®), lithium aluminum hydride or borane [cf., for example, WO 00/20424; Marchi, C. et al., Tetrahedron 58 (28), 5699 (2002); Blank, S. et al., Liebigs Ann. Chem. (8), 889-896 (1993); Kuwano, R. et al., J. Org Chem. 63 (10), 3499-3503 (1998); Clariana, J. et al., Tetrahedron 55 (23), 7331-7344 (1999)).

Furthermore, the reduction can also be carried out in the presence of hydrogen and a catalyst. Suitable catalysts are, for example, [Ru(BINAP)Cl₂] or Pd/C [cf. Noyori, R. et al., J. Am. Chem. Soc. 111 (25), 9134-9135 (1989); Bolhofer, A. et al., J. Am. Chem. Soc. 75, 4469 (1953)].

In addition, the reduction can also be carried out in the presence of a microorganism. A suitable microorganism is, for example, Saccharomyces Rouxii [cf. Soukup, M. et al., Helv. Chim. Acta 70, 232 (1987)].

The N-acyl keto compounds of the formula XII and the reducing agent in question are generally reacted with one another in equimolar amounts. It may be advantageous to employ an excess of reducing agent, based on XII.

Work-up and isolation of the products can be carried out in a manner known per se.

The resulting heteroaroyl derivatives of the formula III where R⁴=hydroxyl and R⁵=hydrogen can then, according to the processes A and B mentioned above, be converted into the desired heteroaroyl-substituted phenylalanineamides of the formula I where R⁴=OR¹¹.

The present invention also provides heteroaroyl derivatives of the formula III 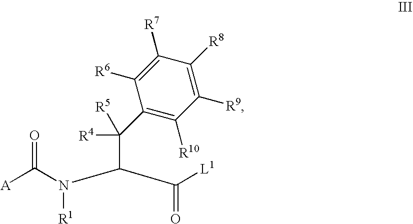
in which A, R¹ and R⁴ to R¹⁰ are as defined in claim 1 and L¹ is a nucleophilically displaceable leaving group, e.g. hydroxyl or C₁-C₆-alkoxy.

The particularly preferred embodiments of the intermediates with respect to the variables correspond to those of the radicals A, R¹ and R⁴ to R¹⁰ of formula I.

Particularly preferred are heteroaroyl derivatives of the formula III in which
A is 5- or 6-membered heteroaryl selected from the group consisting of thienyl, furyl, pyrazolyl, imidazolyl, thiazolyl, oxazolyl and pyridyl; where the heteroaryl radicals mentioned may be partially or fully halogenated and/or may carry 1 to 3 radicals from the group consisting of C₁-C₆-alkyl, C₃-C₆-cycloalkyl, and C₁-C₆-haloalkyl;
R¹ is hydrogen;
R⁴ is hydrogen, C₁-C₄-alkyl, C₁-C₄-haloalkyl, OR¹¹, SR¹² or NR¹³R¹⁴;
R⁵ is hydrogen;
R⁶ is hydrogen, fluorine or CH₃;
R⁷ is hydrogen, fluorine or chlorine;
R⁸, R⁹ and R¹⁰ are hydrogen;
R¹¹ and R¹³ independently of one another are hydrogen, C₁-C₄-alkylcarbonyl, C₁-C₄-alkylaminocarbonyl, di-(C₁-C₄-alkyl)-aminocarbonyl, phenylaminocarbonyl, N—(C₁-C₄-alkyl)-N-(phenyl)-aminocarbonyl, SO₂CH₃ or SO₂(C₆H₅);
R¹² is hydrogen, C₁-C₄-alkylcarbonyl, C₁-C₄-alkylaminocarbonyl, di-(C₁-C₄-alkyl)-aminocarbonyl, phenylaminocarbonyl, N—(C₁-C₄-alkyl)-N-(phenyl)aminocarbonyl; and
R¹⁴ is hydrogen or C₁-C₄-alkyl.

Particularly preferred are also heteroaroyl derivatives of the formula III in which
A C-linked pyrazolyl is selected from the group consisting of A1 to A4 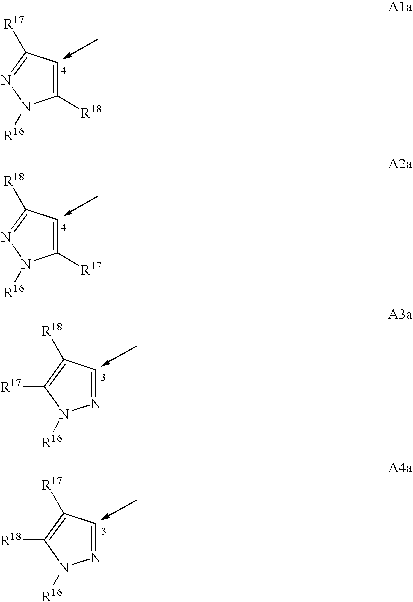
   where the arrow indicates the point of attachment and
   R¹⁶ is C₁-C₆-alkyl, C₃-C₆-cycloalkyl, C₁-C₆-haloalkyl or C₁-C₆-alkoxy-C₁-C₄-alkyl;
      particularly preferably C₁-C₄-alkyl, C₃-C₆-cycloalkyl, C₁-C₄-haloalkyl or C₁-C₄-alkoxy-C₁-C₄-alkyl;
      especially preferably C₁-C₄-alkyl or C₁-C₄-haloalkyl;
      with extraordinary preference C₁-C₄-alkyl;
      with very extraordinary preference CH₃;
   R¹⁷ is hydrogen, halogen, C₁-C₆-alkyl or C₁-C₆-haloalkyl;
      particularly preferably hydrogen, C₁-C₄-alkyl or C₁-C₄-haloalkyl;
      especially preferably hydrogen or C₁-C₄-alkyl;
      with extraordinary preference hydrogen; and
   R¹⁸ is halogen, C₁-C₆-alkyl or C₁-C₆-haloalkyl;
      particularly preferably halogen, C₁-C₄-alkyl or C₁-C₄-haloalkyl;
      especially preferably C₁-C₄-haloalkyl;
      with extraordinary preference CF₃;
   particularly preferably A1a, A2a, or A3a, where R¹⁶ to R¹⁸ are as defined above;
   with extraordinary preference A1a or A2a, where R¹⁶ to R¹⁸ are as defined above;
R¹ is hydrogen;
R⁴ is hydrogen, C₁-C₄-alkyl, C₁-C₄-haloalkyl, OR¹¹, SR¹² or NR¹³R¹⁴;
R⁵ is hydrogen;
R⁶ is hydrogen, fluorine or CH₃;
R⁷ is hydrogen, fluorine or chlorine;
R⁸, R⁹ and R¹⁰ are hydrogen;
R¹¹ and R¹³ independently of one another are hydrogen, C₁-C₄-alkylcarbonyl, C₁-C₄-alkylaminocarbonyl, di(C₁-C₄-alkyl)aminocarbonyl, phenylaminocarbonyl, N—(C₁-C₄-alkyl)-N-(phenyl)aminocarbonyl, SO₂CH₃ or SO₂(C₆H₅);
R¹² is hydrogen, C₁-C₄-alkylcarbonyl, C₁-C₄-alkylaminocarbonyl, di(C₁-C₄-alkyl)aminocarbonyl, phenylaminocarbonyl, N—(C₁-C₄-alkyl)-N-(phenyl)aminocarbonyl; and
R¹⁴ is hydrogen or C₁-C₄-alkyl.

### EXAMPLE 1

### 2-Methylcarbamoyl-2-[(1-methyl-3-trifluoromethyl-1H-pyrazole-4-carbonyl)amino]-1-phenylethyl 2,2-dimethylpropionate (Tab. 4, No. 4.15)

1.1) 3-Hydroxy-2-[(1-methyl-3-trifluoromethyl-1H-pyrazole-4-carbonyl)amino]-3-phenylpropionic acid

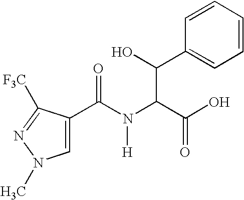

10.0 g (55.2 mmol) of DL-threo-3-phenylserine hydrate were added to a solution of 1.1 g (27.6 mmol) of NaOH in water. Simultaneously, 3.3 g (83 mmol) of NaOH in water and 11.7 g (55 mmol) of 1-methyl-3-trifluoromethyl-1H-pyrazole-4-carbonyl chloride were added dropwise to this mixture, so that the solution remained slightly alkaline and the temperature did not exceed 30° C. The resulting solution was stirred at RT for 48 h, and 75 ml of concentrated hydrochloric acid were then added dropwise with ice-cooling. The resulting precipitate was filtered off with suction, washed and dried. This gave 15.7 g of the title compound as colorless crystals.

¹H-NMR (DMSO): δ=8.50 (s, 1H); 7.95 (d, 1H); 7.1-7.5 (m, 5H); 5.25 (d, 1H); 4.70 (dd, 1H); 3.95 (s, 3H).
1.2) N-(2-Hydroxy-1-methylcarbamoyl-2-phenylethyl)-1-methyl-3-trifluoromethyl-1H-pyrazole-4-carboxamide

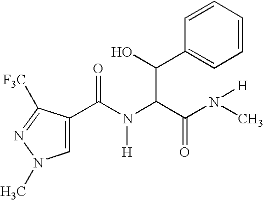

15.7 g (43.8 mmol) of 3-hydroxy-2-[(1-methyl-3-trifluoromethyl-1H-pyrazole-4-carbonyl)amino]-3-phenylpropionic acid were dissolved in THF. At −20° C., 8.9 g (87.7 mmol) of N-methylmorpholine, dissolved in THF, and then 12.0 g (87.7 mmol) of isobutyl chloroformate, dissolved in THF, were added. The mixture was stirred for another 10 min, and 34.0 g (438 mmol) of a 40% strength solution of methylamine in water were then added dropwise. After 2 h at −20° C., 100 ml of a 5% strength solution of NaHCO₃ were added dropwise, and the mixture was stirred at RT for 30 min. The precipitate was filtered off, washed and dried. This gave 13.1 g of the title compound as colorless crystals.

¹H-NMR (DMSO): δ=8.50 (s, 1H); 7.2-7.9 (m, 7H); 6.75 (brs, 1H); 5.15 (brs, 1H); 4.55 (dd, 1H); 4.00 (s, 3H); 2.60 (d, 3H).
1.3) 2-Methylcarbamoyl-2-[(1-methyl-3-trifluoromethyl-1H-pyrazole-4-carbonyl)amino]-1-phenylethyl 2,2-dimethylpropionate (Tab. 4, No. 4.15)

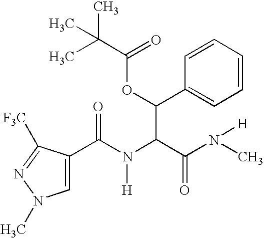

0.5 g (1.35 mmol) of N-(2-hydroxy-1-methylcarbamoyl-2-phenylethyl)-1-methyl-3-trifluoromethyl-1H-pyrazole-4-carboxamide was dissolved in pyridine. At RT, 0.20 g (1.71 mmol) of pivaloyl chloride was then added dropwise, and a spatula tip of 4-dimethylaminopyridine was added. After 24 h at RT, another 0.06 g of pivaloyl chloride was added, and the mixture was stirred at RT for 3 h. Ice was added, and the mixture was acidified with 10% strength hydrochloric acid and extracted with methylene chloride. The organic phase was washed, dried and concentrated. Chromatographic purification (silica gel column, cyclohexane/ethyl acetate) gave 183 mg of the title compound as colorless crystals.

¹H-NMR (DMSO): δ=8.50 (s, 1H); 8.35 (d, 1H); 8.0 (q, 1H); 7.2-7.5 (m, 5H); 6.0 (d, 1H); 5.0 (q, 1H); 4.0 (s, 3H); 2.55 (d, 3H); 1.20 (s, 9H).

### EXAMPLE 2

### N-[2-(benzylformylamino)-1-methylcarbamoyl-2-phenylethyl]-1-methyl-3-trifluoromethyl-1H-pyrazole-4-carboxamide (Tab. 4, No. 4.23)

2.1) Ethyl 1-benzyl-5-phenyl-4,5-dihydro-1H-imidazole-4-carboxylate

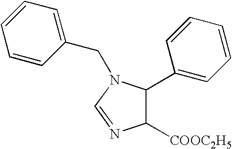

25.7 g (0.1305 mol) of benzylidenebenzylamine were dissolved in ethanol, and 15.2 g (0.1305 mol) of ethyl isocyanoacetate were added dropwise. The solution was heated under reflux for 16 h. Removal of the solvent and drying gave 40.2 g of the title compound as a colorless oil.

¹H-NMR (DMSO): δ=7.1-7.4 (m, 1H); 4.6 (d, 1H); 4.5 (d, 1H); 4.3 (d, 1H); 4.1 (q, 2H); 3.8 (d, 1H); 1.1 (t, 3H).
2.2) 2-Amino-3-(benzylformylamino)-3-phenylpropionic acid

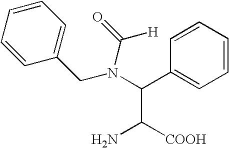

14.8 g (0.048 mol) of ethyl 1-benzyl-5-phenyl-4,5-dihydro-1H-imidazole-4-carboxylate were heated under reflux in a 47% strength HBr solution for 3 h. The solvents were removed and the residue was triturated with water and filtered. The solvents were removed and the residue was taken up in ethanol and diluted with diethyl ether. The suspension was filtered and the solvents were removed. This gave 14.0 g of the title compound which was used without further purification for the next step.
2.3) Methyl 2-amino-3-(benzylformylamino)-3-phenylpropionate

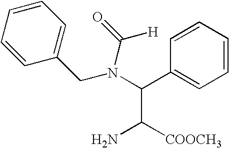

13.5 g (0.04 mol) of 2-amino-3-(benzylformylamino)-3-phenylpropionic acid were dissolved in methanol, and 7.1 g (0.06 mol) of thionyl chloride and 1 drop of DMF were added dropwise. After 20 hours, the solvents were removed, the residue was suspended in diethyl ether and a 5% strength solution of NaHCO₃ was added with stirring. The organic phase was removed, washed and dried. Removal of the solvents gave 4.0 g of the title compound as a colorless oil which was reacted further without further purification.
2.4) Methyl 3-(benzylformylamino)₂-[(1-methyl-3-trifluoromethyl-1H-pyrazole-4-carbonyl)amino]-3-phenylpropionate

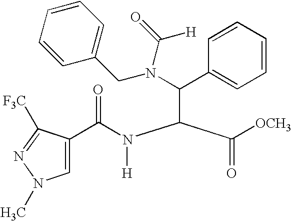

2.3 g (0.0075 mol) of methyl 2-amino-3-(benzylformylamino)-3-phenylpropionate were dissolved in methylene chloride. 1.46 g (0.0075 mol) of 1-methyl-3-trifluoromethyl-1H-pyrazole-4-carboxylic acid and 1.52 g (0.015 mol) of triethylamine in THF were added. At 0-5° C., 1.78 g (0.0075 mol) of bis(2-oxo-3-oxazolidinyl)phosphoryl chloride were then added. After 3 h at 0° C., the mixture was stirred at room temperature for 15 h. The solvents were removed and the residue was taken up in methylene chloride, washed and dried. Removal of the solvents and chromatographic purification (silica gel column, cyclohexane/ethyl acetate) gave 3.0 g of the title compound as a colorless oil.

¹H-NMR (DMSO): δ=9.10 (d, 1H); 8.51 (s, 1H); 8.38 (s, 1H); 6.8-7.4 (m, 1H); 5.50 (t, 1H); 5.15 (d, 1H); 4.40 (d, 1H); 4.30 (d, 1H); 3.95 (s, 3H); 3.80 (s, 3H).
2.5) N-[2-(benzylformylamino)-1-methylcarbamoyl-2-phenylethyl]-1-methyl-3-trifluoromethyl-1H-pyrazole-4-carboxamide (Tab. 4, No. 4.23)

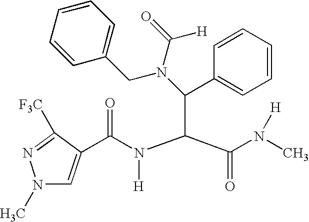

2.4 g (0.0049 mol) of methyl 3-(benzylformylamino)-2-[(1-methyl-3-trifluoromethyl-1H-pyrazole-4-carbonyl)amino]-3-phenylpropionate were dissolved in methanol. At 0° C., methylamine gas was introduced. After 1 h, the mixture was warmed to RT for 0.5 h. The solvents were removed and the residue was washed with a little methanol and n-hexane. This gave 980 g of the title compound as colorless crystals.

¹H-NMR (DMSO): δ=8.80 (d, 1H); 8.51 (s, 1H); 8.40 (s, 1H); 8.38 (m, 1H); 6.7-7.4 (m, 10H); 5.50 (t, 1H); 5.07 (d, 1H); 4.45 (d, 1H); 4.15 (d, 1H); 3.95 (s, 3H); 2.35 (d, 3H).

### EXAMPLE 3

### 3-Chloro-2-trifluoromethylbenzoic acid

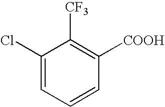

1.03 g (42.4 mmol) of magnesium turnings were dissolved in THF. 2 drops of 1,2-dibromomethane were added, and the reaction mixture was, after the exothermal reaction had set in, stirred at 32-35° C. with ice-cooling. 10.0 g (38.5 mmol) of 1-bromo-3-chloro-2-trifluoromethylbenzene in THF were then added dropwise such that the temperature did not exceed 32° C. The mixture was stirred for another 30 min and cooled to 0° C., and carbon dioxide was introduced over a period of 2 h. The mixture was then warmed to room temperature, and CO₂ was introduced for a further hour. The solution was poured into a mixture of 1 M hydrochloric acid and ice and extracted with methyl tert-butyl ether. The organic phase was then extracted with 1 M NaOH and the aqueous phase was acidified with concentrated hydrochloric acid and extracted with methylene chloride.

Drying and distillative removal of the solvent gave 7.7 g (84% of theory) of the title compound as colorless crystals (m.p. 110° C.).

In addition to the above compounds, further heteroaroyl derivatives of the formula III and heteroaroyl-substituted phenylalanineamides of the formula I which were prepared or are preparable in a manner similar to the processes described above are listed in Tables 2, 3, 4 and 5 below.

TABLE 2

| | |
|---|---|
| | III |
| 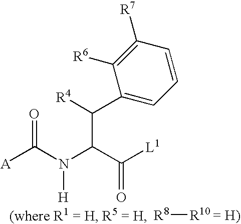 | |

| | | | | | | | | erythro/ | Confi- | m.p. [° C.] |
|---|---|---|---|---|---|---|---|---|---|---|
| No. | A | R⁴ | R⁶ | R⁷ | R⁸ | R⁹ | L¹ | threo | guration | or m/z |
| 2.1 | 1-CH₃-3-CF₃-4-pyrazolyl | OH | H | H | H | H | OC₂H₅ | erythro | rac | 127 |
| 2.2 | 2-CF₃-3-thienyl | OH | H | H | H | H | OCH₃ | threo | rac | m/z 373 |
| 2.3 | 3-CF₃-4-thienyl | OH | CH₃ | F | H | H | OH | threo | rac | m/z 359 |
| 2.4 | 3-CF₃-4-thienyl | OH | CH₃ | F | H | H | OCH₃ | threo | rac | 110 |
| 2.5 | 5-CH₃-2-CF₃-3-furyl | OH | H | H | H | H | OCH₃ | threo | rac | m/z 371 |
| 2.6 | 1-CH₃-3-CF₃-4-pyrazolyl | OH | H | H | H | H | OCH₃ | threo | rac | m/z 371 |
| 2.7 | 1-CH₃-3-CF₃-4-pyrazolyl | OH | CH₃ | F | H | H | OC₂H₅ | erythro | rac | m/z 417 |
| 2.8 | 1-CH₃-3-CF₃-4-pyrazolyl | OH | H | F | F | H | OC₂H₅ | erythro | rac | m/z 421 |
| 2.9 | 1-CH₃-3-CF₃-4-pyrazolyl | OH | H | F | F | F | OC₂H₅ | erythro | rac | m/z 439 |
| 2.10 | 1-CH(CH₃)₂-3-CF₃-4-pyrazolyl | OH | H | H | H | H | OCH₃ | threo | rac | m/z 399 |
| 2.11 | 1-CH₂CHCH₂-3-CF₃-4-pyrazolyl | OH | H | H | H | H | OCH₃ | threo | rac | m/z 397 |
| 2.12 | 1-CH₃-3-CF₃-5-F-4-pyrazolyl | OH | H | H | H | H | OCH₃ | threo | rac | m/z 389 |
| 2.13 | 1-CH₃-5-CHF₂-4-pyrazolyl | OH | H | H | H | H | OCH₃ | threo | rac | m/z 353 |
| 2.14 | 1-CH₃-5-CF₃-4-pyrazolyl | OH | H | H | H | H | OCH₃ | threo | rac | m/z 371 |
| 2.15 | 1-CH₂CH₃-5-CF₃-4-pyrazolyl | OH | H | H | H | H | OCH₃ | threo | rac | m/z 385 |
| 2.16 | 1-CH₂CF₃-5-CF₃-4-pyrazolyl | OH | H | H | H | H | OCH₃ | threo | rac | m/z 439 |
| 2.17 | 2-CF₃-3-pyridyl | OH | H | H | H | H | OCH₃ | threo | rac | m/z 368 |
| 2.18 | 3-CF₃-4-pyridyl | OH | H | H | H | H | OCH₃ | threo | rac | m/z 368 |

TABLE 3

| | |
|---|---|
| | I |
| 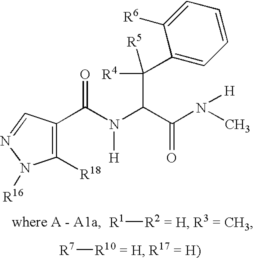 | |

| | | | | | | | erythro/ | Configu- | |
|---|---|---|---|---|---|---|---|---|---|
| No. | R⁴ | R⁵ | R⁶ | R¹⁶ | R¹⁷ | R¹⁸ | threo | ration | m.p. |
| 3.1 | H | H | H | CH₂CH₃ | H | CF₃ | — | 2S | 150 |
| 3.2 | H | H | H | CH₃ | H | CF₃ | — | 2S | 158 |

TABLE 4

| | |
|---|---|
| | I |
| 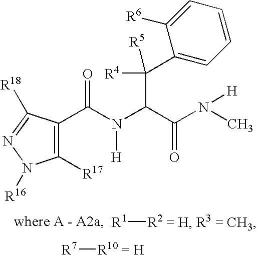 | |

| | | | | | | | erythro/ | Configu- | |
|---|---|---|---|---|---|---|---|---|---|
| No. | R⁴ | R⁵ | R⁶ | R¹⁶ | R¹⁷ | R¹⁸ | threo | ration | m.p. |
| 4.1 | H | H | H | CH₃ | H | CF₃ | — | 2S | 175 |
| 4.2 | H | H | H | CH₃ | H | CHFCH₃ | — | 2S | 71 |
| 4.3 | H | H | F | CH₃ | H | CF₃ | — | rac. | 212 |
| 4.4 | H | H | F | CH₃ | Cl | CH₃ | — | rac. | 152 |
| 4.5 | H | H | CH₃ | CH₃ | H | CF₃ | — | rac. | 240 |
| 4.6 | CH₃ | H | CH₃ | CH₃ | H | CF₃ | 1:1 | rac. | 232 |
| 4.7 | CH₃ | H | F | CH₃ | H | CF₃ | 1:1 | rac. | 185 |
| 4.8 | OH | H | H | CH₃ | H | CF₃ | erythro | rac. | oil |
| 4.9 | OH | H | H | CH₃ | H | CF₃ | threo | rac. | 216 |
| 4.10 | OH | H | H | CH₂CH₃ | H | CF₃ | threo | rac. | oil |
| 4.11 | OH | CH₃ | H | CH₃ | H | CF₃ | threo | rac. | 153 |
| 4.12 | OCOCH₃ | H | H | CH₃ | H | CF₃ | threo | rac. | oil |
| 4.13 | OCOCH(CH₃)₂ | H | H | CH₃ | H | CF₃ | threo | rac. | 185 |
| 4.14 | OCOCH(CH₂CH₃)₂ | H | H | CH₃ | H | CF₃ | threo | rac. | 178 |
| 4.15 | OCOC(CH₃)₃ | H | H | CH₃ | H | CF₃ | threo | rac. | 158 |
| 4.16 | OCOOCH₂CH(CH₃)₂ | H | H | CH₃ | H | CF₃ | threo | rac. | oil |
| 4.17 | OCON(CH₃)₂ | H | H | CH₃ | H | CF₃ | threo | rac. | 196 |
| 4.18 | OCON-Morpholinyl | H | H | CH₃ | H | CF₃ | threo | rac. | 175 |
| 4.19 | OCON(CH₃)(C₆H₅) | H | H | CH₃ | H | CF₃ | threo | rac. | 115 |
| 4.20 | OCONH(m-CN—C₆H₄) | H | H | CH₃ | H | CF₃ | threo | rac. | 143 |
| 4.21 | OCONH(m-Cl—C₆H₄) | H | H | CH₃ | H | CF₃ | threo | rac. | 105 |
| 4.22 | OSO₂CH₃ | H | H | CH₃ | H | CF₃ | threo | rac. | 132 |
| 4.23 | N(CHO)(CH₂C₆H₅₎ | H | H | CH₃ | H | CF₃ | 1:1 | rac. | oil |
| 4.24 | OH | H | H | CH₃ | NHCH₃ | CF₃ | threo | rac. | 183 |

TABLE 5

| | |
|---|---|
| | I |
| 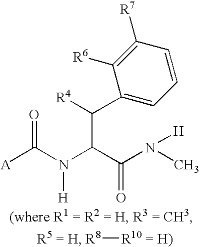 | |

| | | | | | erythro/ | Configu- | m.p. [° C.] |
|---|---|---|---|---|---|---|---|
| No. | A | R⁴ | R⁶ | R⁷ | threo | ration | or m/z |
| 5.1 | 1-CH₃-2-pyrrolyl | OH | H | H | threo | rac | m/z 301 |
| 5.2 | 3-CH₃-2-thienyl | OH | H | H | threo | rac | m/z 318 |
| 5.3 | 3-Cl-2-thienyl | OH | H | H | threo | rac | m/z 338 |
| 5.4 | 3-Cl-4-SO₂CH₃-2-thienyl | OH | H | H | threo | rac | m/z 416 |
| 5.5 | 2-CF₃-3-thienyl | OH | H | H | threo | rac | 155 |
| 5.6 | 2-CF₃-3-thienyl | OCOCH₂OCH₃ | H | H | threo | rac | 167 |
| 5.7 | 2-Br-4,5-(CH₃)₂-3-thienyl | OH | H | H | threo | rac | m/z 411 |
| 5.8 | 3-CF₃-4-thienyl | OCON(CH₃)₂ | H | H | threo | rac | 160 |
| 5.9 | 3-CF₃-4-thienyl | OH | CH₃ | F | erythro | rac | 175 |
| 5.10 | 3-CF₃-4-thienyl | OCONHC₆H₅ | CH₃ | F | threo | rac | 188 |
| 5.11 | 3-CF₃-4-thienyl | OCONHSO₂-(2-Cl-C₆H₄) | CH₃ | F | threo | rac | 210 |
| 5.12 | 2,5-(CH₃)₂-3-furyl | OH | H | H | threo | rac | m/z 316 |
| 5.13 | 2,4,5-(CH₃)₃-3-furyl | OH | H | H | threo | rac | m/z 330 |
| 5.14 | 5-CH₃-2-CF₃-3-furyl | OH | H | H | threo | rac | 185 |
| 5.15 | 5-CH₃-2-CF₃-3-furyl | OH | CH₃ | F | threo | 2-S, 3-R | 206 |
| 5.16 | 5-CH₃-2-CF₃-3-furyl | OCON(CH₃)₂ | H | H | threo | rac | 168 |
| 5.17 | 5-C₆H_{5-2-CF}₃-3-furyl | OH | H | H | threo | rac | 190 |
| 5.18 | 4-CH₃-5-thiazolyl | OH | H | H | threo | rac | m/z 319 |
| 5.19 | 2,4-(CH₃)₂-5-thiazolyl | OH | H | H | threo | rac | m/z 333 |
| 5.20 | 2-Cl-3-CH₃-4-pyridyl | OH | H | H | threo | rac | 208 |
| 5.21 | 2-SCH₃-3-pyridyl | OH | H | H | threo | rac | 345 (HCl salt) |
| 5.22 | 2-CF₃-3-pyridyl | OH | H | H | threo | rac | 190 |
| 5.23 | 3-CF₃-4-pyridyl | OH | H | H | threo | rac | oil |
| 5.24 | 2-[2′,2′,2′-(OCF₃)₃]-3-pyridyl | OH | H | H | threo | rac | 397 |

Biological Activity

The pyrazolylcarbonyl-substituted phenylalanineamides of the formula I and their agriculturally useful salts are suitable as herbicides, both in the form of isomer mixtures and in the form of the pure isomers. The herbicidal compositions comprising compounds of the formula I effect very good control of vegetation on non-crop areas, especially at high rates of application. In crops such as wheat, rice, maize, soybeans and cotton they act against broad-leaved weeds and grass weeds without damaging the crop plants substantially. This effect is observed especially at low rates of application.

Depending on the application method in question, the compounds of the formula I, or herbicidal compositions comprising them, can additionally be employed in a further number of crop plants for eliminating undesirable plants. Examples of suitable crops are the following:

Allium cepa, Ananas comosus, Arachis hypogaea, Asparagus officinalis, Beta vulgaris spec. altissima, Beta vulgaris spec. rapa, Brassica napus var. napus, Brassica napus var. napobrassica, Brassica rapa var. silvestris, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N. rustica), Olea europaea, Oryza sativa, Phaseolus lunatus, Phaseolus vulgaris, Picea abies, Pinus spec., Pisum sativum, Prunus avium, Prunus persica, Pyrus communis, Ribes sylvestre, Ricinus communis, Saccharum officinarum, Secale cereale, Solanum tuberosum, Sorghum bicolor (s. vulgare), Theobroma cacao, Trifolium pratense, Triticum aestivum, Triticum durum, Vicia faba, Vitis vinifera and Zea mays.

Moreover, the compounds of the formula I can also be used in crops which tolerate the action of herbicides due to breeding including genetic engineering methods.

The compounds of the formula I, or the herbicidal compositions comprising them, can be employed, for example, in the form of directly sprayable aqueous solutions, powders, suspensions, also highly-concentrated aqueous, oily or other suspensions or dispersions, emulsions, oil dispersions, pastes, dusts, materials for spreading or granules, by means of spraying, atomizing, dusting, spreading or pouring. The use forms depend on the intended purposes; in any case, they should guarantee the finest possible distribution of the active ingredients according to the invention.

The herbicidal compositions comprise a herbicidally active amount of at least one compound of the formula I or of an agriculturally useful salt of I and auxiliaries conventionally used for the formulation of crop protection products.

Suitable inert auxiliaries are essentially:

mineral oil fractions of medium to high boiling point such as kerosene and diesel oil, furthermore coal tar oils and oils of vegetable or animal origin, aliphatic, cyclic and aromatic hydrocarbons, eg. paraffins, tetrahydronaphthalene, alkylated naphthalenes and their derivatives, alkylated benzenes and their derivatives, alcohols such as methanol, ethanol, propanol, butanol and cyclohexanol, ketones such as cyclohexanone, strongly polar solvents, for example amines such as N-methylpyrrolidone and water.

Aqueous use forms can be prepared from emulsion concentrates, suspensions, pastes, wettable powders or water-dispersible granules by adding water. To prepare emulsions, pastes or oil dispersions, the substrates, as such or dissolved in an oil or solvent, can be homogenized in water by means of wetting agent, tackifier, dispersant or emulsifier. However, it is also possible to prepare concentrates composed of active substance, wetting agent, tackifier, dispersant or emulsifier and, if appropriate, solvent or oil, and these concentrates are suitable for dilution with water.

Suitable surfactants (adjuvants) are the alkali metal, alkaline earth metal and ammonium salts of aromatic sulfonic acids, for example ligno-, phenol-, naphthalene- and dibutylnaphthalenesulfonic acid, and of fatty acids, of alkyl- and alkylaryl sulfonates, of alkyl sulfates, lauryl ether sulfates and fatty alcohol sulfates, and salts of sulfated hexa-, hepta- and octadecanols, and of fatty alcohol glycol ether, condensates of sulfonated naphthalene and its derivatives with formaldehyde, condensates of naphthalene, or of the naphthalenesulfonic acids, with phenol and formaldehyde, polyoxyethylene octylphenol ether, ethoxylated isooctyl-, octyl- or nonylphenol, alkylphenyl, tributylphenyl polyglycol ether, alkylaryl polyether alcohols, isotridecyl alcohol, fatty alcohol ethylene oxide condensates, ethoxylated castor oil, polyoxyethylene alkyl ethers or polyoxypropylene alkyl ethers, lauryl alcohol polyglycol ether acetate, sorbitol esters, lignosulfite waste liquors or methylcellulose.

Powders, materials for spreading and dusts can be prepared by mixing or concomitantly grinding the active substances with a solid carrier.

Granules, for example coated granules, impregnated granules and homogeneous granules, can be prepared by binding the active ingredients to solid carriers. Solid carriers are mineral earths such as silicas, silica gels, silicates, talc, kaolin, limestone, lime, chalk, bolus, loess, clay, dolomite, diatomaceous earth, calcium sulfate, magnesium sulfate, magnesium oxide, ground synthetic material, fertilizers such as ammonium sulfate, ammonium phosphate, ammonium nitrate, ureas and products of vegetable origin such as cereal meal, tree bark meal, wood meal and nutshell meal, cellulose powders or other solid carriers.

The concentrations of the compounds of the formula I in the ready-to-use products can be varied within wide ranges. In general, the formulations comprise approximately from 0.001 to 98% by weight, preferably 0.01 to 95% by weight, of at least one active ingredient. The active ingredients are employed in a purity of from 90% to 100%, preferably 95% to 100% (according to NMR spectrum).

The formulation examples below illustrate the preparation of such products:
I. 20 parts by weight of an active ingredient of the formula I are dissolved in a mixture composed of 80 parts by weight of alkylated benzene, 10 parts by weight of the adduct of 8 to 10 mol of ethylene oxide and 1 mol of oleic acid N-monoethanolamide, 5 parts by weight of calcium dodecylbenzenesulfonate and 5 parts by weight of the adduct of 40 mol of ethylene oxide and 1 mol of castor oil. Pouring the solution into 100,000 parts by weight of water and finely distributing it therein gives an aqueous dispersion which comprises 0.02% by weight of the active ingredient of the formula I.
II. 20 parts by weight of an active ingredient of the formula I are dissolved in a mixture composed of 40 parts by weight of cyclohexanone, 30 parts by weight of isobutanol, 20 parts by weight of the adduct of 7 mol of ethylene oxide and 1 mol of isooctylphenol and 10 parts by weight of the adduct of 40 mol of ethylene oxide and 1 mol of castor oil. Pouring the solution into 100,000 parts by weight of water and finely distributing it therein gives an aqueous dispersion which comprises 0.02% by weight of the active ingredient of the formula I.
III. 20 parts by weight of an active ingredient of the formula I are dissolved in a mixture composed of 25 parts by weight of cyclohexanone, 65 parts by weight of a mineral oil fraction of boiling point 210 to 280° C. and 10 parts by weight of the adduct of 40 mol of ethylene oxide and 1 mol of castor oil. Pouring the solution into 100,000 parts by weight of water and finely distributing it therein gives an aqueous dispersion which comprises 0.02% by weight of the active ingredient of the formula I.
IV. 20 parts by weight of an active ingredient of the formula I are mixed thoroughly with 3 parts by weight of sodium diisobutylnaphthalenesulfonate, 17 parts by weight of the sodium salt of a lignosulfonic acid from a sulfite waste liquor and 60 parts by weight of pulverulent silica gel and the mixture is ground in a hammer mill. Finely distributing the mixture in 20,000 parts by weight of water gives a spray mixture which comprises 0.1% by weight of the active ingredient of the formula I.
V. 3 parts by weight of an active ingredient of the formula I are mixed with 97 parts by weight of finely divided kaolin. This gives a dust which comprises 3% by weight of the active ingredient of the formula I.
VI. 20 parts by weight of an active ingredient of the formula I are mixed intimately with 2 parts by weight of calcium dodecylbenzenesulfonate, 8 parts by weight of fatty alcohol polyglycol ether, 2 parts by weight of the sodium salt of a phenol/urea/formaldehyde condensate and 68 parts by weight of a paraffinic mineral oil. This gives a stable oily dispersion.
VII. 1 part by weight of an active ingredient of the formula I is dissolved in a mixture composed of 70 parts by weight of cyclohexanone, 20 parts by weight of ethoxylated isooctylphenol and 10 parts by weight of ethoxylated castor oil. This gives a stable emulsion concentrate.
VIII. 1 part by weight of an active ingredient of the formula I is dissolved in a mixture composed of 80 parts by weight of cyclohexanone and 20 parts by weight of Wettol® EM 31 (=nonionic emulsifier based on ethoxylated castor oil). This gives a stable emulsion concentrate.

The compounds of the formula I, or the herbicidal compositions, can be applied pre- or post-emergence. If the active ingredients are less well tolerated by certain crop plants, application techniques may be used in which the herbicidal compositions are sprayed, with the aid of the spray apparatus, in such a way that they come into as little contact as possible, if any, with the leaves of the sensitive crop plants while reaching the leaves of undesirable plants which grow underneath, or the bare soil (post-directed, lay-by).

Depending on the intended aim of the control measures, the season, the target plants and the growth stage, the application rates of the compound of the formula I are from 0.001 to 3.0, preferably 0.01 to 1.0 kg/ha of active substance (a.s.).

To widen the spectrum of action and to achieve synergistic effects, the pyrazolylcarbonyl-substituted phenylalanineamides of the formula I can be mixed and applied jointly with a large number of representatives of other groups of herbicidally or growth-regulatory active ingredients. Suitable components in mixtures are, for example, 1,2,4-thiadiazoles, 1,3,4-thiadiazoles, amides, aminophosphoric acid and its derivatives, aminotriazoles, anilides, aryloxy-/hetaryloxyalkanic acids and their derivatives, benzoic acid and its derivatives, benzothiadiazinones, 2-(hetaroyl/aroyl)-1,3-cyclohexanediones, hetaryl aryl ketones, benzylisoxazolidinones, meta-CF₃-phenyl derivatives, carbamates, quinolinecarboxylic acid and its derivatives, chloroacetanilides, cyclohexenone oxime ether derivatives, diazines, dichloropropionic acid and its derivatives, dihydrobenzofuranes, dihydrofuran-3-ones, dinitroanilines, dinitrophenols, diphenyl ethers, dipyridyls, halocarboxylic acids and their derivatives, ureas, 3-phenyluracils, imidazoles, imidazolinones, N-phenyl-3,4,5,6-tetrahydrophthalimides, oxadiazoles, oxiranes, phenols, aryloxy- and hetaryloxyphenoxypropionic esters, phenylacetic acid and its derivatives, 2-phenylpropionic acid and its derivatives, pyrazoles, phenylpyrazoles, pyridazines, pyridinecarboxylic acid and its derivatives, pyrimidyl ethers, sulfonamides, sulfonylureas, triazines, triazinones, triazolinones, triazolcarboxamides and uracils.

Moreover, it may be advantageous to apply the compounds of the formula I, alone or in combination with other herbicides, in the form of a mixture with additional other crop protection agents, for example with pesticides or agents for controlling phytopathogenic fungi or bacteria. Also of interest is the mis cibility with mineral salt solutions which are employed for treating nutritional and trace element deficiencies. Non-phytotoxic oils and oil concentrates can also be added.

Use Examples

The herbicidal action of the pyrazolylcarbonyl-substituted phenylalanineamides of the formula I was demonstrated by the following greenhouse experiments:

The culture containers used were plastic flowerpots containing loamy sand with approximately 3.0% of humus as substrate. The seeds of the test plants were sown separately for each species.

For the pre-emergence treatment, the active ingredients, suspended or emulsified in water, were applied directly after sowing by means of finely distributing nozzles. The containers were irrigated gently to promote germination and growth and subsequently covered with transparent plastic hoods until the plants had rooted. This cover caused uniform germination of the test plants unless this was adversely affected by the active ingredients.

For the post-emergence treatment, the test plants were grown to a plant height of from 3 to 15 cm, depending on the plant habit, and only then treated with the active ingredients which had been suspended or emulsified in water. To this end, the test plants were either sown directly and grown in the same containers, or they were first grown separately as seedlings and transplanted into the test containers a few days prior to treatment. The rate of application for the post-emergence treatment was 0.5, 0.25, 0.125 or 0.0625 kg/ha a.s. (active substance).

Depending on the species, the plants were kept at from 10 to 25° C. and 20 to 35° C., respectively. The test period extended over 2 to 4 weeks. During this time, the plants were tended, and their response to the individual treatments was evaluated.

Evaluation was carried out using a scale of from 0 to 100. 100 means no emergence of the plants, or complete destruction of at least the aerial parts, and 0 means no damage or normal course of growth.

The plants used in the greenhouse experiments belonged to the following species:

| Scientific name | Common name |
|---|---|
| Amaranthus retroflexus | pig weed |
| Chenopodium album | lambsquarters |
| Echinocloa crus-galli | cockspur |
| Galium aparine | cleavers harrif |
| Polygonum convolvulus | black bindweed |
| Setaria viridis | green foxtail |

At application rates of 1.0 kg/ha, the compounds 4.6 and 4.14 (Table 4) showed very good post-emergence activity against the unwanted plants pig weed, lambsquarters and green foxtail.

The post-emergence action of compound 4.22 (Table 4) at application rates of 0.5 kg/ha on the weeds pig weed, lambsquarters and green foxtail was very good.

At application rates of 1.0 kg/ha, the compound 5.6 (Table 5), applied by the post-emergence method, also effected very good control of the unwanted plants pig weed, lambsquarters and green foxtail.

Furthermore, at application rates of 1.0 kg/ha, the compound 5.8 (Table 5), applied by the post-emergence method, effected very good control of the harmful plants lambsquarters, cockspur, cleavers harrif, black bindweed and green foxtail.

Compound 5.14 (Table 5), at application rates of 1.0 kg/ha, had very good post-emergence activity against the weeds lambsquarters, cockspur, cleavers harrif and green foxtail.

At application rates of 1.0 kg/ha, compound 5.16 (Table 5) showed very good post-emergence activity against the unwanted plants lambsquarters, cockspur, black bindweed and green foxtail.

Furthermore, compound 5.23 (Table 5), applied by the post-emergence method at applications rates of 1.0 kg/ha, effected very good control of the harmful plants pig weed, lambsquarters, cleavers harrif and green foxtail.

1. A heteroaroyl-substituted phenylalanineamide of the formula I 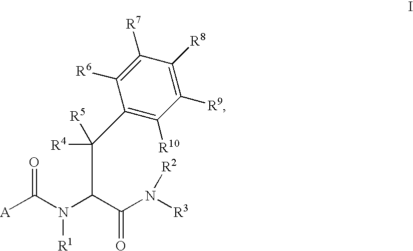
in which the variables are as defined below:
A is C-linked 5- or 6-membered heteroaryl selected from the group A1 to A14 where 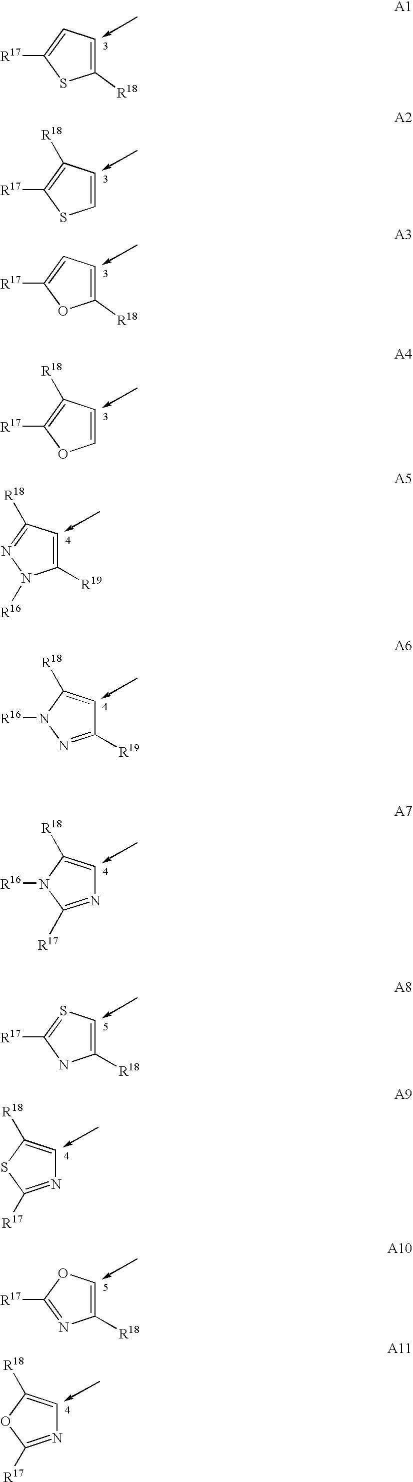
where the arrow indicates the point of attachment and
R¹⁶ is hydrogen, C₁-C₆-alkyl, C₃-C₆-cycloalkyl, C₁-C₆-haloalkyl or C₁-C₆-alkoxy-C₁-C₄-alkyl,
R¹⁷ is hydrogen, halogen, C₁-C₆-alkyl or C₁-C₆-haloalkyl,
R¹⁸ is halogen, C₁-C₆-alkyl, C₁-C₆-haloalkyl or C₁-C₆-haloalkoxy; and
R¹⁹ is hydrogen, halogen, C₁-C₆-alkyl or C₁-C₆-haloalkyl;
R¹, R² are hydrogen, hydroxyl or C₁-C₆-alkoxy;
R³ is C₁-C₆-alkyl or C₁-C₆-haloalkyl;
R⁴ is hydrogen, C₁-C₆-alkyl, C₁-C₆-haloalkyl, OR¹¹, SR¹² or NR¹³R¹⁴;
R⁵ is hydrogen or C₁-C₆-alkyl;
R⁶, R⁷ are hydrogen, halogen, cyano, C₁-C₆-alkyl, C₁-C₆-haloalkyl, hydroxyl, C₁-C₆-alkoxy or C₁-C₆-haloalkoxy;
R⁸, R⁹, R¹⁰ are hydrogen, halogen, cyano, C₁-C₆-alkyl, C₁-C₆-haloalkyl, C₁-C₆-alkoxy or C₁-C₆-haloalkoxy;
R¹¹, R¹², R¹³ are hydrogen, C₁-C₆-alkyl, C₃-C₆-cycloalkyl, C₃-C₆-alkenyl, C₃-C₆-alkynyl, C₃-C₆-haloalkenyl, C₃-C₆-haloalkynyl, formyl, C₁-C₆-alkylcarbonyl, C₃-C₆-cycloalkylcarbonyl, C₂-C₆-alkenylcarbonyl, C₂-C₆-alkynylcarbonyl, C₁-C₆-alkoxycarbonyl, C₃-C₆-alkenyloxycarbonyl, C₃-C₆-alkynyloxycarbonyl, C₁-C₆-alkylaminocarbonyl, C₃-C₆-alkenylaminocarbonyl, C₃-C₆-alkynylaminocarbonyl, C₁-C₆-alkylsulfonylaminocarbonyl, di(C₁-C₆-alkyl)aminocarbonyl, N—(C₃-C₆-alkenyl)-N—(C₁-C₆-alkyl)aminocarbonyl, N—(C₃-C₆-alkynyl)-N—(C₁-C₆-alkyl)aminocarbonyl, N—(C₁-C₆-alkoxy)-N—(C₁-C₆-alkyl)aminocarbonyl, N—(C₃-C₆-alkenyl)-N—(C₁-C₆-alkoxy)aminocarbonyl, N—(C₃-C₆-alkynyl)-N—(C₁-C₆-alkoxy)aminocarbonyl, di(C₁-C₆-alkyl)aminothiocarbonyl, C₁-C₆-alkylcarbonyl-C₁-C₆-alkyl, C₁-C₆-alkoxyimino-C₁-C₆-alkyl, N—(C₁-C₆-alkylamino)imino-C₁-C₆-alkyl or N-(di-C₁-C₆-alkylamino)imino-C₁-C₆-alkyl, where the alkyl, cycloalkyl and alkoxy radicals mentioned may be partially or fully halogenated and/or may carry one to three of the following groups: cyano, hydroxyl, C₃-C₆-cycloalkyl, C₁-C₄-alkoxy, C₁-C₄-alkylthio, di(C₁-C₄-alkyl)amino, C₁-C₄-alkylcarbonyl, hydroxycarbonyl, C₁-C₄-alkoxycarbonyl, aminocarbonyl, C₁-C₄-alkylaminocarbonyl, di(C₁-C₄-alkyl)aminocarbonyl or C₁-C₄-alkylcarbonyloxy;
phenyl, phenyl-C₁-C₆-alkyl, phenylcarbonyl, phenylcarbonyl-C₁-C₆-alkyl, phenoxycarbonyl, phenylaminocarbonyl, phenylsulfonylaminocarbonyl, N—(C₁-C₆-alkyl)-N-(phenyl)aminocarbonyl, phenyl-C₁-C₆-alkylcarbonyl, heterocyclyl, heterocyclyl-C₁-C₆-alkyl, heterocyclylcarbonyl, heterocyclylsulfonylaminocarbonyl; heterocyclylcarbonyl-C₁-C₆-alkyl, heterocyclyloxycarbonyl, heterocyclylaminocarbonyl, N—(C₁-C₆-alkyl)-N-(heterocyclyl)aminocarbonyl, or heterocyclyl-C₁-C₆-alkylcarbonyl, where the phenyl and the heterocyclyl radical of the 17 last-mentioned substituents may be partially or fully halogenated and/or may carry one to three of the following groups: nitro, cyano, C₁-C₄-alkyl, C₁-C₄-haloalkyl, C₁-C₄-alkoxy or C₁-C₄-haloalkoxy; or
SO₂R¹⁵;
R¹⁴ is hydrogen, C₁-C₆-alkyl, C₃-C₆-cycloalkyl, C₃-C₆-alkenyl, C₃-C₆-alkynyl, C₃-C₆-haloalkenyl, C₃-C₆-haloalkynyl, where the alkyl and cycloalkyl radicals mentioned may be partially or fully halogenated and/or may carry one to three of the following groups: cyano, hydroxyl, C₃-C₆-cycloalkyl, C₁-C₄-alkoxy, C₁-C₄-alkylthio, di(C₁-C₄-alkyl)amino, C₁-C₄-alkylcarbonyl, hydroxycarbonyl, C₁-C₄-alkoxycarbonyl, aminocarbonyl, C₁-C₄-alkylaminocarbonyl, di(C₁-C₄-alkyl)aminocarbonyl or C₁-C₄-alkylcarbonyloxy; or
phenyl, phenyl-C₁-C₆-alkyl, heterocyclyl or heterocyclyl-C₁-C₆-alkyl, where the phenyl and the heterocyclyl radical of the 4 last-mentioned substituents may be partially or fully halogenated and/or may carry one to three of the following groups: nitro, cyano, C₁-C₄-alkyl, C₁-C₄-haloalkyl, C₁-C₄-alkoxy or C₁-C₄-haloalkoxy;
R¹⁵ is C₁-C₆-alkyl, C₁-C₆-haloalkyl or phenyl, where the phenyl radical may be partially or fully halogenated and/or may carry one to three of the following groups: C₁-C₆-alkyl, C₁-C₆-haloalkyl or C₁-C₆-alkoxy;
or an agriculturally useful salt thereof.

2. The heteroaroyl-substituted phenylalanineamide of the formula I according to claim 1, where A is C-linked pyrazolyl selected from the group consisting of A1a to A4 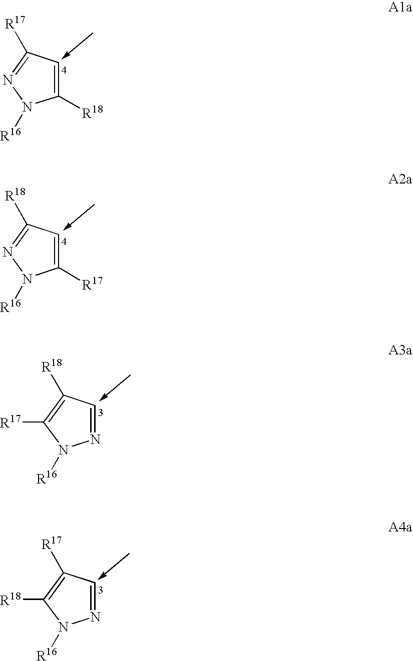
where the arrow indicates the position of attachment and
R¹⁶ is C₁-C₆-alkyl, C₃-C₆-cycloalkyl, C₁-C₆-haloalkyl or C₁-C₆-alkyoxy-C₁-C₄-alkyl;
R¹⁷ is hydrogen, halogen, C₁-C₆-alkyl, C₁-C₆-haloalkyl or (C₁-C₆-alkyl)amino; and
R¹⁸ is halogen, C₁-C₆-alkyl or C₁-C₆-haloalkyl.

3. The heteroaroyl-substituted phenylalanineamide of the formula I according to claim 1, where A is C-linked pyrazolyl selected from the group consisting of Ala and A2a 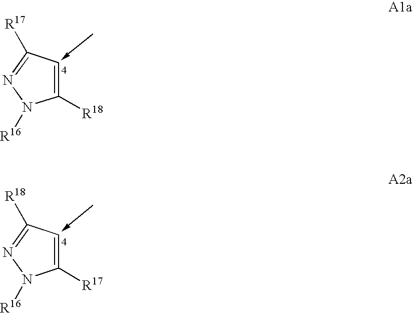
where the arrow indicates the point of attachment and
R¹⁶ is C₁-C₆-alkyl, C₃-C₆-cycloalkyl, C₁-C₆-haloalkyl or C₁-C₆-alkoxy-C₁-C₄-alkyl;
R¹⁷ is hydrogen, halogen, C₁-C₆-alkyl or C₁-C₆-haloalkyl; and
R¹⁸ is halogen, C₁-C₆-alkyl or C₁-C₆-haloalkyl.

4. The heteroaroyl-substituted phenylalanineamide of the formula I claim 1, where R¹, R², R⁵, R⁹ and R¹⁰ are hydrogen.

5. The heteroaroyl-substituted phenylalanineamide of the formula I claim 1, where R⁴ is hydrogen, C₁-C₄-alkyl or OR¹¹.

6. A process for preparing heteroaroyl-substituted phenylalanineamides of the formula I according to claim 1, which comprises converting
phenylalanines of the formula V 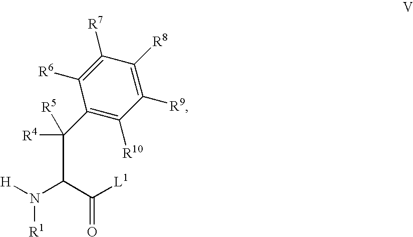
where R¹ and R⁴ to R¹⁰ are as defined in claim 1 and L¹ is a nucleophilically displaceable leaving group
with heteroarylcarboxylic acids or heteroarylcarboxylic acid derivatives of the formula IV 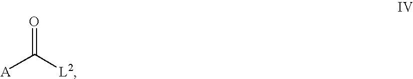
where A is as defined in claim 1 and L² is a nucleophilically displaceable leaving group into the corresponding heteroaroyl derivatives of the formula III 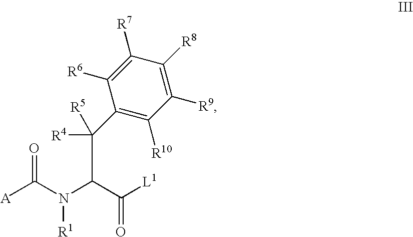
where A, R¹ and R⁴ to R¹⁰ are as defined in claim 1 and L¹ is a nucleophilically displaceable leaving group
and reacting the resulting heteroaroyl derivatives of the formula II with an amine of the formula II
HNR⁶R⁷ II.

7. A process for preparing heteroaroyl-substituted phenylalanineamides of the formula I according to claim 6 where R⁴ is hydroxyl and R⁵ is hydrogen, which comprises preparing heteroaroyl derivatives of the formula III where R⁴ is hydroxyl and R⁵ is hydrogen by acylation of keto compounds of the formula XIII 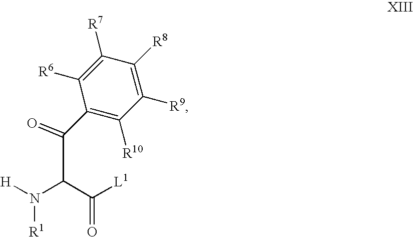
where R¹ and R⁶ to R¹⁰ are as defined in claim 6 and L¹ is a nucleophilically displaceable leaving group,
with heteroarylcarboxylic acids or heteroarylcarboxylic acid derivatives of the formula IV to N-acyl keto compounds of the formula XII 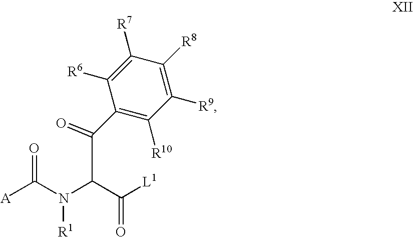
where A, R¹ and R⁶ to R¹⁰ are as defined in claim 6 and L¹ is a nucleophilically displaceable leaving group,
followed by reduction of the keto group.

8. A heteroaroyl derivative of the formula III 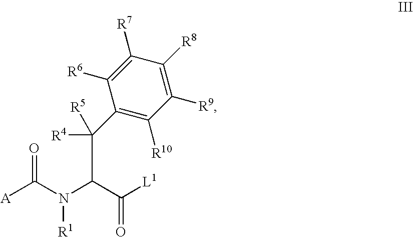
where R¹ and R⁴ to R¹⁰ are as defined in claim 1,
A is A1, A2, A3, A4, A5, A6, A8 or A9, where R¹⁶ to R¹⁹ are as defined in claim 1; and
L¹ is hydroxyl or C₁-C₆-alkoxy.

9. A herbicidal composition, comprising a herbicidally effective amount of at least one heteroaroyl-substituted phenylalanine of the formula I, or an agriculturally useful salt thereof, of claim 1 and auxiliaries customary for formulating crop protection agents.

10. A process for preparing a compositions according to claim 9, which comprises mixing a herbicidally effective amount of at least one heteroaroyl-substituted phenylalanine, or an agriculturally useful salt thereof, of claim 1 and auxiliaries customary for formulating crop protection agents.

11. A method for controlling unwanted vegetation, which comprises allowing a herbicidally effective amount of at least one heteroaroyl-substituted phenylalanine of the formula I, or an agriculturally useful salt thereof, of claim 1 to act on plants, their habitat and/or on seed.

12. (canceled)

13. The heteroaroyl-substituted phenylalamineamide of claim 1, wherein A is pyrrolyl, thienyl, furyl, pyrazolyl, imidazolyl, thiazolyl, oxazolyl, tetrazolyl, pyridyl or pyrimidinyl; where the heteroaryl radicals mentioned may be partially or fully halogenated and/or may carry 1 to 3 radicals selected from the group consisting of cyano, C₁-C₆-alkyl, C₃-C₆-cycloalkyl, C₁-C₆-haloalkyl, C₁-C₆-alkoxy, C₁-C₆-haloalkoxy, C₁-C₆-alkoxy-C₁-C₄-alkyl, amino, (C₁-C₆-alkyl)amino and di(C₁-C₆-alkyl)amino.

14. The heteroaroyl-substituted phenylalamineamide of claim 1, wherein A is thienyl, furyl, pyrazolyl or imidazolyl; where the heteroaryl radicals mentioned may be partially halogenated and/or may carry 1 to 2 radicals selected from the group consisting of C₁-C₆-alkyl and C₁-C₄-haloalkyl.

15. The heteroaroyl-substituted phenylalamineamide of claim 1, wherein A is A1, A2, A5 or A6.

16. The heteroaroyl-substituted henylalamineamide of claim 1, wherein A is 3-pyrazolyl which may be partially or fully halogenated and/or may be substituted by one to three radicals selected from the group consisting of C₁-C₆-alkyl, C₃-C₆-cycloalkyl, C₁-C₆-haloalkyl and C₁-C₆-alkoxy-C₁-C₄-alkyl; or
A is 4-pyrazolyl which may be partially or fully halogenated and/or may be substituted by one to three radicals selected from the group consisting of C₁-C₆-alkyl, C₃-C₆-cycloalkyl, C₁-C₆-haloalkyl and C₁-C₆-alkoxy-C₁-C₄-alkyl.

17. The composition of claim 9, wherein the concentration of the phenylalanine or salt thereof is 0.01 to 98% by weight.

18. The method of claim 11, wherein the phenylalanine or salt thereof is applied to plants or their habitat at an application rate of the active substance of from 0.001 to 3.0 kg/ha.

19. The method of claim 18, wherein the rate is 0.01 to 1.0 kg/ha.
